(19) United States
(12) Patent Application Publication
(10) Pub. No.: US 2014/0259879 A1
(43) Pub. Date: Sep. 18, 2014

(54) Badder than a Bed Bug Strategically Designed Modular Moat Systems for Control of Target Pests

(71) Applicant: Joseph Benedict Logsdon, Chicago, IL (US)

(72) Inventor: Joseph Benedict Logsdon, Chicago, IL (US)

(21) Appl. No.: 13/796,629

(22) Filed: Mar. 12, 2013

(51) Int. Cl. A01M 1/20; A01M 1/14; A01M 1/10

(52) U.S. Cl. CPC A01M 1/2011; A01M 1/103; A01M 1/14
USPC 43/114; 43/123; 43/131

(57) ABSTRACT

Method and apparatus for killing target pests using strategically designed moats. The moats are constructed of barrier material that is difficult for the target pests to traverse, material that is easy for the target pests to traverse, and killing material, which tends to kill the target pests after they have made adequate contact with it. These elements are strategically positioned so that target pests that are attracted to a bait travel along a long zigzag path parallel to the barrier material and, hence, a long zigzag path along killing material held by the material that is easy for the target pests to traverse and along any killing material contained in a strategically positioned furrow. Moat system embodiments that provide selective access to baits and/or killing material are disclosed. Several examples are provided demonstrating applications to bed bugs, and explanation is provided for how to apply the invention to other pests.

### CROSS-REFERENCES TO RELATED APPLICATIONS

This application claims the benefit of the U.S. Provisional patent application Nos. 61/610,990, which was filed on Mar. 14, 2012; 61/677,050, which was filed on Jul. 30, 2012; and 61/677,055, which was filed on Jul. 30, 2012. The entirety of each of these provisional patent applications is hereby incorporated by reference.

### BACKGROUND OF THE INVENTION

1. Field of the Invention

This invention relates to methods and means for killing target pests, while minimizing the use of poisons, controlling access of any potential target pests to their desired bait, and protecting non-target animals from any poisons that are used. This invention synergistically combines a barrier with killing material, so that the harder and longer that target pests try to reach their desired bait, the greater the contact they make with the killing material. The simplest embodiments, which are also those disclosed in the greatest detail, target bed bugs.

2. Description of the Related Art

Various apparatuses exploit bed bugs' inability to climb very smooth surfaces to trap bed bugs. For a typical apparatus, the outer surface of the apparatus is rough, so that bed bugs can easily climb it to enter the trap. The inner surface of the trap is smooth and coated with talc, so that bed bugs, once they drop inside the trap, cannot escape. These traps are good for verifying the presence of bed bugs, and they help to control the population of bed bugs. These apparatuses, however, have several shortcomings. Many of the bed bugs that climb up the rough side refuse to enter the trap; these traps tend to be fragile, so they do not typically last long; and each trap must be periodically removed from beneath the protected item of furniture, so that the trapped bed bugs and any powder inside the trap can be discarded. Bed bugs that fail to enter a trap will simply hide elsewhere to await their next blood meal. Furthermore, if any mistake is made, for even a moment, and a bridge is formed, e.g., by a sheet, blanket, or piece of paper dropping onto the trap, any trapped bed bugs are likely to enter the protected item of furniture all at once. Still further, children and pets could make contact with live bed bugs that are trapped inside a trap. Replacing or emptying traps repeatedly is thus required; unfortunately, this can be a cumbersome and expensive chore. Yet another shortcoming of these traps is that they cannot be used to protect many items that typically need to be protected, such as windows, doors, walls, and furniture that does not have legs.

Various heating devices have been employed to kill bed bugs by heating them. Typically, items that one wishes to clear of live bed bugs can be placed inside a heating device. After the items have been held for a certain duration at a certain temperature, at which all stages of bed bugs are likely to be dead, the items are removed from the heating device. Such heating devices have several shortcomings. They cannot be used for large items of furniture; they cannot be used to heat a room; there is a risk that some items placed inside such a device are destroyed; they are expensive; and, according to some consumer reviews of these heating systems, they sometimes do not work as intended.

Various poisons, such as pyrethrins, pyrethroids, and organophosphates have been used against bed bugs. Bed bugs are not killed by many of the pesticides that easily kill other insects, such as roaches and ants. Most of these poisons can be harmful to the environment, and even those poisons that are claimed to be relatively safe can cause reactions, such as coughing, sneezing, etc., in sensitive people. There have been many reports of bed bug victims who, in the frustration they experience as a result of foggers, sprays, etc. having limited effect on bed bugs that routinely hide deep inside cracks and crevices, are injured as a result of excessive and/or improper use of the poisons. Such frustration is further enhanced by the tendency of pests to develop tolerance to pesticides. For several reasons, the statistics concerning injuries due to pesticide use probably vastly understate the rate of such injuries. For example, there is commonly a time delay between exposure to a poison and symptoms, so it can be difficult to impute the poison as the cause of untoward symptoms. Imputing a poison as a cause could also be difficult because some poisons potentiate the effects of other poisons, so that symptoms do not appear immediately after application of a first poison, but appear soon after application of a second poison because, together, their effects are far greater than the sum of the effects of the two poisons used alone. Thus, the use of poisons can be not only expensive and ineffective, but far more harmful than the bed bugs themselves. It should be noted that these same concerns apply to any types of target pests.

Diatomaceous earth is a product that is effective for killing bed bugs. It is relatively safe for humans and pets, yet it kills bed bugs and many other pests by scratching their exoskeletons and drawing out lipids, which causes them to dehydrate. The common current practice is to either spread this powder over areas along which bed bugs are expected to crawl or sprinkle it into a moat. This practice has several shortcomings. Bed bugs tend to avoid stepping over areas that have what for them are huge accumulations of powder because they prefer to climb on surfaces over which they can get a good foothold. And when they find a preferred area upon which to crawl, they just walk along the top of the short distance of powder. A bed bug does not necessarily die as a result of any exposure to diatomaceous earth. In a worst case scenario, a pregnant female can therefore cross a sea of diatomaceous earth and survive long enough to deposit its eggs in the protected items, such as beds. What is needed is a way to transform a short, straight walk over the top of killing material, such as diatomaceous earth, into a walk of indefinite length, which involves changes in direction along the walking path in addition to a chance that persistent bed bugs will drop onto their backs into some killing material. Another shortcoming of current methods is that they do not permit the arrangement of moats in which the killing material is arranged vertically or of vertical guides, which direct bed bugs into moats; these arrangements, if designed in accordance with the present invention, would permit bed bugs that enter or exit through windows, curtains, drapes, doors, or cracks or crevices, regardless of their direction of movement, to be directed to their deaths from an indefinite exposure to killing material, such as diatomaceous earth.

Smooth materials of various kinds and/or oil have been used to prevent bed bugs from entering items, such as beds. Because, in contrast to many cockroaches and ants, bed bugs lack adhesive pads on their feet, they have considerable difficulty climbing smooth material, such as smooth plastics and glasses. Polytetrafluoroethylene (PTFE (Teflon)) is commonly used for such a bed bug barrier. Bed bugs also avoid trying to cross oil. The drawback of currently existing methods and systems for using smooth material and/or oil to prevent bed bugs from entering items of furniture is that bed bugs that fail to enter these protected items can survive many months without a blood meal. They would thus infest unprotected items and either bite when they get the chance or simply travel from such an infested item to the protected item when they get the opportunity. For example, smooth material and/or oil could be used to protect all four legs of a bed. Bed bugs that are deterred from entering the protected bed might infest a nearby book. A person might decide to read the book in bed, and a bed bug might either bite the person on a hand or, after the person sets the book down on the protected bed, a bed bug might wander out of the book to hide in the bed. What is needed is a way to combine smooth material with killing material in such a way that they interact synergistically to induce bed bugs to walk along a path of indefinite length, regardless of their direction of approach to or from a protected item, along the killing material. (This patent sometimes characterizes this path as a “zigzag path” because it tends to trace out a generally zigzag pattern, although the actual path is not necessarily zigzag.)

Various concoctions have been marketed as repellants of bed bugs. There is usually little, if any, apparent merit to such concoctions—except, in some cases, for their potential use as tea.

Moats have been used to protect furniture. Some moats use mineral oil to prevent bed bugs from entering furniture, such as beds. Some moats use diatomaceous earth to kill bed bugs that cross them to enter whatever items of furniture are being protected by the moats. Moats that contain only mineral oil only repel bed bugs, and moats that contain only diatomaceous earth are easily traversed by bed bugs because they simply walk along the top surface of the powder. What is needed in the war against bed bugs is a moat system, which protects a bait for bed bugs, which could be either a potential source of a blood meal or a potential hiding place, wherein the moat system employs smooth material, which keeps bed bugs away from the bait while compelling persistent bed bugs to walk a long distance along killing material, which is held by the moat system.

Most of this disclosure focuses on applications of this invention to bed bugs because discussion of applications of this invention to bed bugs is the simplest way to teach the basic inventive concept. Although other possibilities exist, for bed bugs, the bather can be smooth material, such as smooth tape; the “killing material” can be diatomaceous earth; and the “clinging material”, upon which the killing material is sprinkled and into which it is rubbed, can be any material that bed bugs find easy to climb, such as balsa wood or cork sheet. This disclosure explains how these elements can be arranged to efficiently kill bed bugs. Some portion of this disclosure is also intended to briefly suggest how the basic inventive concept taught in this disclosure can be used to kill more general target pests.

For many pests, poisons are commonly used. Many pests, however, particularly insects, are infamous for their ability to develop resistance to poisons. Furthermore, poisons tend to harm the environment and oftentimes present dangers to health that far outweigh dangers presented by the pests they are intended to control. It is, therefore, desirable to employ a method and system, which enable us to minimize the use of poisons.

One approach to pest management is the use of sticky traps, which catch target pests, such as cockroaches and mice. These devices tend to be expensive because they need to be replaced frequently. Once a mouse is trapped, the mouse, along with the trap to which it is stuck, should be discarded as soon as possible; while the mouse is still alive, it is likely to leave behind urine and feces, and after it is dead, it will soon decompose, leaving a horrible odor, and any fleas or mites on the mouse might exit the mouse carcass to create another pest problem. A common complaint of users of sticky traps for mice is that they oftentimes escape from the traps. Sticky traps for roaches tend to lose their effectiveness quickly and are typically useless by the time they are fairly full of cockroaches. Furthermore, some cockroaches typically avoid bait used in any given sticky trap. By the time such a sticky trap for cockroaches is discarded and replaced with a new trap, cockroaches typically will have multiplied to many times their original number.

Some barriers have been used to prevent even insects, such as some cockroaches and ants, with adhesive pads at the ends of their feet, from climbing onto an item that is protected by one of such barriers. These barriers typically use smooth material in combination with particulate matter, which is either arranged adjacent to the smooth material or adhered to the smooth material in such a manner that it breaks away from the smooth surface when a target pest tries to climb it, thereby causing the target pest to lose its footing on the smooth surface. These arrangements have several shortcomings. After a target pest has struggled long enough and, as a result, clears a path, which other such target pests can later exploit, it and the other target pests eventually have a fairly high probability of scaling the barrier. Furthermore, it can be a cumbersome chore to repeatedly reapply the particulate matter to the smooth material; this reapplication chore would be frequent if the target pests do not die as a result of their struggle with the barrier. Still further, for many of these arrangements, which rely on particulate matter arranged adjacent to the barrier, it is difficult, if not impossible, to arrange the barrier vertically, so that the target pests are guided to walk in the vertical direction. What is needed is an invention that would permit these bathers to be oriented in any direction; that would make it more difficult for the target pests to clear paths through these barriers; and that would cause these target pests to become ever more exposed to killing material the harder they try to climb these barriers.

Many currently existing pest control arrangements employ bait in which some type of killing material, which is usually a poison of some type, is mixed in with the bait. A target pest eats the tainted bait, which normally comprises inert ingredients, which provide nutrients for the target pest. There are several shortcomings to this approach. Consider, as an example, an abode that is infested with both mice and cockroaches. To kill the mice, poison laced bait is placed in locations frequented by mice. But the inert ingredients of this bait, which typically serve as food for mice, oftentimes serve as food for cockroaches as well, yet the poison for the mice is normally not also poisonous for cockroaches. Thus, the poison laced bait for the mice serves as food for the cockroaches, which tends to make the cockroach problem worse. Conversely, the inert ingredients for cockroach bait, such as maltose, fructose, sucrose, and glucose, typically provide nutrients for mice, yet the poison that is used against cockroaches is normally ineffective for mice.

A common cause of poisoning among pets and wildlife is the use of poisoned slug bait. Typically, a grain-based bait, which pets, such as dogs, find irresistible, which is laced with metaldehyde, is spread over the ground near potential hiding places of slugs. Unfortunately, this metaldehyde, which is highly toxic to mammals and birds, is consumed when an animal eats the irresistible bait. What is needed is a method and apparatus for selectively separating the bait from the killing material, so that potential target pests that are unaffected by the killing material cannot consume the bait and so that non-target animals are not inadvertently harmed by consuming tainted bait.

A general idea of this invention is to provide inaccessible bait for the target pests, and to strategically locate some killing material, which kills specifically the target pests and is in most cases relatively safe for other creatures, so that the harder the target pests try to reach the inaccessible bait, the greater the contact that the target pests make with the killing material. Thus, the more persistent a target pest is, the greater is the probability that it will die as a result of the contact it makes with the killing material. Depending on the situation, it might be advantageous to modify this general idea somewhat so that only selected target pests can gain access to a given bait. These measures help to prevent one type of target pest from consuming the bait intended for another type of target pest. These measures also help to protect non-target species from consuming any poison that might be used.

### SUMMARY OF THE INVENTION

### 1. Basic Theory Underlying the Inventive Concept

Throughout most of this enabling disclosure, where examples are provided, bed bugs are considered the target pests because the application of this invention to the control of bed bugs is particularly simple, and extensions to other target pests is likewise simple once applications to bed bugs are understood. The invention is a moat system, which for many embodiments typically comprises four main components: bait to which the target pests are attracted; barrier material, which the target pests find considerably difficult to traverse; killing material, which kills the target pests after they have made adequate contact with it; and clinging material, which the target pests find easy to traverse and which holds the killing material to its surface, regardless of the orientation of the surface of the clinging material. For many embodiments, a furrow, which can hold killing material, can be advantageously formed. In some alternative embodiments, the bather material can also hold some killing material. For most applications, the synergistic combination of the elements of which the moat system is comprised, rather than repel target pests, lures them to their deaths by encouraging them to walk or crawl indefinite distances along killing material; the travel along these indefinite distances typically involves significant changes in direction, thereby enhancing the forces the target pests apply to the killing material.

A word should be provided concerning our use of the word “smooth.” When discussing bathers for bed bugs, we assume that “smoothness,” according to our own perception, translates to “smoothness,” according to the bed bugs' perception. When we wish to decide whether a substance is smooth, we apply a force to the surface of the material, usually with a finger. We then observe the ease with which our finger slides along the surface. The component of the force applied to the finger by the material, which is tangential to the surface, equals the product of the normal component of the force we apply and the coefficient of friction. The easier it is to slide our finger along the surface, for a given amount of the normal component of force, the smoother we estimate the material to be. A bed bug's experience with such material is, however, different. The bed bug cannot apply a normal component of force until it grabs the material so that it can pull on the material with an equal and opposite force. Observations of bed bugs suggest that, while a bed bug attempts to climb materials we consider smooth, the bed bug gropes the surface for pits or holes it can use to plant its claws into the material. Rather than spend any time or energy applying a normal component of force, it applies only a tangential component of force, so that it can climb the material. Thus, it is not necessarily true that “smooth” material, according to our perception, is hard for a bed bug to climb. Fortunately, our sense of smoothness does seem to be highly correlated with the difficulty a bed bug encounters upon trying to climb the material. Therefore, although some materials that do not seem to be smooth to our touch might be hard for bed bugs to climb, probably the vast majority of materials we consider smooth are hard for bed bugs to climb.

Many creatures that climb surfaces we consider smooth rely on forces originating from intermolecular permanent or induced dipole fields; these forces are known as van der Waals forces. For many insects, these forces are important for permitting the insects' adhesive pads to stick to a smooth surface, so that they can climb it. It has been found that insects that can normally climb a smooth surface can in many cases be prevented from climbing it by loosely adhering to the surface some very fine particles, which stick to the adhesive pads of the insects, thereby preventing them from getting a foothold on the smooth surface until they remove the tiny particles from their adhesive pads.

### 1.1 Application to Bed Bugs

For bed bugs, simple embodiments of the invention can be realized by using humans for the bait; smooth material, such as smooth tape, for the barrier material; diatomaceous earth for the killing material; and easily climbable material, such as balsa wood (or most any other wood) or cork sheet, which also holds diatomaceous earth well to its surface at any orientation, for the clinging material. A furrow, which holds diatomaceous earth, can advantageously be included in the design; such a furrow oftentimes greatly increases the exposure of bed bugs to diatomaceous earth. In some situations, when a furrow is used, it is unnecessary to use clinging material; in general, however, use of clinging material greatly enhances the killing power of the moat system.

One representative embodiment for a moat system for bed bugs comprises a moat wall, comprised of balsa wood or cork, to which smooth tape, such as ultrahigh molecular weight polyethylene (UHMW-P) tape, is adhered in such a manner that bed bugs have great difficulty accessing a human host that is protected by the moat system. Easily climbable material to which diatomaceous earth clings well, such as balsa wood or cork, can be considered an example of “clinging material.” If balsa wood is used, the balsa wood can be curved, if desired, using ammonia applied to the balsa wood. Smooth tape used in this manner can be considered an example of “barrier material.” Diatomaceous earth is rubbed into the surface of this moat wall, both above and below the smooth tape, so that bed bugs that try to enter or exit the protected bait tend to walk a long zigzag path along the diatomaceous earth that is rubbed into the moat wall. A furrow, into which diatomaceous earth is spread, is arranged below the smooth tape, so that bed bugs that try to enter or exit the protected bait must walk a long distance along diatomaceous earth in the furrow and so that they oftentimes drop into the furrow after having struggled against the smooth tape. The diatomaceous earth used for these purposes can be considered an example of “killing material.”

In other representative embodiments, smooth tape, such as UHMW-P tape, is used as a guide, which guides bed bugs, from any direction, into a moat system, such as one just described. Smooth tape used for this application can be considered an example of “guiding material.” It should be emphasized that, even for application to bed bugs, many materials other than balsa wood, cork, UHMW-P tape, and diatomaceous earth can be similarly arranged to accomplish a similar objective.

In deciding how to design the moats we shall use to kill bed bugs, it would be helpful to exploit some of the strengths and weaknesses of bed bugs. It is helpful to use reference insects, such as German cockroaches, as a basis of comparison because experience with them could help us exploit any weaknesses inherent to bed bugs. One could, conversely, consider and exploit strengths and weaknesses of German cockroaches, but here, for simplicity, bed bugs are considered. Some strengths and weaknesses of bed bugs are the following:
1. Unlike German cockroaches, all bed bugs reliably pursue the same bait. All bed bugs of concern to us are attracted to only one source of food: fresh flowing blood (usually of humans, and, possibly, of pets). This is a weakness of bed bugs because it enables us to reliably lure all bed bugs from any cracks or crevices in which they may be hiding—using human beings (and possibly pets) as the bait.
2. Unlike German cockroaches, bed bugs cannot readily climb smooth surfaces. German cockroaches have adhesive pads near the ends of their feet. Although these adhesive pads make German cockroaches more susceptible to the effects of residue of many poisons, it offers them the advantage that they can easily climb on smooth surfaces. Bed bugs, having no such adhesive pads, have great difficulty climbing smooth surfaces, such as those of plastics and glasses. This observation can be exploited by using smooth materials, on which bed bugs have difficulty climbing, to guide them in such a manner that their exposure to diatomaceous earth is maximized.
3. In contrast to a German cockroach, a bed bug has a remarkably flat body, with its widest dimension parallel to the ground. This flatness becomes ever more extreme the longer the bed bug goes without a blood meal and, thus, the hungrier the bed bug becomes—and this is when it is most likely to pursue the blood meal bait. As a consequence of this flat shape, with its short legs, the entire underside of its body would drag along any diatomaceous earth spread on the surface along which it crawls. This flat shape renders it particularly susceptible to death by dehydration because the ratio of surface area to volume is much greater for the bed bug than it is, for example, for the German cockroach. The maximum volume of water already within the insect is about proportional to the volume of the insect, but the maximum rate at which water is lost as a result of damage to the epicuticle (outermost layer) of the insect's exoskeleton is about proportional to the surface area of the insect (it is also about proportional to the dryness of the ambient air, an observation which is discussed below). The difference in damage, combined with this difference in ratio, would probably help to explain the observation that bed bugs are far more susceptible to death from exposure to diatomaceous earth than German cockroaches are.
4. Compared to a German cockroach, a bed bug has very short legs relative to the surface area of the portion of its body closest to the surface along which it climbs or crawls. Thus a bed bug that crawls or climbs along a surface along which diatomaceous earth has been spread and/or coated would have a relatively great tendency to accumulate diatomaceous earth on the portion of its exoskeleton nearest the surface along which it climbs or crawls.
5. Bed bugs tend to be top heavy. They oftentimes struggle against smooth material until they drop, usually on their backsides. It takes considerable struggle for a bed bug that has landed on its backside to right itself. Thus, the presence of a furrow containing diatomaceous earth would result in additional accumulation of the deadly powder on the bed bugs' exoskeletons.
6. Bed bugs inhabit drier locations than German cockroaches. This might partly explain the difference in susceptibility, between these two insects, to death from diatomaceous earth. German cockroaches hang out near sinks and other moist locations, but bed bugs hang out in enclosed areas that tend to be dry. We do not enjoy sleeping in water logged beds, and we like to keep our clothes dry. So bed bugs are adapted to dry areas, but German cockroaches are adapted to wet areas, although the relatively large ratio of German cockroach volume to surface area does enable German cockroaches to tolerate dry conditions very well. Thus, addition of desiccant, such as silicon dioxide gel, to enclosed areas, such as inside box springs, dressers, chests, and sofas, although unnecessary, would likely tend to hasten the death, through dehydration, of bed bugs that contact diatomaceous earth. This strategy of adding a desiccant can be particularly important for pregnant female bed bugs because we would like them to die before they can lay their eggs—newly emerging nymphs being unaffected by any diatomaceous earth to which the mother has been exposed. It would also be helpful for preventing bed bugs from getting another blood meal, which would provide them with some much needed water.
7. A bed bug probably tends to be more persistent than a German cockroach in its attempts to reach a given target. Because a German cockroach can easily climb virtually anything, the only obstacle a German cockroach encounters is either an impassable barrier, such as a tightly closed refrigerator, or a human. In either case, German cockroaches feast on so many types of food that they can easily find alternatives and continue thriving. For the bed bug, survival of the fittest probably dictates that only genes for persistence will propagate. Imagine a bed bug, in its “natural” surroundings, with no traps set or moats designed by humans. A bed bug approaches its host virtually blindly, almost aimlessly following hints to the location of its human host. Along the way, it encounters obstacles. If, the moment it encounters an obstacle, it gives up hope, or if it gives up hope easily, then it will have wasted energy, and it cannot breed. And if every time it tries to reach its host, and it encounters an obstacle, which is practically inevitable, it gives up hope, then it will eventually die without ever having a chance to mate.
   We can therefore expect that the vast majority of bed bugs that encounter material that is too smooth for them to climb, while they are close to their host or some attractive hiding place, will try repeatedly to find an opening in the smooth material. They would thus tend to walk along a more or less “zigzag path”. Therefore, if diatomaceous earth, which is not known to strongly repel bed bugs, is present along the bed bugs' zigzag path, we expect these persistent bed bugs to be exposed to plenty of diatomaceous earth to kill them. This is much of the basic idea underlying the moat systems discussed in this patent.
8. Bed bugs prefer to climb and crawl along materials they find easy to climb, diatomaceous earth clings well to materials they find easy to climb, and bed bugs do not hesitate to climb and crawl on such easy to climb materials even if they are coated with diatomaceous earth. This leads to the prediction that an effective way to kill bed bugs would be to coat easy to climb materials with diatomaceous earth and add these powdered materials to moat systems. As noted above, bed bugs have short legs relative to the surface area of the portion of their bodies closest to the surface upon which they crawl. They climb and crawl avidly on easy to climb materials, such as balsa wood and cork, coated with diatomaceous earth—their exoskeletons dragging quickly over long stretches of the deadly powder.
9. Aggregation of bed bugs into clusters postpones their dehydration and aids in their reproduction, but hungry bed bugs postpone aggregation into clusters.
   Bed bugs, like most insects, have various subtle ways of communicating with each other so that they can coordinate their behavior. This coordination of behavior confers upon them a survival benefit. Under various conditions, depending on a bed bug's sex, age, and physical condition, feces, exuvia, and pheromones can either attract or repel the bed bug. When the presence of these elements attracts bed bugs, it causes them to aggregate, which increases their ability to avoid dehydration because the ratio of the surface area to volume of a cluster of bed bugs is far less than that of an isolated bed bug. It has been found that each bed bug in a cluster of 20 bed bugs loses water at half the rate of an isolated bed bug. Bed bugs within a cluster have been found to intermittently trade places, thereby equalizing the rate of water loss among them. Such aggregation also speeds maturation and eases the task of mating. When one bed bug within a cluster is disturbed, e.g., by a predator, it emits a high concentration of the same pheromones that attract the bed bugs in low concentrations; this high concentration of the pheromones causes the bed bugs within the cluster to scatter.
   The presence of feces, exuvia, or pheromones, at low levels, tends to attract fed bed bugs more strongly than it attracts hungry bed bugs. Thus, rather than aggregate, a hungry bed bug tends to search for its host. If it fails to find its host, it expends more energy than it would otherwise expend, so it dies of starvation sooner unless it at some point obtains a meal. Furthermore, if such a bed bug has had its exoskeleton damaged by diatomaceous earth, it is likely to dehydrate sooner both because it hesitates to aggregate into a cluster and because the activity itself causes the bed bug to lose water. Bed bugs don't tend to search for a host unless they detect, using primarily their antennae, the presence of a host. Therefore, the method of baiting bed bugs, using a host, thereby luring them into walking along diatomaceous earth, while preventing them from reaching the host and encouraging them to walk as long a distance as possible along the diatomaceous earth, is perfectly fitting as a method for efficiently killing bed bugs.
10. Bed bugs tend to wander along largely meandering paths.
11. Insects, including bed bugs, cannot adapt to develop immunity to diatomaceous earth the way they can for typical poisons.
12. Bed bugs can live for extended periods without any meals. This strength suggests that relying on the strategy of closing off every crack and crevice would be a losing battle. Not only are openings small enough for bed bug nymphs to hide in extremely hard to find, but new cracks open up all the time, particularly as temperatures fluctuate. And closing off one set of cracks might increase the stresses in other areas of the walls, thereby increasing their likelihood of cracking soon. Because they live so long without food, they could simply patiently wait until another crack opens up, at which point they would likely attack with a vengeance. Furthermore, if they are successfully closed off by the sealing of, cracks, the bed bugs would be forced to remain still, thereby conserving energy, which would reduce their requirement for food, so that successfully cordoning them off might actually increase their lifespans!
13. Bed bugs are much better than we are at finding hiding places. This strength suggests that if we try to combat bed bugs by locating every crack and crevice in which they may be hiding, we are only fighting a losing battle. Time and money would be more wisely spent by reliably luring them out of their hiding places, where they encounter material that is dangerous to their lives, which is not dangerous to us, and for which they are ill prepared, than by trying to track down such elusive pests.
14. Bed bugs are small, and their colors blend well with furniture. Thus, both because of limitations in our sense of vision and limitations in our mental function known as “attention,” trying to find bed bugs by inspection tends to be a losing battle.
   The disclosure of the invention described in this patent explains and illustrates some of the myriad embodiments of the invention, which can be designed to exploit the above observations.

### 1.2 Applications to General Target Pests

In general, different pests have different preferences for bait, yet there is considerable overlap of preferences among pests so different that a substance that is toxic for one might not be toxic for another. It has been found, for example, that some German cockroaches avoid bait that others find irresistible and that this aversion to the bait is a result of the behavior of avoidance of the inert ingredients, such as maltose, sucrose, fructose, or glucose, rather than from avoidance of, or physiological resistance to, the toxic ingredients themselves. It has also been found that even those German cockroaches that avoid the usual bait are strongly attracted to certain types of dog food. If one tries leaving out some poisoned dog food, the roaches would eat it, but so would any mice or rats that might also be present. These rodents would simply flourish from the dog food because the roach poison would not tend to harm them. In fact, it has been found that dog food serves as an antidote to anticoagulant mouse or rat poison because dog food contains Vitamin K. Conversely, if one leaves poisoned bait intended to kill rats or mice out, unprotected from cockroaches, some rats and mice will avoid the bait, but the cockroaches might, and oftentimes do, quickly devour the bait. Furthermore, it has been found that animals we do not wish to be harmed, such as pets and beneficial insects, are oftentimes injured as a result of consuming poisoned bait to which they are attracted. For example, slugs are commonly controlled by mixing metaldehyde with a cereal-based bait. There have been many reports of pets and wildlife being injured as a result of consuming this tainted bait. We can avoid these problems by employing logic similar to that used for dealing with bed bugs: we can protect the bait, so that no potential target pests and no non-target animals can reach it, and we can arrange killing material along surfaces in the proximity of the protected bait, so that persistent target pests would, simply because of their struggle to reach the bait, acquire a generous portion of the killing material on their bodies. Alternatively, we can design our moat system to selectively allow specific target pests to gain access to any given poisoned bait.

In this section, the task of designing moat systems for general target pests is divided into four parts: choice and arrangement of bait; choice and arrangement of barriers; choice and arrangement of killing material; and choice and arrangement of clinging material, which the target pests are comfortable climbing and which holds the killing material well to its surface. In most cases, a furrow would also be helpful.

### 1.2.1 General Bait

For dealing with bed bugs, “selection” of bait is simple. Bed bugs are naturally drawn to potential sources of flowing blood and to select types of hiding places. In other words, bed bugs' baits already exist within living areas, and they will continue to exist as long as the living areas are inhabited by potential bait.

Many other target pests have naturally occurring bait. Examples are slugs and beetles, which commonly feed on plants, and ants, some of which feed on aphid excretions. Plants can be protected from slugs and ants by surrounding the plants with a barrier, which is hard for these target pests to traverse, and arranging killing material near the barrier, so that persistent target pests would die relatively quickly. Some of these target pests, such as slugs and ants, sometimes enter living areas from outdoors. An example of a moat system, which is disclosed herein and which would help kill such target pests, while making it difficult for them to enter the living area, is a moat system that protects the door that leads from outdoors to the living area (see FIGS. 14 and 15).

For many target pests, naturally occurring bait exists all throughout living areas, so it tends to be helpful to place concentrated bait in specific locations in order to kill these target pests. For many such target pests, selection of bait can be a challenge. For example, both German cockroaches and mice have been found to develop a genetically based aversion toward certain types of what would serve as food if it were ingested. Some strains of German cockroaches avoid various types of mono and disaccharides, and some strains of mice avoid certain grains. Fortunately, each of these target pests must be drawn to some type of food because, otherwise, it could not survive. For example, even these avoidant German cockroach strains are attracted to “Advion-C” and dog food. Similarly, even the mice that avoid grains are attracted to many other types of bait.

A problem with many of these baits is that they serve as food for many types of potential target pests, yet the poison that is typically blended in with the bait is toxic to only one or two of the potential target pests. Another problem is that animals we do not wish to harm might be attracted to the bait, and they might be susceptible to the poison contained within the bait. A solution is to employ barriers, which keep all potential target pests, as well as all non-target animals, away from the bait. Another solution is to use selective barriers, which only permit target pests that are susceptible to the killing material contained inside a bait to reach the bait. These solutions are discussed in more detail below.

### 1.2.2 General Barriers

Bed bug barriers are particularly simple because bed bugs tend to have great difficulty traversing material that is smooth to the touch. For example, ¼″ wide ultrahigh molecular polyethylene (UHMW-P) tape or polytetrafluoroethylene (PTFE (Teflon)) tape, where the smooth, non-adhesive portion of the tape is oriented so that the tape lies either approximately in the vertical plane or at a more challenging angle, serves as an excellent barrier for bed bugs because they find such smooth tape almost impossible to climb. For target pests in general, the barrier does not have to be comprised of smooth material. For example, slugs are reportedly repelled by copper tape, sand, ashes, broken eggshells, soot, and mixtures of chewing tobacco and coffee grounds. U.S. Pat. No. 5,337,513 discloses a slug barrier comprised of particulate copper metal which is held in a polymeric matrix. Any combination of these materials could be used as the barrier for slugs, and killing material could be arranged near the barrier, so that persistent slugs would acquire ample killing material on their bodies. Many arthropods have adhesive pads that enable them to climb smooth surfaces. As discussed below, material comprised of particles that cover the adhesive pads of the target pests and that break away from the surface upon which they are coated tend to make the task of climbing more difficult for such target pests.

It has been found that many insects, such as ants and cockroaches, have either hairy or smooth tarsal adhesive pads near their claws, which they use to climb relatively smooth surfaces. It has also been found that when ants, with these special pads, first walk along powders comprised of particles of sufficiently small size, they tend to have great difficulty subsequently climbing a smooth surface. This effect appears to depend more strongly on particle size than on particle type. The critical particle size further appears to depend on the size of the tarsal adhesive pads, and this effect increases with decreasing particle size. It has further been found that ants that encounter such fine powder clean the powder from their antennae and feet. Thus, optionally, powders comprised of very small particles, such as 1-5 micron silica glass or 21 micron (or smaller) polytetrafluoroethylene (PTFE (Teflon)) particles, could be mixed in with some killing material, so that the combination is held to the surface adjacent to the smooth barrier and/or adhered to the bather itself. This option offers the advantage that ants that clean their antennae and feet of the fine powder would also ingest the killing material, which, if it is selected so that ingestion by the target pest would tend to kill it, would help to hasten the death of the target pest. An example of such killing material, for many cockroaches and ants, is boric acid. Another option would be to position this fine powder separate from the killing material, but adjacent to the barrier.

U.S. Pat. No. 5,561,941 discloses several ways to design a barrier to insects, wherein the barrier is comprised of very small particles. A bather of this nature could be combined with killing material, which targets specific pests. A commonly used bather is comprised of liquid Teflon. It has been found that very low concentrations of liquid Teflon can deter some insects, such as certain species of ants, from climbing a surface. The required concentration depends, in part, on the substrate upon which the liquid Teflon is coated.

Any arrangement that causes a target pest to have great difficulty reaching its destination, such as some type of bait, and that the target pest has difficulty crawling, slithering, or climbing on can be used as a barrier. As discussed above, smooth material combined with fine particulate matter could thus serve as a barrier to target pests that have adhesive pads on their feet. Cockroaches are commonly confined to containers by researchers using petroleum jelly, such as Vaseline, combined with oil. Cockroaches are reportedly repelled by a substance contained in catnip, known as nepetalactone. Because some cockroaches avoid certain types of sugars, for some cockroaches, these sugars might possibly be used as relatively weak barriers. If the bather comprises a repellant, it is important that the repellant effect not be so strong as to discourage the target pests from making contact with the killing material held by the clinging material and/or a furrow, which is located near the barrier. As discussed below, any substances that can serve as barriers to cockroaches can be used to encourage cockroaches to walk a long zigzag path along killing material that is held by material that cockroaches find easy to climb.

Another type of bather material, which could be useful for some applications, is sticky material. For example, to control ants that easily climb smooth material, which enter a living area through a door leading outdoors, a barrier, which is comprised of material with a sticky surface, can be adhered to the portion of the door jamb located outdoors. Similar to some embodiments for a moat system, in accordance with the invention, which are used to protect door or windows (see, e.g., FIGS. 14-18), easily climbable sticks can be arranged on the side of this sticky barrier opposite the door or window, and killing material can be rubbed into these sticks. A moat system can be arranged beneath the door or widow, also in accordance with the invention. Ants that try to enter the living area would either get stuck to the barrier, or they would, in avoiding the sticky barrier, walk a long, typically zigzag path along the killing material rubbed into the easily climbable material and/or contained in the moat located beneath the door. Because sticky barriers tend to lose their effectiveness quickly as a result of accumulation of debris, dust, etc., it is particularly helpful if killing material is strategically arranged alongside of such sticky barriers.

Usually, whether a given barrier material is difficult for a given target pest to traverse by climbing or crawling along the surface of the barrier depends on the orientation of the barrier. For bed bugs, the length of the smooth bather can be oriented at most any direction with respect to the horizontal. For example, smooth, ultrahigh molecular weight polyethylene tape can be adhered vertically along the door jamb of a door and then horizontally across the top of the door jamb of the door. As long as the smooth tape lies approximately in the vertical plane at each point of the smooth tape, bed bugs cannot traverse the smooth tape by climbing or crawling along its smooth surface. Another way to express this is by noting that as long as the smooth tape lies substantially in the vertical plane, from the perspective of an approaching bed bug, the bed bug cannot scale the smooth tape without extreme difficulty. If the smooth tape is wrapped around a can, then, although the entire smooth tape does not lie in a single vertical plane, the small area of the smooth tape near an approaching bed bug would appear to the approaching bed bug to lie substantially in the vertical plane and would thus be very difficult for the bed bug to scale. If the smooth surface of the smooth tape were inclined somewhat downward, a bed bug would find it even harder to scale by climbing or crawling across the smooth surface of the smooth tape; in this case, the required smoothness of the smooth tape would probably not be as great it would be if the smooth tape were positioned in a less challenging orientation. In general, for any target pest, it is important to orient whatever barrier is used so that the target pest has great difficulty traversing it by climbing or crawling along the surface of the barrier.

Barriers made of sticky substances seem to be an exception. Usually, such barriers can be laid out in any orientation, and even the best of climbing target pests, like roaches and ants, could not traverse such a barrier, regardless of its orientation. A drawback to sticky barriers, however, is that they usually do not remain adequately sticky for long.

For many bathers, the barrier can be extended along any direction, yet the barrier can be oriented in such a manner that the target pest cannot easily, if at all, traverse the bather by climbing it or by crawling along its surface. For example, as discussed elsewhere in this disclosure, smooth tape can be extended in any direction, yet the orientation of the smooth tape can always be adjusted so that bed bugs would have a difficult time scaling it. This property of the smooth bather is important because it permits virtually any region of an abode to be protected from bed bugs. For example, smooth tape can be adhered vertically and horizontally along a door jamb, around windows, or around any areas of walls. In general, this versatility is important for any type of barrier material and for any type of target pest.

### 1.2.3 General Killing Material

When selecting killing material, several criteria for the selection should, ideally, be used. The killing material should target the target pests without harming other creatures or plants; be demonstrated to have the property that the target pests have not developed resistance to it; be demonstrated not to repel any of the target pests; be demonstrated to lead to the death of the target pests as a result of accumulation of the killing material on their bodies and/or ingestion of the killing material; and be easy to contain on a surface on which the target pests appear comfortable, preferably, independent of the orientation of the surface.

A major difficulty with deciding on the killing material is that animals that are relatively related biologically tend to be susceptible to similar substances. Another major difficulty is that some poisons harm creatures indiscriminately, harming beneficial insects, wildlife, pets, and humans. For bed bugs, the solution is simple: diatomaceous earth kills the highly susceptible bed bugs and tends to kill some other arthropods, few of which we desire to hang around in our abodes, yet it leaves mammals almost completely unscathed and in various ways can actually benefit mammals. Although bed bugs, cockroaches, and ants are insects, their susceptibilities to substances are radically different. The shape and size of the bed bugs leave them much more susceptible than cockroaches and ants to the effects of diatomaceous earth, but their lack of moving mouthparts render them nearly immune to the effects of boric acid, which is an effective poison of the foregut when ants or cockroaches ingest it. Compared to most poisons, diatomaceous earth and boric acid are relatively safe for mammals and birds, so they are relatively safe for humans and pets. It is, however, a challenge to find substances that are lethal to some mammals, such as mice and rats, yet relatively harmless for humans and pets. In what follows, a few examples of considerations relevant to the use of specific choices of killing material are discussed.

For several reasons, it would be advantageous to use the barrier material, discussed above, to separate the inert bait from the killing material. Such a barrier could be used to encourage target pests to struggle to try to reach the bait that is protected by the barrier; in this struggle, the target pests would acquire some type of killing material on specific parts of their anatomy, which would lead them, as well as any target pests that make adequate contact with them, to die as a result of this contact. Such a barrier could further be used to prevent potential target pests, for which any killing material that is used is harmless, from devouring the bait. Such a barrier is also desirable because it can help to keep other animals, which we do not wish to be harmed, away from tainted bait. Such an arrangement is also advantageous because, when combining killing material with inert bait, it is necessary to ensure that the killing material and inert bait do not counteract each other's effects. For example, some poisons can repel target pests from otherwise attractive bait. Furthermore, the inert ingredients of the bait sometimes counteract the poison itself. If the inert ingredients in a bait, such as dog food, for rats or mice include a substance that contains Vitamin K, then anticoagulant poison might be ineffective for the rats or mice. It has been found that, although boric acid is effective for killing many types of insects, it is less effective when combined with various other substances, such as sorbitol.

There are many types of poisons that can be used to kill rodents, such as rats and mice. Unfortunately, many of these poisons tend to be toxic to other mammals, such as humans and pets. In the next section, “clinging material” is discussed. This is material upon which target pests feel comfortable and that holds the killing material well to its surface. The usual approach, recommended in this disclosure, of rubbing killing material into clinging material, can be hazardous if applied to rodents because rodents that acquire a substance on their bodies might eventually contaminate other areas, such as those containing food. One alternative approach, which is also taught in this disclosure, is to safely trap rodents that struggle against some type of barrier. Another approach to control of rodents, which is discussed next, is to rub a synergist, which is relatively safe for humans and pets, into the clinging material.

Probably the most common type of poison used against rodents is an anticoagulant. There are several synergists that can be used with an anticoagulant. Examples are various calciferols or antibiotics, such as sulfaquinoxaline. In China Patent Application No. 200810030345, which has been published with Publication Number 101356916, on 2009-02-04, a combination comprising salicylic acid and sodium bicarbonate is used as a synergist, which potentiates the effect of anticoagulants. European Patent EP 2090164 B1 teaches several synergistic combinations of poisons for killing rodents. U.S. Pat. No. 8,022,067 teaches myriad different combinations of substances, which can be synergistically combined to kill many types of target pests, including rodents. With anticoagulant and/or a synergist carefully rubbed into the material adjacent to the bait, the target rodent would, hopefully, relatively quickly bleed to death. It would probably be safest, in many cases, to mix the anticoagulant with the bait and employ the barriers to permit only the target rodents to access the bait, and to rub a synergist that is relatively safe for humans and pets into the material that lies adjacent to the bait. Rodents that get these substances onto their bodies will transfer them to other rodents during grooming, mating, etc. Any such arrangement should be carefully closed using a child proof seal, and any killing material or synergist that is applied to a surface of the material surrounding the bait should be carefully applied to the surface.

For killing slugs, particularly those found in home gardens, poisonous pellets are commonly used. Two common active ingredients are metaldehyde and methiocarb. Methiocarb is more poisonous to mammals, and it is poisonous to insects, including beneficial insects. In contrast to metaldehyde, methiocarb is not a contact poison; methiocarb acts as a stomach poison and must be ingested, but metaldehyde kills upon making adequate contact with the skin of the slug. Thus, in general, metaldehyde is to be preferred over methiocarb. Typically, these pellets are comprised of a cereal-based bait mixed in with the poison. For each application of these poisons, only a minute fraction of the poison itself is ever consumed by slugs. Pure metaldehyde tends to repel slugs, so the poison must be spread thinly. There have been many reports of pets and wildlife being poisoned from exposure to these poisons. We thus see here an example in which tainted bait is consumed by animals that are not among the target pests. But metaldehyde, which kills slugs either through ingestion or through contact with the skin of the slug, tends to kill the slug at about the location at which it makes contact with the metaldehyde. This is because the metaldehyde draws mucus out of the slug, thus making it difficult for it to wander about. Thus, a moat system, shaped much like a donut with a roof that keeps out rain and other animals, with copper tape (or other material, as discussed above) used as the barrier, and with metaldehyde sprinkled into the furrow or rubbed into the material adjacent to the barrier, could be used to kill slugs that are attracted to a plant that is protected by the moat system. As discussed below, the quantity of metaldehyde can be kept low enough to avoid repelling slugs by using a synergist and perhaps other types of killing material. With this moat system, because the poison is sheltered and is separated from the bait, which is the plant to which the slugs are attracted, there is little chance that other animals would be harmed by the poison.

A detergent-like substance has reportedly been found, which increases the rate of absorption of metaldehyde by the slug upon contact with both of these substances. The addition of this detergent-like synergist could thus reduce the amount of metaldehyde that is necessary to kill the slugs. Thus, sprinkling these substances into a furrow and/or rubbing them into material adjacent to the barrier would likely be an effective approach to control of slugs in the home garden.

Salt (NaCl) kills slugs, when it accumulates on their bodies, through osmosis, i.e., it dehydrates slugs by drawing water out of their bodies. Unfortunately, NaCl is phytotoxic. But when used in adequately small amounts, e.g., when it is simply rubbed into the material, such as wood, upon which the slugs crawl and adjacent to the barrier, such as copper tape (or other material, as discussed above), it is likely to kill slugs without harming the plants, provided that the barrier is effective enough to keep the slugs away from the plants. To enhance the killing power of the killing material, while minimizing risk to plants and other animals, salt can be combined with another substance, such as metaldehyde, which is discussed in the previous paragraph. The metaldehyde, in small concentrations, would not repel the slugs, and, upon contact with a slug, it would draw mucus out of the slug, so that it would not tend to wander away. Thus, the salt that the slug simultaneously contacts, which draws water out of the slug, through osmosis, would not tend to be transferred elsewhere. Thus, a moat system, shaped much like a donut with a roof that keeps out rain and other animals; with copper tape (or other material, as discussed above) used as the barrier; and with metaldehyde and salt sprinkled into the moat furrow and/or rubbed into porous material, such as wood, adjacent to the barrier, could be used to kill slugs that are attracted to a plant that is protected by the moat system. Synergists, such as the detergent-like substance mentioned above, could be used to enhance the effectiveness of the system using a minimal quantity of poison.

There are many other possible choices of killing material for slugs. For example, iron phosphate, which is safe for plants, can be sprinkled into a donut-shaped moat, so that the iron phosphate is located adjacent to the copper tape (or other material, as discussed above), which is used as the barrier; iron phosphate must generally be ingested to kill the slugs. It should also be noted that, whatever the choice of killing material, it is sometimes possible to choose the barrier so that it holds the killing material well to its surface. For example, for the slug, a barrier comprised of a substance, such as sand, ashes, broken eggshells, or soot, could hold killing material; this arrangement would probably not be as efficient as one in which the killing material is arranged alongside the barrier because the killing material might have a tendency to seep deep into the barrier if it is sprinkled on top of it. If one or more of these materials scratches the skin of a slug as it makes contact with killing material, such as metaldehyde with a synergist and/or salt, death of the slug might be hastened. To the extent that slugs avoid contact with the latter types of barriers, however, it would be best to also arrange some killing material adjacent to the barrier, to ensure that the slugs make contact with the killing material.

A poison that is safe for the environment, for humans, and for pets, and that selectively kills certain target pests is bacillus thuringiensis (also known as “BT”), which is typically available in powder or liquid form. It can be rubbed into moat walls adjacent to barriers, of which the moats are comprised. BT is effective against early larval stages of pests, so, although it is effective against many garden pests, it is unlikely to be effective against most house pests. If the moat walls are made of wood or cork, they would hold the BT well to their surfaces. Because of the presence of the barrier, persistent target pests would crawl a long distance along the BT coated on the surfaces of the moat walls. Unfortunately, BT breaks down quickly in sunlight or rain; it might be somewhat helpful to design the moats so that they have covers, which would protect the BT from sunlight and rain.

An alternative killing material, which is safe for humans and pets, comprises various types of fungi. U.S. Pat. No. 7,951,389 discloses the use of fungal mycelium as insect attractants and biopesticides to control insects, including termites, fire ants, carpenter ants, flies, beetles, cockroaches, grasshoppers and other pests, using pre-sporulation fungal mycelium as an attractant and/or infectious agent. These fungi kill the target pests, as a result of contact with one of these fungi, and these fungi subsequently spread from one target pest to another when the target pests gather together in groups.

U.S. Pat. No. 8,263,526 discloses a method for prolonging the life and enhancing the effectiveness of fungi for killing target pests. The method employs compositions of keratin hydrolysate and fungal biological control agents such as Paecilomyces species, Metarhizium species, Beauveria species, and/or Verticillium species, to control a variety of insect pests. Insect pests which may be controlled include, but are not limited to, subterranean termites, particularly those belonging to the family Rhinotermitidae, such as the Formosan subterranean termite and native North American subterranean termites, and other agronomically important soil-dwelling insects such as Japanese beetles, June beetles, vine weevils, banana weevils, and sugar beet root maggot. The invention disclosed in U.S. Pat. No. 8,263,526 is thus useful for outdoor pests that dwell in the soil.

As mentioned above, sometimes some target pests consume bait intended for other target pests, yet the former target pests are unaffected by the poison contained in the bait. It also happens that rodents oftentimes carry other pests, such as fleas and mites. It would thus be advantageous to be able to kill rodents and any target pests they might harbor. It is typically helpful for the rodents to die slowly enough that the target pests they carry die before the rodents die; otherwise these other target pests could leave the carcass of the mouse on which they had been feeding to infest the living area. U.S. Pat. No. 7,943,160 discloses methods and compositions for simultaneously controlling rodents and any target pests they might be harboring using the same bait. The method and system entail combining a pesticide for the other target pests with a rodenticide for the rodents. Methods for combining these substances synergistically are also provided. Control of these target pests that are carried by the rodents could probably more effectively be achieved using the present invention. For example, various fungi, such as those previously mentioned above, could be rubbed into material into which rodents come into contact as they try to reach the bait. Simple contact between a rodent's fur and these fungi would likely be enough to kill the target pests carried by the rodent. And when the rodent returns to its den, the fungi would tend to spread to other rodents, thereby killing target pests carried by these other rodents.

### 1.2.4 General Clinging Material

Bed bugs prefer to climb and crawl along materials they find easy to climb, diatomaceous earth clings well to materials they find easy to climb, and bed bugs do not hesitate to climb and crawl along such easy to climb materials even if they are coated with diatomaceous earth. This leads to the prediction that an effective way to kill bed bugs would be to coat easy to climb materials with diatomaceous earth and add these powdered materials to moat systems. As noted above, bed bugs have short legs relative to the surface area of the portion of their bodies closest to the surface upon which they crawl. They climb and crawl avidly on easy to climb materials, such as balsa wood and cork, coated with diatomaceous earth—their exoskeletons dragging quickly over long stretches of the deadly powder.

Many species of ants and cockroaches easily climb on many materials, whether they are smooth or rough to the touch. As discussed previously, however, materials can be modified so that even cockroaches and ants find them difficult to climb. Such modified materials would not qualify as clinging material because clinging material is, by the definition used in this disclosure, easy for the target pests to climb. Another property of clinging material is that it holds the killing material well to its surface. What serves as clinging material for bed bugs could probably serve as clinging material for most other target pests because they find it easy to climb and it holds killing material well to its surface.

### 2. Advantages of the Invention

### 2.1 Advantages of the Disclosed Moat Systems for Bed Bugs

Here, we assume, for simplicity, that the target pests are bed bugs, that the barrier material that is used, i.e., the material bed bugs find difficult to traverse when oriented within a specific range of orientations, is smooth material; that the killing material is diatomaceous earth; and that the moat walls are constructed of material that bed bugs find easy to climb and that holds diatomaceous earth well to its surface. One might wonder, if diatomaceous earth is so effective at killing bed bugs, why bother building moats to contain it? Why not just toss some diatomaceous earth around? Moats designed in accordance with the present invention offer many advantages, which enable the diatomaceous earth contained within them to kill bed bugs more effectively, for a longer time, and under a greater variety of circumstances. A study of the disclosure in this patent would reveal that, as applied to bed bugs, the moat systems disclosed in this patent help:
1. to greatly enhance the killing power of the diatomaceous earth by compelling bed bugs to walk, crawl, or climb an indefinitely long distance, involving plenty of acceleration, along the deadly powder;
2. to minimize the volume of diatomaceous earth required;
3. to minimize the surface area of diatomaceous earth exposed to the air, per volume of diatomaceous earth used;
4. to maximize the efficiency of the distribution of the diatomaceous earth;
5. to obviate the need for reapplication of diatomaceous earth every time furniture is moved;
6. to protect the contents of the moats from sudden jarring, moisture, etc.;
7. to make housecleaning easier;
8. to prolong the useful life of the contents of the moats;
9. to enhance the aesthetic appeal of the living quarters;
10. to add flexibility to the manner and location of placement of diatomaceous earth;
11. to permit bed bugs to be reliably and effectively guided into and through a sea of diatomaceous earth;
and
12. to permit a sea of diatomaceous earth to present itself to bed bugs at any orientation, rather than just horizontally, i.e., under the influence of gravity.

Yet another advantage of the invention lies in its extraordinary versatility. Because the invention is based on generalizations of simple principles that are applicable to bed bugs, the same device that can kill bed bugs can kill many other pests as well making only minor modifications. For example, a moat system, which uses diatomaceous earth as the killing material, smooth tape as the barrier, and wood or cork as the easily climbable material, can be applied to bed bugs. But this same moat system can also be used to kill ants and cockroaches in addition to bed bugs, with minimal modification of the moat system, by rubbing a mixture of diatomaceous earth and boric acid into the easily climbable material, and employing fine particulate matter to make climbing of the smooth tape difficult for the ants and cockroaches. (Details are provided elsewhere in this patent).

### 2.2 Advantages of the Disclosed Moat Systems for General Target Pests

This invention can be used to kill many other target pests, such as cockroaches, ants, and slugs, to name just a few examples. For general target pests, this invention offers most of the same advantages that it offers for bed bugs, as previously listed. For general target pests, there are many other advantages that this invention offers. This invention helps to protect non-target animals while killing the target pests. To kill slugs, for example, poison is typically combined with inert bait, which, unfortunately, is attractive to other creatures, such as dogs, which are commonly harmed when they consume the tainted bait. This invention solves this problem by separating the bait (typically plants) from the poison, shielding the poison, and drastically reducing the amount of poison that is needed to kill the slugs.

This invention also helps to avoid the problem of one target pest, which is not adversely affected by a certain poison, which is intended for another target pest, consuming tainted bait which was intended only for the latter target pest. For example, cockroaches oftentimes consume tainted bait that has been left out for mice. Using this invention, this problem could be solved by either separating the mouse poison from the bait and employing a barrier that keeps all creatures away from the bait, or using a barrier that only permits mice to access tainted bait that is intended for mice.

This strategy could be applied to some cases in which some of the target pests avoid the bait. As discussed elsewhere in this disclosure, relatively safe killing material, such as a fungus, could be rubbed into clinging material, which is located near a barrier, which protects bait. If this fungus is selected to kill the target pests, which might be, for example, any number of possible arthropods, those target pests that struggle to reach the bait will return to the other hiding target pests, spreading the deadly fungus to the latter target pests. A similar strategy can be applied to many target pests and many types of bait using many types of barriers.

As discussed elsewhere in this disclosure, rodents oftentimes carry parasitic pests, so that immediately after a rodent dies, parasitic pests, such as fleas and mites, leave the dead rodent to feed off of humans and pets. These parasitic pests not only cause discomfort, but they also oftentimes act as disease vectors. This invention can help to solve this problem by compelling rodents, such as mice, that struggle to reach some bait, to rub their bodies against some clinging material, which holds killing material, such as a fungus, which is selected to target likely parasitic pests. When these rodents return to their fellow rodents, the fungus would spread to kill other parasitic pests.

As mentioned at the end of the previous subsection, an advantage of the invention lies in its extraordinary versatility. The present invention is basically “modular” in nature. Because of the separation of the moat system into components, i.e., bait, killing material, bather material, and clinging material, the present invention enables a user to choose the desired combinations among these elements. One may desire non-poisonous killing material for some areas of the abode, but prefer somewhat more toxic killing material for other areas. One may choose a combination of killing material so that it targets a specific combination of target pests. One could similarly choose any combinations of bait, bather material, and clinging material to target specific combinations of target pests and to satisfy tastes and general goals, which might comprise considerations other than eradication of the desired combinations of target pests. (Details are provided elsewhere in this patent).

### BRIEF DESCRIPTION OF THE SEVERAL VIEWS OF THE DRAWINGS

FIGS. 1A to 1C show a cylindrical moat system.

FIG. 2 shows an overhead view of a cylindrical moat system using two bathers.

FIG. 3 shows a cone shaped moat system, using one barrier.

FIG. 4 shows a cone shaped moat system, using two barriers.

FIG. 5 shows a square or rectangular moat system with sloping moat walls.

FIG. 6 shows a portable moat system, which can protect objects supported by the moat system.

FIG. 7 shows a single furrow moat system which uses one bather, which faces away from the center of the moat system, and which can protect resting areas or areas surrounding furniture.

FIG. 8 shows a single furrow moat system which uses one barrier, which faces toward the center of the moat system, and which can be used for protecting resting areas or areas surrounding furniture.

FIG. 9 shows a double furrow moat system which uses one barrier, which faces away from the center of the moat system, and which can protect resting areas or areas surrounding furniture.

FIG. 10 shows a double furrow moat system which uses two bathers, which face toward each other, and which can protect resting areas or areas surrounding furniture.

FIG. 11 shows a double furrow moat system which uses two barriers, which face away from each other, and which can protect resting areas or areas surrounding furniture.

FIG. 12 shows a cross sectional view of a typical moat system with two barriers that face each other.

FIG. 13 shows a cross sectional view of a typical moat system with two barriers that face away from each other.

FIG. 14 shows a moat system for protecting a door.

FIG. 15 shows an overhead view of a bottom portion, shown as 1499 in FIG. 14, of a moat system for protecting a door.

FIG. 16 shows a front view of a moat system, which can protect a window area.

FIG. 17 shows an overhead view of the lowest portion of the window moat system, which is shown in FIG. 16, which lies below the window, with the barrier affixed to the outside of the moat wall and facing away from the window.

FIG. 18 shows an overhead view of the lowest portion of the window moat system, which is shown in FIG. 16, which lies below the window, with the barrier affixed to the inside of the moat wall and facing toward the window.

FIGS. 19A and 19B show two orientations of a versatile moat system.

FIG. 20 shows an example of a moat system, in which easily climbable sticks, which can be made to hold killing material to their surfaces, are positioned beneath a barrier. This figure illustrates, among other points, that a furrow, although normally advantageous, is not strictly necessary.

FIG. 21 shows an example of a moat system, in which easily climbable sticks, which can be made to hold killing material to their surfaces, are positioned beneath a barrier. This figure illustrates an example of how a bed frame or similar structure can be protected. This figure illustrates, among other points, that a furrow, although normally advantageous, is not strictly necessary.

FIGS. 22A-C show a cylindrical donut-shaped moat, which can be used for slug control.

FIGS. 23A-B show a psychological barrier comprised of a lenticular print, which can be used to intimidate rodents and birds.

### DETAILED DESCRIPTION OF THE INVENTION

What follows is an enabling disclosure of some of the myriad possible embodiments of the present invention. In no manner is the disclosure intended to limit the scope of the present invention.

Before proceeding with the discussion concerning the preferred embodiments, as detailed in the drawings, here a few of the many alternative embodiments are briefly mentioned, not for the purpose of exhaustively listing such embodiments, but for the purpose of supporting the claim, by way of a few examples, that many such alternative embodiments exist. For aesthetic purposes, any moat system described in this disclosure could have an additional, easily climbable outer moat wall added. This additional wall could then, optionally, have no killing material rubbed into it. The additional furrow that results from this addition of a moat wall could advantageously have a little killing material sprinkled into it. This additional, easily climbable moat wall would, if no killing material is rubbed into it, help to keep the living area free of killing material that might otherwise fall onto the nearby living area, making a minor mess. It should also be emphasized that, for any of the moat systems discussed in this disclosure, it is unnecessary to have both furrows and easily climbable material to which the killing material clings well (“clinging material”). If only a furrow is used, then it would tend to be advantageous, though not strictly necessary, to position the barrier close to the killing material held by the furrow. If clinging material is used, alone or in combination with one or more furrows, it would be advantageous to position the bather so that some clinging material lies above and/or below the barrier. For most applications, a moat system would tend to have the greatest killing power if it employs a combination of furrows and clinging material.

It should further be mentioned that there exist myriad applications of the present invention not explicitly mentioned in the specification. Among those applications mentioned in this specification are protection of the following (the figures which describe them are provided in parentheses): an item of furniture (every figure); a region including clothing (every figure); a region in which people spend considerable time (FIGS. 7-11); a drawer (FIGS. 7-11); a region on one side of a door jamb and the area beneath the door jamb (FIGS. 14 and 15); an area of a wall (FIGS. 14-18); an area including a potential opening in a wall (FIGS. 14-18); a region including a window, its drapes, curtains, and any apparatus used for supporting the drapes and the curtains (FIGS. 16-18); the base of a wall (FIGS. 7-11 and 14-18); exercise equipment (FIG. 20); a region including a plant (FIG. 22); and a trash can (FIG. 23). The above lists of figures are not intended to be exhaustive; they merely provide the most obvious figures for each listed application.

An important feature of the present invention, as discussed in this disclosure, is the use of bather material to greatly enhance the killing power of killing material that is either held in a furrow or held to the surface of clinging material. It is possible, and in some cases advantageous, to have some clinging material, with or without killing material held to its surface and with or without bather material located near the clinging material. Similarly, it is possible, and in some cases advantageous, to have at least one furrow, that may or may not contain killing material and that may or may not have bather material located nearby. A furrow, or clinging material, can contain, for example, any combination of killing material; material, such as oil, which they find difficult to traverse; particulate matter, of a type, as discussed previously, which makes climbing difficult for the target pests by, e.g., adhering to the adhesive pads in such a manner that the target pests have difficulty climbing certain surfaces that they normally find easy to climb; a substance that repels the target pests; and a substance that lures the target pests. In general, adjacent moat walls, which form each furrow, should be separated far enough that the target pests cannot simply climb or leap directly from one moat wall to the next moat wall, but must, instead, traverse the bottom of the furrow, which could be arranged to contain a specific substance directed toward the target pests. A selective moat system could be based in part on the strategy of varying the separation between adjacent moat walls so that some target pests can simply reach from one such moat wall to another, while other target pests must traverse the bottom of the furrow below in order to reach the other moat wall. Killing material and barrier material could be held in a relative position, as discussed throughout this disclosure, so that those target pests that cannot reach across or leap across the moat walls could be subjected to abundant killing material. Another adjacent pair of moat walls could then be designed, in a manner similar to the teachings in this disclosure, so that the target pests that could reach across the first two moat walls are killed by an arrangement directed toward them.

One can also design the moat systems so that barriers are positioned in a manner consistent with one's goals. For simplicity, let us consider, again, bed bugs. When one visits a hotel, one is probably more interested in keeping target pests, such as bed bugs, out of one's luggage than in killing all the bed bugs that might happen to dwell in one's hotel room. Therefore, if one uses a moat with a single furrow and a single piece of smooth tape, one would probably want to adhere the smooth tape to the outside of the outermost wall that bounds the furrow. With this arrangement, bed bugs would have a hard time entering one's luggage from the hotel room, and any bed bugs that have somehow happened to get into the luggage, but would like to exit, perhaps to feed or mate, would walk across the diatomaceous earth contained in the furrow and would walk a long zigzag path on any killing material that is rubbed into any killing material above the smooth tape. If it exits, one would, of course, be delighted. But even if it does not exit the luggage, it would have a good chance of dying of dehydration from exposure to the diatomaceous earth. One might prefer to use two pieces of smooth tape, with one piece adhered to the outer perimeter of the outermost moat wall, as just mentioned, and the other piece adhered to the outer perimeter of the innermost moat wall. It would, for this arrangement, be advantageous for some clinging material, which holds killing material, to be located directly above this latter piece of smooth tape, so that bed bugs that try to exit the luggage would walk a long zigzag path along the killing material held by this clinging material. Some of these bed bugs would probably drop into the furrow below; if they do, they would have a difficult time trying to return to the luggage because they would have to climb or crawl up the smooth tape that is adhered to the innermost moat wall.

One might, instead, face the bather material inward, toward the protected item. Again, considering the example of bed bugs, this might be advantageous if the protected item is clothes that will be washed and dried at high heat before reuse. The outer perimeter of the outer moat wall could be made of clinging material into which plenty of diatomaceous earth has been rubbed. Bed bugs could climb this clinging material, at their peril, drop over the side of the barrier material, land into the zigzag furrow below, and then enter the dirty clothes. They would have a very difficult time leaving because of the position of the barrier material. Thus, they would either die from washing and drying at high heat or from dehydration as a result of exposure to diatomaceous earth presented to them by the moat system.

Another arrangement of smooth material, which can be applied to greatly enhance the killing power of a moat, especially a moat that uses both clinging material and furrows, each of which holds killing material, is the following. Pitfall traps are typically constructed so that they have what could be called “moats,” each of which is a type of furrow, in accordance with the terminology in this disclosure, wherein the inner moat walls of the furrow are constructed entirely of smooth material. Such pitfall traps are particularly common for bed bugs because bed bugs cannot easily crawl or climb on smooth material. To simplify the following discussion, let us assume, again, that the target pests are bed bugs. A significant shortcoming of this arrangement of typical pitfall traps is that when a bed bug first comes in contact with the smooth material, it also has a grip on easily climbable material, and any momentum carried by the bed bug is initially normal to the smooth surface and the force of gravity. As a result, a bed bug can relatively easily straddle the top rim of the pitfall trap, thereby avoiding dropping into the furrow below.

The main purpose of the present invention, for the vast majority of embodiments, is to kill, rather than trap, the target pests. Clinging material could thus advantageously be placed around the outer periphery of the furrow and onto the rim of the outer moat wall Killing material could then be rubbed into this clinging material. This would offer the advantage that even the most skittish of target pests would get ample exposure to the killing material. But if the furrow also contains killing material, it would clearly be advantageous to design the moat system, so that the target pests would at least have a fair probability of dropping into the furrow below. If the clinging material is only arranged as just discussed, it would tend to reduce the chance that a target pest would drop into the furrow below because target pests could easily grip onto the clinging material at the top of the rim of the outer moat wall. To help increase the probability that target pests drop into the furrow below, while using clinging material as just described, we can arrange the outer moat wall so that its inner surface is not constructed of only bather material. Instead, we can include enough clinging material, which holds killing material to its surface, along the top portion of the inner surface of the outer moat wall, that target pests would gleefully crawl over the edge of the rim of the outer moat wall and continue to hold onto the clinging material that is located directly above the bather material, which would then form only a part of the outer moat wall that bounds the furrow.

Consider, again, the example of bed bugs. Bed bugs would first climb the clinging material on the outer portion of the pitfall trap, thereby gaining exposure to killing material. They would then merrily climb the clinging material over the top edge of the outer moat wall, thereby acquiring yet more killing material. They would then tend to walk a zigzag path along the clinging material directly above the smooth material of which the outer moat wall is comprised. Sometimes, their momentum would have a component that tends to direct them into the furrow waiting below. But at all times, throughout this struggle to find an opening in the smooth material, the bed bugs are subjected to the pull of gravity, so that one misstep by one of these struggling bed bugs, so that it temporarily loses an adequate grip on the clinging material to which it is currently clinging for dear life, would cause it to drop over the side of the smooth barrier material and land into the killing material contained in the furrow below.

This same type of arrangement can also be applied to other moat walls, can be applied to almost any embodiment in this disclosure, and can be applied to most any target pest. This arrangement could be modified in many ways. For example, some thin portions of bather material could be positioned between the top rim of the furrow and the remainder of the barrier; thus, a target pest that walks directly above the above-discussed barrier material, upon suddenly encountering a small piece of barrier material lying directly in its path, might stumble and fall into the furrow below.

Furrows may or may not have bottoms or floors. A bottomless furrow could be particularly helpful on a rug or carpet because target pests that try to crawl beneath the moat would be exposed to killing material, which is contained in the bottomless furrow. Another possibility is to design the moats so that they include tops, which protect the contents of the moats from water, air currents, debris, etc. The possibilities are clearly endless.

1. Protecting Furniture Legs

### 1.1 Cylindrical Embodiments

FIG. 1A shows a perspective view, which includes some detail, not normally visible, as dashed lines, of an embodiment of the invention. FIG. 1B shows the same embodiment without the dashed lines, for added clarity. FIG. 1C shows a top view of the embodiment shown in FIGS. 1A and 1B. In Figs. The item protected by this moat system could be bait to which the targets pests are attracted. Barrier 150 forms a demarcation between the region containing this bait and a region not containing this bait; the former region is the “bait region,” and the latter region is the “target pest region.” In FIGS. 1A-1C, 120 could be an opening into which a furniture leg, such as the leg of a bed, chair, sofa, etc., is placed. Or 120 could be a solid surface, such as a cap, at the top of the moat, in which case the moat could be used to protect an item, such as a box, that is placed upon the top of the moat. The embodiment could thus also be used to protect items, such as boxes, which might contain items, such as clothes or exercise equipment, which are placed upon it; for this application, placing an object over 120 would help reduce the pressure applied by this moat system to any item that is placed upon it.

In FIGS. 1A, 1B, and 1C, 100 and 110 are the outer and inner surfaces, respectively, of the inner moat wall, which is made up of the combination of 105 and inner moat wall cover 135. These surfaces could advantageously be made of material the target pests find easy to climb; for bed bugs, this could be, e.g., wood or cork sheet. These surfaces could, instead, be made of material, such as a metal, which is not particularly easy to climb; for bed bugs, a prototype could be made of a tin can.

Outer surface 130 of inner moat wall cover 135 could advantageously be made of material that the target pests find easy to climb and that holds killing material well. If the target pests are bed bugs, this “clinging material” could be, e.g., balsa wood or cork sheet, and this “killing material” could be diatomaceous earth. Many other materials would serve well, such as cloth or adequately rough cardboard. If 100 is made of similar clinging material, 135 is unnecessary. 140 is the junction between 100 and inner moat wall cover 135.

150, which is represented by the bold double lines, is barrier material, which would be smooth material if the target pests are bed bugs. A simple prototype of such a barrier for bed bugs could be designed using smooth tape made of smooth material, such as ultrahigh molecular polyethylene or polytetrafluoroethylene (PTFE (Teflon)).

160 is a furrow, i.e., a space between the two moat walls, represented by 130, 135, and 140, for the inner moat wall (by 100, 105, and 110 if moat wall cover 135 is absent); and 170, 175, and 180, for the outer moat wall, of the moat system depicted in FIGS. 1A, 1B, and 1C. The moat wall surfaces, 130, 170, 175, and 180, are, preferably, easily climbable, and they preferably hold the killing material well to their surfaces. Prototypes for bed bugs could easily be made with the moat walls constructed from, e.g., balsa wood and/or cork sheet.

Briefly, the operation of the moat system depicted in FIGS. 1A-1C is as follows. A target pest climbs the outer moat wall surface, 180, which is made of easily climbable material, which, preferably, has killing material, which does not repel the target pests, on its surface. The target pest crosses moat wall 175, and descends moat wall surface, 170 to enter into the furrow, 160. The target pest then climbs the inner moat wall cover surface, 130, until it reaches barrier material 150. If the optional inner moat wall cover 135 is absent, the target pest instead ascends inner moat wall surface, 100. As it ascends the outer surface of the inner moat wall, 130 (100 if the moat wall cover is absent), the target pest encounters some bather material 150. All the moat wall surfaces, except bather 150, preferably, are easy for the target pests to climb, and, preferably, hold killing material to their surfaces. If the target pests are bed bugs, for example, the easily climbable material could, for example, be wood or cork sheet, to name just two of myriad possibilities. The killing material, for bed bugs, could be, e.g., diatomaceous earth. The barrier material, of which bather 150 is comprised, for bed bugs could be, e.g., smooth tape, such as ultrahigh molecular weight polyethylene tape or PTFE (Teflon) tape.

The persistent target pests would walk a long zigzag path along the killing material held by the inner moat wall cover surface 130 (inner moat wall surface 100 if no cover is present) below the barrier 150. Some of these target pests would drop from the barrier 150 and land into the furrow, 160, which contains some killing material. Target pests would have a difficult time reaching the bait region, which is either supported by legs placed inside opening 120 or contained inside a box that rests upon 120, which could be either an opening or a solid cover, such as a cap because they would have great difficulty getting past the barrier, 150. For bed bugs, all these barriers could be made of smooth tape, and all the moat walls could be made of material that bed bugs find easy to climb and that holds killing material, such as diatomaceous earth, well to its surface. In their attempt to enter the bait region, persistent target pests that find themselves inside furrow 160 would tend to walk a long zigzag path along killing material, contained in furrow 160 and on the portion of moat wall surface 130 below barrier 150.

Sometimes a target pest desires to wander away from the bait region, for example, to aggregate with other of the target pests, to mate, to hide elsewhere, or to feed elsewhere. Such a target pest would cross inner moat wall 105 and then the easily climbable material of moat wall cover 135, which surrounds inner moat wall 105. This target pest would descend the outer surface, 130, of inner moat wall cover 135 to encounter the barrier, 150. (If inner moat wall cover 135 is absent, the target pest would instead descend inner moat wall surface 100 until it reaches bather 150.) If this target pest is persistent, it would walk a long zigzag path along killing material that is held by the surface, 130, of the inner moat wall cover, 135. Eventually, this target pest might drop into the furrow 160, which contains some killing material.

The moat systems shown in FIGS. 1A-1C could be modified in myriad ways. For example, the barrier material 150 could be positioned on the inner surface 170 of moat wall 175 so that the surface of the barrier 150 that the target pests find hard to traverse faces inward, toward the bait area. For bed bugs, for example, the surface of bather 150 that is hard to traverse could be a smooth surface; this barrier 150 could thus be smooth tape or the inside of a smooth plastic jar. One could make a prototype using, e.g., a smooth plastic medicine jar, the surface of which bed bugs have difficulty climbing. This arrangement, in which the smooth surface faces inward, could be advantageously used to protect dirty clothes that would be washed and dried at high heat before reuse. Bed bugs that drop over the side of the smooth material might reach these dirty clothes. Because of their exposure to the diatomaceous earth contained on the moat surfaces and in the furrow 160, they might die of dehydration. Even if they don't die, they would have a hard time leaving the bait region because the smooth surface of the smooth material faces inward. Thus, even if they do not die of dehydration, they would die from washing and drying at high heat.

FIG. 2 shows a similar moat system to that shown in FIGS. 1A-1C, except that one furrow 282, one outer moat wall 290, and one piece of barrier 286, are added. A target pest climbs the outer moat wall surface 288, which is made of easily climbable material, which, preferably, has killing material, which does not repel the target pests, on its surface. The target pest crosses moat wall 290 and descends moat wall surface 284 to enter into the outer furrow 282. The target pest then climbs the central moat wall surface 280 and crawls across the central moat wall 275. As it descends the inner surface 270 of the central moat wall 275, the target pest encounters some barrier material 286. All the moat wall surfaces are, preferably, easy for the target pests to climb, and, preferably, hold killing material well to their surfaces. If the target pests are bed bugs, for example, the easily climbable material could, for example, be wood or cork sheet, to name just two of myriad possibilities. The killing material, for bed bugs, could be, e.g., diatomaceous earth. The barrier material 286 for bed bugs could be, e.g. smooth tape, such as ultrahigh molecular weight polyethylene tape or PTFE (Teflon) tape.

The persistent target pests would walk a zigzag path along the killing material held by the portion 270 of the central moat wall above the barrier material 286. Some of these target pests would drop over the side of the barrier material 286 and land into the furrow 260, which contains some killing material. Target pests that fall into furrow 260 tend to be trapped because, if they attempt to climb the outer surface 230 of inner moat wall cover 235, they find that they have great difficulty getting past the barrier 250, and if they attempt to climb up the inside surface 270 of central moat wall 275 they find that they have great difficulty getting past the barrier 286. For bed bugs, all these barriers could be made of smooth tape, and all the moat walls could be made of material that bed bugs find easy to climb, such as balsa wood or cork, and that holds killing material, such as diatomaceous earth, well to its surface. The barrier 286 could instead be constructed of a smooth plastic jar, the surface of which bed bugs have difficulty climbing. In their attempt to escape, target pests that find themselves inside furrow 260 would tend to walk a long zigzag path along killing material, contained in furrow 260 and on moat wall surfaces 230 and 270, in their attempt to escape furrow 260.

In FIG. 2, 220 could be an opening into which a furniture leg, such as the leg of a bed or a chair leg, is placed. Or 220 could be a solid surface at the top of the moat, in which case the moat could be used to protect an item, such as a box, that is placed upon the top of the moat. The protected item could be bait to which the target pests are attracted. Sometimes a target pest desires to wander away from the bait region, for example, to aggregate with other of the target pests, to mate, to hide elsewhere, or to feed elsewhere. Such a target pest would cross inner moat wall 205 and then the easily climbable material of inner moat wall cover 235, which surrounds inner moat wall 205. (If inner moat wall cover 235 is absent, the target pest would, instead, descend inner moat wall surface 240 until it reaches the top of barrier 250.) This target pest would descend the outer surface 230 of inner moat wall cover 235 to encounter the barrier 250. If this target pest is persistent, it would walk a long zigzag path along killing material that is held by the surface 230 of the inner moat wall cover 235, above the bather material 250. Eventually, this target pest might drop into the furrow 260, which contains some killing material. At this point, the target pest is at the point discussed previously for this embodiment.

The moat system shown in FIG. 2 could be modified in myriad ways. For example, the barrier material 250 could be positioned on the outer surface 280 of central moat wall 275 so that its smooth surface faces outward, away from the bait area. For bed bugs, for example, both barriers 250 and 286 could be constructed of smooth tape. Optionally, the barrier 286, with the inner facing smooth surface, could be constructed of the inside of a smooth plastic jar. One could make a prototype using, e.g., a smooth plastic medicine jar for the inward facing smooth surface, the inside surface of the jar being smooth enough that bed bugs have difficulty climbing it. Similar to the other embodiments, regardless of whether the target pests, such as bed bugs, are coming or going, they would tend to walk a long zigzag path along the killing material, such as, e.g., diatomaceous earth. Because of their exposure to the diatomaceous earth contained on the moat surfaces and in the furrow 260, bed bugs might die of dehydration. The same principle applies to other target pests using other killing material. Target pests would have a hard time leaving the bait region, as well as entering the bait region. The moat system could use only clinging material or only one or more furrows. In many situations it would, however, be advantageous for the moat system to use both clinging material and furrows.

Whether one chooses to design the moat system using one or two pieces of barrier material, and, if two pieces are used, the choice of position of the barrier material would depend on the circumstances. If they are both positioned on the central wall, then target pests would have great difficulty both entering and leaving the bait region; persistent target pests would walk a long zigzag path along the killing material, regardless of whether they are coming or going. If the barriers are positioned as shown in FIG. 2, however, the target pests would have some difficulty leaving the bait region, but they could still leave it by dropping over the side of the barrier. But once they are inside the furrow 260, they would be trapped inside it, unless they eventually find an imperfection in one of the barriers; by the time they find such an imperfection, they would have been exposed to ample killing material. The analysis is much the same for target pests that try to enter the bait region for the moat system depicted in FIG. 2.

### 1.2 Simple Prototype Designs for FIGS. 1-2 Applied to Bed Bugs

For the four legs of a bed, one could place each of four cleaned and dried empty cans (most any similar durable containers could be used), and place each bed leg inside one can. One could then securely wrap some very smooth tape, e.g., tape made with ultrahigh molecular weight polyethylene, around each can, fairly close to the bottom of the can. For the next step, one could then take one can or cap for each of the cans already being used to protect a bed leg, and place one such can or cap concentrically beneath each of the latter cans. It is probably generally easier to work with a can placed inside a cap. Some diatomaceous earth could then be sprinkled into the newly added can or cap, as well as the original can. Optionally, a second piece of smooth tape could be wrapped around the can directly above, and either touching or slightly overlapping, the first piece of smooth tape. If one chooses to wrap a second piece of smooth tape, one should position the second piece of smooth tape higher than the first to prevent any bedbugs from possibly finding a “platform” that would otherwise result from the lower piece of smooth tape, which might assist a bed bug in climbing the smooth tape.

The idea of this arrangement is that bed bugs that approach the bed from the outside first cross the first sea of diatomaceous earth, which is contained in the furrow bounded by the can and the cap, before encountering the smooth tape. This smooth tape encourages them, because they have great difficulty climbing it, to try again and again, walking along a zigzag path roughly parallel to, and, hopefully, across the first sea of diatomaceous earth. Also, bed bugs that are already in the bed, but would like to leave will first cross a sea of diatomaceous earth. Note that the smooth tape is located on the outside of the can into which the leg is placed. As a result, bed bugs that enter from the outside find the challenge of crossing the tape greater than bed bugs that are already in the bed but want to leave. Some bed bugs, regardless of whether they are coming or going, will struggle against the smooth tape until they drop into the furrow below, usually on their backs. This increased exposure to the diatomaceous earth would likely hasten their deaths from dehydration.

If the moat wall to which the smooth tape is adhered does not have easily climbable material, into which killing material has been rubbed, above and or below the smooth tape, it is important to adhere the smooth tape close to the sea of diatomaceous earth in the furrow formed by the can and cap. In general, to maximize the killing power, one should adhere the tape about as close as reasonably possible to the top surface of the diatomaceous earth in this furrow.

The outer side of the outer moat wall can be made rough, so that bed bugs can more easily enter the moat and so that the outer portion of the moat can hold diatomaceous earth well to its surface, by tightly wrapping some friction tape around the outer furrow, i.e., around the cap in this example, and then spreading a very thin layer of diatomaceous earth over the friction tape to vitiate its sticky quality. The addition of the very thin coat of diatomaceous earth to the tape would help reduce the possibility that the sticky quality might repel some bed bugs. One could also wrap powdered friction tape around the can, both above and below the smooth tape. When doing this, it is necessary that no bridge across the smooth tape is formed.

It would be desirable to design the moat so that all moat surfaces are easy for bed bugs to climb and so that they hold diatomaceous earth well to their surfaces. Instead of the plastic cap, curved balsa wood or cork sheet could advantageously be used. A simple method for curving balsa wood is to soak strips or sheets of balsa wood in ammonia and then bend the balsa wood around an object, such as a can or a barbell plate. Another possibility is to add small balsa wood or cork sheet bridges to the outer wall of the moat. Still another possibility is to use wood (such as balsa wood) and/or cork sheet for both moat walls. If the can is covered with easily climbable material, to which diatomaceous earth clings well, then the smooth tape should be positioned so that some of this easily climbable material lies both above and below the smooth tape. With this arrangement, diatomaceous earth can be rubbed into the easily climbable material, so that, regardless of whether bed bugs are coming or going, they will tend, because of the presence of the smooth tape, to walk a zigzag path parallel to the diatomaceous earth that has been rubbed into the material to which the smooth tape is adhered. And, oftentimes, they struggle against the smooth tape until they fall, usually on their backs, into the furrow of diatomaceous earth below.

Because a person sleeping in bed is particularly powerful bait for bed bugs, it would be a good idea to design at least some of the moats for protecting the bed legs so that both walls that bound the outer furrow of the moat are easily climbable. This strategy would help to kill as many bed bugs as possible, assuming, of course, that diatomaceous earth is rubbed into the easily climbable material. For most applications, a barrier comprised of only a single ¼″ wide piece of ultrahigh molecular weight polyethylene tape is adequate. However, because so many bed bugs are likely to struggle against the smooth tape in any such easily climbable moat for the bed, there is a higher probability than for most other moats that at least one bed bug will manage, somehow, to get past the smooth tape. Therefore, if one uses easily climbable moats for the bed, one might prefer to wrap two or more pieces of smooth tape around the central wall of each easily climbable moat (i.e., around the innermost moat wall of the two moat walls bounding the outer furrow); this would reduce the probability that a bed bug might successfully scale the smooth tape. If one layer of the smooth tape somewhat overlaps the other, the second layer that is adhered should be positioned above (i.e., further from the floor than) the first layer to be adhered; this will prevent bed bugs from using the upper edge of the second adhered layer of smooth tape as a support as they grope on the higher layer of smooth tape in search of a pit they can use for climbing. One should make sure that some of the easily climbable wall, to which the smooth tape is adhered, extends both above and below all the pieces of smooth tape, so that one can rub some diatomaceous earth into this easily climbable wall both above and below all the smooth tape; this would ensure that persistent bed bugs walk a long zigzag path along diatomaceous earth, regardless of whether they are trying to enter or exit the protected item. And, with a furrow containing diatomaceous earth below, many bed bugs will continue to struggle against the smooth tape at least until they drop into the furrow, usually on their backsides.

One possible drawback of the moats shown in FIGS. 1-2 is that they do not allow one to freely move the bed around without first temporarily removing the moats. An inability to freely move the bed around can, however, be advantageous because one would be unable to accidentally roll the bed up against a wall or furniture, which might result in a bed bug friendly bridge. If it is important to be able to freely roll the bed from place to place, other embodiments discussed in this patent can be used.

To enhance the dehydrating effect of the diatomaceous earth, one could place some desiccant, such as silicon dioxide gel, inside the box springs. This desiccant would help dry the air inside the box springs, which should help hasten the deaths of any bed bugs that are exposed to the diatomaceous earth. The relatively small volume of air within the box springs should enable the desiccant to last a relatively long time.

### 1.3 Cone Shaped Embodiments

FIG. 3 shows a perspective view of an embodiment in which cone shaped moat wall 380, with inner surface 370, and outer surface 360 is wrapped around a structure, such as a leg or other support for furniture, which supports the protected item, which serves as the bait to which the target pests are attracted. The surfaces 360 and 370 of the moat wall 380 could advantageously be comprised of material that the target pests find easy to climb and that holds the killing material well. Target pests that are attracted to the bait would climb the outer surface 360 of the outer moat wall 380 and then descend the inner surface 370 of moat wall 380. As they climb these surfaces, the target pests would climb along the killing material held by these surfaces. The furrow 390, which is formed by the junction between outer moat wall 380 and the leg or other support 300 for the bait, could advantageously contain killing material, so that target pests that attempt to reach the portion 350 of inner moat wall 305 that lies below the barrier material 340 must first crawl through the killing material contained in the furrow 390. Preferably, the surfaces 350 and 330, below and above barrier 340, respectively, are easy for the target pests to climb and hold the killing material well. Because of the barrier material 340, persistent target pests that try to reach the protected bait region will walk a long zigzag path along the killing material held by the portion 350 of the surface of inner moat wall 305 below barrier 340 as well as the killing material contained in furrow 390. Because of the barrier, target pests would have great difficulty reaching the protected bait region.

Although outer moat wall 380 is shown as having negligible thickness, it would in general have some finite thickness. Outer moat wall 380 could optionally be covered on the inner and/or outer surface (370 and/or 360, respectively) with some type of material that is easy for the target pests to climb and that holds the killing material well to its surface. The opening 395 is optional. The cone shaped outer moat wall 380, could be opened using the opening 395 and subsequently wrapped around the protected leg or support. The ends of the opening could then be fastened together in any one of numerous possible ways. For example, either Velcro, or elastic, or hooks could be used to fasten the ends of opening 395 together in such a manner that the edges that bound this opening 395 overlap with the outer moat wall enough that an air tight seal is formed at the bottom of furrow 390.

Target pests that are already in the bait region and want to exit the bait region, e.g., to aggregate with other target pests, to feed, or to mate, would first encounter the portion of moat wall 305 that lies above barrier 340. This portion of moat wall 305 that lies above barrier 340 comprises the junction 310 between the inner moat wall 305 and the leg or support for the protected bait; the outer portion 320 of the top of the inner moat wall 305; and the outer surface 330 of the portion of moat wall 305 that lies directly above barrier 340. All these surfaces, except barrier 340, would advantageously be easy for the target pests to climb and would advantageously hold the killing material well. Target pests that attempt to exit the protected bait region would encounter barrier material 340. If they are persistent, they would walk a long zigzag path along the killing material held by the surface 330 of inner moat wall 305 that lies above the barrier 340. Some of these target pests would struggle against the barrier until they drop over the side of barrier 340 and then land into the furrow 390, which lies between the leg or other support of the protected bait and outer moat wall 380, where the furrow advantageously contains killing material.

FIG. 4 depicts an embodiment, which is identical to that shown in FIG. 3, except for the additional barrier material 445 along the inner surface 470 of the outer moat wall 480. The operation of this moat system is similar to that of FIG. 2, except that the moat depicted in FIG. 4 has only one furrow 490. Target pests that try to reach the protected bait, which is supported by leg or other support 400, first climb the outer surface 460 of outer moat wall 480 and then descend along the inner surface 470 of outer moat wall 480 until they reach barrier material 445. If they are persistent, they walk a long zigzag path roughly parallel to the barrier material 445. It would be advantageous if the outer surface 460 and the inner surface 470 of the outer moat wall 480 are easy for the target pests to climb and hold the killing material well. Persistent target pests would walk long zigzag paths along any of the killing material that is held onto these surfaces as they struggle against the barrier 445. Some of these target pests might drop into furrow 490, which could advantageously contain killing material. Such target pests would become trapped because of the barrier material 445 and 440, which bound the furrow 490. If they are persistent, they would continue walking a long zigzag path along killing material that is held to the portions of the surfaces 470 and 450 of the outer moat wall 480 and the inner moat wall 405, respectively, which lie below the barriers 445 and 440, respectively. All surfaces, except the barriers 440 and 445, would thus advantageously be made of material the target pests find easy to climb and that holds the killing material well to its surface.

Target pests that try to exit the protected bait, which is supported by leg or other support 400, cross the junction 410 between the inner moat wall 405 and the leg or other support 400. They then cross the outer edge 420 of inner moat wall 405 and descend the outer surface 430 of the inner moat wall to reach barrier 440. Because they cannot easily cross the barrier 440, if they are persistent, they walk a long zigzag path parallel to barrier 440. Some of these target pests would likely drop over the side of bather material 440 and land into furrow 490 below. It would thus be advantageous for all the surfaces of the moat walls, excluding barriers 440 and 445, to be easily climbable by the target pests and to hold the killing material well. Thus with these surfaces holding killing material, target pests that try to exit the protected bait region would walk a long zigzag path along the killing material. If they wind up inside furrow 490, they would be virtually trapped because they would find the barrier material 440 and 445 to be hard to climb.

The embodiment shown in FIG. 2 could have been designed much like that shown in FIG. 4, with only one furrow, which is bounded by two bathers. Conversely, the moat system shown in FIG. 4 could have been designed using two furrows similar to the moat system shown in FIG. 2. This invention is amenable to virtually countless effective embodiments. Which embodiment is best depends on the precise application, and even for a given application, whether one embodiment is better than another is oftentimes a matter of opinion.

### 1.4 Simple Prototype Designs for FIGS. 3-4 Applied to Bed Bugs

A prototype for a moat system as shown in FIG. 3 or 4 could be designed by cutting a strip of cork sheet; wrapping and adhering it around the furniture support; tightly wrapping and adhering a piece of smooth tape, such as ultrahigh molecular weight polyethylene tape, around the cork sheet; cutting a plastic cup along a side; cutting out the bottom of the plastic cup; and, optionally, adhering smooth tape, such as ultrahigh molecular weight polyethylene tape, to the inside and/or outside of the plastic cup, so that the smooth tape is arranged as the barriers are revealed to be arranged in the figures. The bottom of the plastic cup is adhered to the furniture support, e.g., using tape or Velcro, and diatomaceous earth is rubbed into the cork sheet and sprinkled inside the plastic cup. To enhance the killing power of the moat, a strip of cork sheet can be wrapped around the plastic cup, and adhered to the cup, e.g., using glue. Some diatomaceous earth could then be rubbed into the cork sheet. Similarly, a strip of powdered cork sheet could be positioned inside the plastic cup, provided that the cork sheet does not form a bridge across the smooth tape over which bed bugs can crawl. Regardless of whether the bed bugs are coming or going, they would wind up walking a long, typically zigzag, path along the diatomaceous earth.

### 1.5 Rectangular Embodiments

FIG. 5 shows an exploded view of an embodiment, which is, in several respects, similar to those shown in FIGS. 3 and 4. The moat system shown in FIG. 5 protects an item that is supported by a leg or other support of square or rectangular cross section. (A support with a cross section of any other shape could have a similar moat system designed; a moat system with a square or rectangular cross section is being provided as an illustrative example.) Such a leg or other support is common for exercise machines, although it is also used for many other types of furniture. The leg or other support is inserted through opening 500 in such a manner that the leg or other support does not touch the inner surface 520 of the inner moat wall 550 at any point, except, possibly, at the bottom 540 of the inner moat wall 550. A furrow is thus formed between the leg or other support for the protected item and the surface 520 of the inner moat wall. The general location of this furrow is indicated by 525. Similarly, outer moat wall 585 is slid up through the leg or other support, so that the inner surface 560 of the outer moat wall 585 touches neither the leg or other support nor the outer surface 545 and 510 of the inner moat wall. A furrow thus formed between the two moat walls 550 and 585 is indicated as 535. The inner moat wall 550 could be slid into the opening 590 in the outer moat wall 585 until outer moat surface 545, which lies below barrier 515, of inner moat wall 550 makes contact with surface 570. Optionally, the bottom 540 of inner moat wall 550 could rest on the furrow floor 575 of the outer moat wall 585. The end result is two furrows, one (525) bounded by the leg or other support and inner surface 520 of inner moat wall 550, and the other (535) bounded by outer surface 545, which lies below barrier 515, of the inner moat wall 550 and the inner surface 560 of outer moat wall 585.

The operation of the moat system depicted in FIG. 5 is as follows. A target pest, which is attracted to the bait region, which is supported by a leg or other support, which runs through openings 500 and 590, climbs outer surface 595 of outer moat wall 585. It then enters the furrow 535, which is bounded below by furrow floor 575, by climbing surfaces 580 and 560 of outer moat wall 585. Preferably, the target pest finds outer moat wall 585 easy to climb, and, preferably, the material out of which outer moat wall 585 is constructed holds the killing material well to its surface. With killing material rubbed into all the surfaces of outer moat wall 585 and with killing material contained in the furrow 535 bounded below by furrow floor 575, this target pest would be exposed to the killing material. The target pest would then climb the outer surface 545, which is below barrier 515, of inner moat wall 550 until it reaches barrier material 515. Because of the orientation of the barrier material 515, the target pest would, for many applications, find it particularly difficult to climb. The outer surface 545, which lies below barrier 515, of inner moat wall 550 would advantageously be easy for the target pest to climb and hold the killing material well to its surface. The persistent target pest that is attracted to the bait would thus, as a result of its struggle with barrier 515, walk a long zigzag path along the killing material held by the portion 545 of the outer surface of inner moat wall 550, which lies below the barrier 515.

Target pests that are already in the bait region might wish to exit the bait region, e.g., to mate, feed, or hide. Such a target pest would descend the leg or other structure that supports the protected bait and that runs through the openings 500 and 590. It would walk through the furrow 525, which is bounded by the leg or other structure and the inner surface 520 of the inner moat wall 550. This furrow 525 preferably contains killing material, so that the target pest must crawl through the killing material as it tries to exit the bait region. The target pest then climbs up inner surface 520, along top surface 505, and down surface 510, which lies above barrier 515, of inner moat wall 550 until it reaches barrier 515. It would be advantageous if all the surfaces, excluding barrier 515, are easy for the target pests to climb and hold the killing material well. The persistent target pest that attempts to exit the bait region would thus, upon encountering bather 515, walk a long zigzag path along the killing material held by the portion 510 of the surface of inner moat wall 550, which lies above the barrier 515. The target pest might at some point drop over the side of bather 515. For this reason, it would be advantageous to design the moat system, so that barrier 515 is located above the furrow 535, which is bounded below by furrow floor 575. With this arrangement, the target pest would land in the furrow 535 below, which would, preferably, contain killing material.

### 1.6 Simple Prototype Designs for FIG. 5 Applied to Bed Bugs

A prototype of the moat system shown in FIG. 5 can be designed by proceeding in much the same manner as described above for prototypes for FIGS. 3-4, except using a square or rectangular plastic planter or pot of the type used for containing transplants for purchase at garden centers. Several pieces of balsa wood can be cut and glued together to form the furrow 585. Diatomaceous earth could be sprinkled into the latter furrow, as well as the furrow formed by the space between the moat wall 550 and the furniture support that is protected by this moat system. Diatomaceous earth should then be rubbed into all moat walls, such as those comprised of balsa wood, which hold diatomaceous earth well to their surfaces. Cork sheet could advantageously be adhered to the inner moat wall 550, so that diatomaceous earth can be rubbed into this cork sheet. Regardless of whether bed bugs are coming or going, they would walk a long zigzag path along the diatomaceous earth.

2. Protection of Items placed on Top of a Moat

A moat system can be designed, in accordance with this invention, to support heavy items, such as ankle weights. An example is the rectangular moat system shown in FIG. 6. A target pest, which desires to enter the protected item supported on block 600, which could be constructed of, e.g., durable wood, crawls up the outer surface 610 of moat wall 620 and down the inner moat wall surface 630 of moat wall 620. The target pest then enters furrow 640 and subsequently climbs up the portion 670 of the inner surface of the inner moat wall that lies below barrier 660. It would thus be advantageous if both moat walls, and all their surfaces, 610, 620, 630, 670, and 650, excluding barrier 660, are constructed of material that is easy for the target pests to climb and that holds the killing material well. With the killing material held by all these surfaces, as well as the furrow 640, a persistent target pest would crawl along considerable killing material, including that which lies along its long zigzag path, which is parallel to the barrier 660. Target pests that desire to leave the bait, which is supported by the block 600, would crawl down the portion 650, of the inner moat wall, which lies above barrier 660. The portion 650 of the moat wall that lies above barrier 660 should be easy for the target pests to climb and should hold the killing material well. With the killing material held by the surface 650 of the inner moat wall, which lies above barrier 660, persistent target pests that try to exit the protected bait would walk a long zigzag path along the killing material held by the portion 650 above bather 660. Some of these persistent target pests would eventually drop into the furrow 640 below and into any killing material that is present in furrow 640.

### 2.1 Simple Prototype Designs for FIG. 6 Applied to Bed Bugs

A fairly sturdy piece of wood, such as one made of basswood, could be used for block 600. A piece of smooth tape, such as ¼″ wide ultrahigh molecular weight polyethylene tape, is adhered around the periphery of the wood block. Some space is left both above and below this smooth barrier, so that diatomaceous earth can be rubbed into the wood both above and below the smooth barrier. Pieces of balsa wood are cut up and glued together to form the moat walls 620. Diatomaceous earth is sprinkled into the furrow 640 and rubbed into all the wooden surfaces, which hold diatomaceous earth well.

### 3. Protection of an Enclave

FIGS. 7 and 8 show similar moat systems except that the barrier material 780 is on the outer surface of the inner moat wall, but the barrier material 880 is on the inner surface of the outer moat wall for the respective figures. For both moat systems, all material and all the surfaces, except the barrier material 780 and 880, would advantageously be easy for the target pests to climb and would advantageously hold the killing material well. In FIG. 7, target pests that try to enter the protected bait located in region 790 would climb the surfaces 700, 710, and 720 of the outer moat wall, would enter furrow 750, and would climb the portion 760 below the barrier material 780. If persistent, a target pest would walk a long zigzag path along any killing material rubbed into the surface 760 of the inner moat wall. It would thus be advantageous for all moat surfaces (except barrier 780) to be easy to climb and to hold killing material, and it would also be advantageous for the furrow 750 to contain killing material because such a persistent target pest would also tend to walk a long zigzag path through and near the furrow 750. Target pests that wish to leave the protected bait area 790 will climb up the inner surface 730 and top surface 740 of the inner moat wall. They would then descend the surface 770 of the inner moat wall that lies above the barrier 780. They would tend to walk a long zigzag path along any killing material held by the surface 770 that lies above barrier 780. Eventually, some of such target pests will drop over the side of barrier 780 and into furrow 750 below.

The primary functional difference between the moat systems of FIG. 7 and FIG. 8, is that, whereas for the former entrance by the target pests into the bait area 790 is harder than exit, for the latter it is exit from the bait area that is more difficult. A target pest that tries to enter the bait region 890 climbs the outer and top surfaces, 840 and 830, respectively, and then descends the surface 870 of the outer moat wall until it encounter barrier 880. All surfaces, except barrier 880 would advantageously be made of material that is easy for the target pests to climb and that holds the killing material well to their surfaces. Thus, persistent target pests that try to enter the protected bait region 890 will walk a long zigzag path along the killing material held by surface 870 above barrier 880. Eventually, such a persistent target pest might drop over the side of barrier 880 and land into furrow 850 below, which would advantageously hold killing material. A target pest that tries to leave the bait region 890 would first climb the surfaces 820, 810, and 800, of the inner moat wall. It would then crawl through furrow 850 and then climb the surface 860 of the outer moat wall that lies below barrier 880. If persistent, the target pest would walk a long zigzag path along any killing material held by the surface 860 below bather 880 or by furrow 850. It might then drop into the furrow 850, below, which would advantageously hold killing material. It would, again, thus be advantageous for all material of which this moat system is constructed, except the barrier material 880, to be easy for the target pests to climb and to hold the killing material well.

In the above discussion, we assumed that the protected bait is located in region 790 for FIG. 7 and in region 890 for FIG. 8. It is possible for the protected bait to instead be located on the opposite side of either moat, i.e., outside the outer moat wall. It should also be noted that the choice of design between that shown in FIG. 7 and that shown in FIG. 8, depends on the application, as well as on personal preference. Suppose, for example, that the target pests are bed bugs. If the protected bait is located in region 790 in FIG. 7, the protected bait might be, e.g., a human, clean clothes, or exercise equipment. Because of the orientation of the barrier 780, which could be smooth material for bed bugs, it would be much more difficult for bed bugs to reach the protected item than for them to exit it. If the protected bait is located in region 890 in FIG. 8, the protected bait might instead be dirty clothes that will be washed and dried at high heat before reuse. For the latter case, it is much harder for bed bugs to exit the protected item once they reach it than it would be for them to leave it. These target pests would thus either die of dehydration or would die from being washed and dried at high heat before the clothes are ever reused.

The relative dimensions of the various parts of the moats shown in FIGS. 7 and 8 can be radically different from those shown in the figures. For the case of bed bugs, the moat system shown in FIG. 7 could be used to protect a person while the person is resting or exercising in his or her favorite location. For this case, protected bait region 790 would be much larger relative to the furrow 750. The moats shown in FIGS. 7 and 8 could also be used, with appropriate modification of the relative dimensions, to protect the insides of drawers, e.g., for dressers and chests. The design in FIG. 7 could be used to help kill target pests, e.g., bed bugs, that approach the contents of a drawer, while helping to keep them away from the contents. For bed bugs, it would be helpful to also arrange some smooth material, such as smooth tape, directly above the drawer to prevent bed bugs from dropping into the drawer. The design in FIG. 8 could help keep bed bugs that manage to enter the contents of the drawer from exiting the drawer to reinfest the remainder of the item of furniture to which the drawer belongs. Dirty clothes that will be washed and dried at high heat before reuse could thus be used as bait to lure bed bugs away from hiding in the remainder of the item of furniture. The moat systems depicted in FIGS. 9-11 could similarly be used to protect the insides of drawers.

The moat shown in FIG. 9 is the same as that shown in FIG. 7, except that the moat shown in FIG. 9 has one additional furrow 950. A pest that desires to enter the protected bait region 990 climbs the outer moat wall along the surfaces 985, 965, and 955 of the outer moat wall. It then crosses furrow 975 and climbs the surface 960 of the central moat wall that lies beneath barrier 980. A persistent target pest would walk a long zigzag path parallel to the barrier 980. It would thus be advantageous for all these surfaces (except barrier 980) to be easy for the target pests to climb and for them to hold the killing material well. With the killing material held by these surfaces and in the furrow 975, persistent bed bugs would walk an indefinite distance along the killing material. Some of these target pests are likely to struggle against barrier 980 until they drop into the furrow 975 below.

Target pests that are already in bait region 990 might want to exit in order, e.g., to mate, feed, or hide. They cross the surfaces 920, 910, and 900 of the inner moat wall. They then cross furrow 950, climb inner surface 940 and top surface 930 of the central moat wall, and then descend the portion 970 of the surface of the central moat wall that lies above barrier 980. Persistent target pests that encounter this barrier 980 wind up walking a long zigzag path parallel to the barrier 980. Some of them might drop into the furrow 975 or furrow 950. For this reason, it would be advantageous for all the moat surfaces, except barrier 980, to be easy for the target pests to climb and for all of these surfaces, except barrier 980, to hold the killing material well. Furrows 950 and 975 should, of course, also hold some killing material.

FIG. 10 shows a moat system that uses two barriers 1070 and 1080. In contrast to the moat system shown in FIG. 11, the barriers are held by different moat walls and face each other. With this design, target pests would have difficulty with both entry to and exit from the protected bait region. Once a target pest drops over the side of one of the barriers 1070 or 1080, it would have extreme difficulty exiting furrow 1050, which would act as a type of trap, because of the presence of these two barriers 1070 and 1080. The rest of the analysis is identical to that already shown for the previously discussed moat systems. Target pests that try to enter the protected bait region 1090 climb the outer moat wall surfaces 1055, 1060, and 1040; cross furrow 1075; and climb the central moat wall surfaces 1087, 1065, and 1095. They descend portion 1095 of the central moat wall until they encounter barrier 1080. If persistent, they walk a long zigzag path along the top of barrier 1080. Some of these persistent target pests drop over the side of barrier 1080 and land into the furrow 1050 below. All surfaces of the moat, excluding the barriers 1070 and 1080 would thus advantageously be easy for the target pests to climb and would hold the killing material well. Furrows 1050 and 1075 should also hold killing material. As with the other moats discussed above, such target pests would thus get abundant exposure to the killing material.

Target pests that try to exit the protected bait region 1090 climb the surfaces 1020, 1010 of the inner moat wall and then crawl along the portion 1000 of the surface of the inner moat wall until they reach the barrier 1070. If persistent, they walk a long zigzag path along the top of the barrier 1070. Some such target pests might drop over the side of barrier 1070 and land into the furrow 1050 below. It would, thus, be advantageous for all moat surfaces, excluding barriers 1070 and 1080, to be easy for the target pests to climb and to hold the killing material well. Furthermore, killing material should be contained in furrow 1050. With this arrangement, regardless of whether target pests are coming or going, they will get ample exposure to the killing material.

FIG. 11 shows a moat system that is much like that shown in FIG. 10, except that for FIG. 11 both barriers are held by the central wall and face in opposite directions. As with the other moat systems discussed above, it would be advantageous for all moat wall surfaces, except the barriers 1180 and 1120, to be easily climbable by the target pests and to hold the killing material well. It would also likewise be advantageous for both furrows 1150 and 1175 to contain some of the killing material. Target pests that try to reach the protected bait region 1190 climb the surfaces 1155, 1160, and 1185 of the outer moat wall. They then cross the furrow 1175 and climb the portion 1165 of the central wall that lies below barrier 1120. Target pests that are already inside the protected bait region and try to leave, e.g., to mate, feed, or hide, climb the inner moat wall surfaces 1100, 1110, and 1115. They then crawl along furrow 1150 and climb the portion 1130 of the inner surface of the central moat wall that lies below barrier 1180. Regardless of whether they are entering or exiting the bait region, persistent target pests would walk a long zigzag path parallel to a barrier material, which would be 1120 if they are entering and 1180 if they are exiting. It would, therefore, be advantageous, again, for all materials, except the barriers 1120 and 1180, to be easy for the target pests to climb and to hold the killing material well. The furrows 1150 and 1175 should also contain some killing material. Target pests would then walk along ample killing material; they would walk through killing material contained in furrow 1175 and along zigzag paths along killing material held by the portion 1165 of the central moat wall below barrier 1120 if they are entering the bait region; they would, similarly, walk through killing material contained in furrow 1150 and along zigzag paths along killing material held by the portion 1130 of the central moat wall below barrier 1180 if they are exiting the bait region.

### 3.1 Simple Prototype Designs for FIGS. 7-11 Applied to Bed Bugs

We typically have certain locations, in our abodes, where we spend considerable time. For example, we might have a computer table at which we habitually spend considerable time surfing the Internet. Bed bugs might feed on a person while the person relaxes at such a location, and they might detect body odor at the location, so that they choose to hide within cracks or crevices, waiting to get the opportunity to feed on any person who tries to relax at the location. It would thus be of interest to design a moat system that would protect anyone who spends considerable time at a preferred location.

The moat systems shown in FIGS. 7-11 can be used to accomplish this objective. The moat walls can be constructed of pieces of balsa wood, which are glued together, and joints or junctions between pieces of balsa wood can be strengthened by gluing either popsicle sticks or pieces of basswood across the joints or junctions. Smooth, ultra high molecular weight polyethylene tape can be used for the barriers, shown in FIGS. 7-11 as being adhered to at least one moat wall. Any number of furrows can be built in this manner, and they can be either bottomless or have bottoms. A good example of a design, which can be viewed as lying somewhere between bottomless and having a bottom could be made by using a tape dispenser to score some ¼″ by ¼″ balsa wood sticks on all four sides, rubbing diatomaceous earth into the scored balsa wood sticks, and then placing the balsa wood sticks between moat walls, so that they serve as the bottom(s) of the furrow(s). In general, the bottoms of the furrows, which can help reduce the tendency of the diatomaceous earth to spill out and onto the surrounding floor, can be made of many possible materials, such as balsa wood, basswood, indoor weather stripping, etc.

As with the other prototypes discussed in this disclosure, diatomaceous earth should be rubbed into all surfaces, such as those comprised of balsa wood, which hold diatomaceous earth well. With moats designed as shown in FIGS. 7-11, regardless of whether bed bugs are coming or going, they would tend to walk long zigzag paths along the diatomaceous earth that is rubbed into the balsa wood and/or held in the furrow or furrows.

### 4. Cross Sectional Views of Typical Moat Segments

FIGS. 12 and 13 show small segments of a typical moat that has two barriers. For each of these figures, the sketch on the left hand side shows a cross-sectional view, while that on the right shows a side view. In FIG. 12, the moat walls 1200 together form a furrow 1220. These two moat walls 1200 could be bounded on the left and/or right by any number of other moat walls. Barriers 1210 are difficult for the target pests to cross from above, but are much more difficult for them to cross from below because to cross from above they need only drop into furrow 1220 below. Target pests that drop into furrow 1220 tend to become trapped inside the furrow because they have great difficulty scaling the barriers 1210. In FIG. 13, the moat walls 1300, together with the central moat wall 1330, form furrows 1320. These three moat walls 1300 and 1330 could be bounded on the left and/or right by any number of other moat walls. Neither of the moat walls 1300 is strictly necessary; if they are absent, it is particularly important to arrange the moat wall 1330 so that it holds plenty of killing material. Barriers 1310 are difficult for the target pests to cross from above, but are much more difficult for them to cross from below because to cross from above, they need only drop over the side of one of barriers 1310.

### 5. Protection of Doors

FIG. 14 shows a moat system for protecting a door 1420, such as an entrance/exit door or a closet door. Barrier 1430 and 1495 runs along the horizontal and vertical portions, respectively, of the door jamb. Optional, easily climbing material 1410 and 1440, which could conveniently be shaped in the basic form of sticks, is affixed to the door jamb alongside the barrier 1430 and 1495. Barrier 1400 is affixed to the bottom of the wall so that its length is parallel to the floor and slightly elevated as explained next. Lying on the floor, directly in front of the door 1420 is a moat, which is shown only in outline form in FIG. 14 as 1499. Barrier 1400, 1430, and 1495, in a particularly simple and common embodiment, join up with a barrier, which is part of moat 1499. The total composite barrier is continuous and closed, and, in a particularly simple and common embodiment, such as when the barrier comprises smooth material, which is difficult for the target pests to climb, the barrier at all points lies approximately in a vertical plane.

Target pests that enter through the door, either through cracks in the sides or top of the door, or through the bottom of the door, are guided by the portions 1430 and 1495 of the barrier downward and into moat 1499. As they ascend and/or descend the door jamb, they crawl along the material 1410 and 1440, which is arranged alongside the door jamb. This material 1410 and 1440 would advantageously be easy for the target pests to climb and hold the killing material well to its surface. With plenty of killing material held by these sticks 1410 and 1440, the target pests would be exposed to plenty of killing material. For any portions of the door jamb that do not have these sticks 1410 and 1440, which hold killing material to their surfaces, the barrier 1430 and/or 1495 would serve as a guide, which would guide persistent target pests, which follow them in any one direction, into material, such as the sticks 1410 and 1440 and the moat 1499 below. The barrier 1400, which could be affixed to walls of the abode or to moat walls, helps to prevent target pests from climbing up the walls and, preferably, has some killing material arranged beneath it. Thus, with this arrangement, persistent target pests that try to enter this doorway would tend to walk long zigzag paths along killing material, which is located near the barrier, 1400, 1430, and 1495. The moat, which is located beneath the door in FIG. 14, also comprises a barrier, which makes entry into the living area particularly difficult. In a particularly simple embodiment, this latter barrier material can be arranged to lie in the vertical plane, in the same manner as all the other aforementioned bather material.

FIG. 15 shows a top view of an embodiment of a moat, which can be used as the moat 1499 beneath the door 1420, shown in FIG. 14, as well as the manner in which it can be made to connect with the remainder of this moat system for protecting a door. Bather 1500 is a top view of bather 1400 shown in FIG. 14. Bather 1595 is a top view of bather 1495 shown in FIG. 14. Barrier 1530 is a top view of bather 1430, which is shown in FIG. 14. Sticks 1510 and 1540 are top views of the sticks 1410 and 1440, shown in FIG. 14. Door 1420 in FIG. 14 is shown from the top as 1520 in FIG. 15. The base, 1550, 1570, and 1575, of the moat could be either one single piece or several separate pieces affixed together. This base would advantageously be easy for the target pests to crawl along and would advantageously hold the killing material well to its surface.

Moat sticks 1560, 1585, and 1590 are affixed to the base. These moat sticks would advantageously be easy for the target pests to climb and hold the killing material well to their surfaces. Barrier 1580 is affixed to moat stick 1590 in such a manner that the target pests, although they would have some difficulty exiting the living area 1505 to approach the door 1520, would have much greater difficulty exiting the region of the door 1520 to enter the living area 1505. A portion 1593 of barrier 1500 lies directly above moat sticks 1585. The composite barrier, which comprises barriers 1500, 1530, 1580, 1593, and 1595, is continuous, so that the target pests have great difficulty finding an opening in the barrier through which they can crawl. In a particularly simple and common embodiment, e.g., wherein all barrier material is comprised of material that is too smooth for the target pests to climb, this continuous composite barrier, at each point, lies approximately within a vertical plane, so that it never forms an angle with the vertical, which might give the target pests an advantage in their attempts to climb it. Moat stick 1560 may or may not have a barrier affixed to it. The portion 1550 of the moat base is a furrow formed by the two moat sticks 1560 and 1590 (plus barrier 1580). As with any other furrow, the base of this furrow can be advantageously constructed of clinging material, i.e., material that the target pests find easy to climb and that holds the killing material well to its surface. A small amount of killing material could then be rubbed into the bottom surface of the furrow. This arrangement could be particularly advantageous if the moat walls bounding this furrow must be low enough that the door cannot hit the top of the moat when the door opens.

The moat system shown in FIGS. 14 and 15 works as follows. Target pests that attempt to enter the living area 1505 from the door 1420 and 1520 are guided by the barrier at 1400, 1500, 1593, 1495, 1595, 1430, 1530, and 1580 so that they walk a long zigzag path parallel to the barriers and, hence, along any killing material held by the easily climbable material of which 1410, 1510, 1440, 1540, 1550, 1560, 1570, and 1499 are comprised. The target pests would also crawl along any killing material contained in the furrow formed by the moat base 1550 and the moat sticks 1560 and 1590. Target pests that try to exit the living area 1505 would crawl along the (preferably) easily climbable material 1575, 1585, and 1590. Portion 1593 of bather material 1500 would induce any target pests that crawl along the moat sticks 1585 to walk a long zigzag path parallel to the barrier and, thus, along any killing material held by the moat sticks 1585. Target pests that crawl along moat stick 1590 and are afraid of dropping over the side of barrier 1580 would walk a long zigzag path parallel to barrier 1580 and, thus, a long zigzag path along any killing material held by the moat stick 1590. Some of these target pests might drop over the side of the barrier 1580 and land into the furrow 1550 below. For this reason, all surfaces of this moat system, excluding the barriers, would advantageously be easy for the target pests to climb and would hold the killing material well to their surfaces. It would also be advantageous for the furrow 1550 to contain some killing material.

The moat system shown in FIGS. 14 and 15 can be modified in myriad ways in accordance with the present invention. For example, climbing sticks 1585 can be left uncoated with killing material, omitted altogether, or replaced by furrows. Also, barrier 1593 is not strictly necessary.

In some cases, moat systems shown in FIGS. 14 and 15 suffer from the disadvantage that the door swings back and forth directly above the bottom portion of the moat system. The door might repeatedly bump into, and rub the top of, the portion of the moat system that is arranged along the floor. Air drafts could sweep some of the killing material out of the moat system. It could thus be advantageous to build this moat system so that it is located on the other side of the door, usually in a hallway. For bed bugs, for example, a landlord could apply smooth tape along the outside of the door jamb, i.e., on the side of the door jamb located outside the living area. A moat, which comprises a moat furrow, made of durable material could be built beneath the door and on the side of the door which is outside the living area. This moat could, for example, be constructed of sheet metal or durable wood. A ¼″ by ¼″ balsa wood stick, which could be scored using a tape dispenser, could be coated with killing material, which for bed bugs could be diatomaceous earth, and then placed inside the moat furrow. Smooth tape could be arranged along the furrow beneath the door so that it lies above the balsa wood stick. The smooth surface of the tape would face outward, toward the hallway. Scored balsa wood sticks could be coated with diatomaceous earth and then arranged along the door jamb on the outer side of the smooth tape that is adhered to the door jamb. Regardless of whether they are coming or going, bed bugs would tend to walk a long zigzag path parallel to the diatomaceous earth contained in, and carried on the surfaces of, this moat system.

### 5.1 Simple Prototype Designs for FIGS. 14-15 Applied to Bed Bugs

In an apartment complex that is infested with bed bugs even the best of pest control methods are limited in their effectiveness if bed bugs enter an apartment through a door. The embodiment shown in FIGS. 14 and 15 is designed to guide bed bugs that enter, e.g., an apartment or condominium unit, through a sea of diatomaceous earth and to maximize their exposure to this deadly powder.

To construct the barrier shown in the figures, one can adhere smooth tape, such as ¼″ wide ultrahigh molecular weight polyethylene tape, all along the sides and top of the door jamb. If this arrangement is located inside the abode, some ¼″ by ¼″ balsa wood sticks can be scored using a tape dispenser, and then arranged alongside the door jamb, so that it is positioned nearer the door than the smooth tape. If this moat system is located outside the abode, these sticks could then be arranged along the door jamb, on the side of the hallway outside the abode, so that they are positioned further from the door than the smooth tape. Bed bugs that enter the abode would have no choice but to enter the moat below, which could generally be constructed as shown in FIG. 15.

The moat sticks 1560, 1585, and 1590 can be constructed of ¼″ by ¼″ balsa wood sticks, which have been scored by a tape dispenser. These sticks can be glued together and to a sheet of balsa wood 1550, 1570, and 1575. Smooth tape can then be adhered along one of these balsa wood sticks, so that the smooth surface faces away from the living area. The bather, which could be comprised entirely of smooth tape, should form one continuous demarcation between the target pest region, which is normally infested with many bed bugs, for the present embodiment, and the bait region, in which the potential blood meals for bed bugs are located. This bather should also be oriented in such a manner that bed bugs have great difficulty climbing it. For example if the barrier is ¼″ wide ultrahigh molecular weight polyethylene tape, then if at each point the tape is oriented so that its width is directed approximately vertically (i.e., so that the tape at each point lies approximately in the vertical plane) then bed bugs would have great difficulty climbing it.

It would be advantageous to design this moat system so that it is positioned outside the abode because the door usually swings directly over the moat system if it is located inside the abode. This swinging door would tend to rub against the top of the moat, unless there is enough leeway between the top of the moat below the door and the bottom of the door. The swinging door would also tend to blow some of the diatomaceous earth out into the hallway outside the abode. If the moat system for protecting the door is built outside the abode, it can be constructed of very durable material, such as sheet metal or hardwood. Regardless of whether the moat system is built inside or outside the abode, and regardless of whether bed bugs are coming or going, they would tend to walk a long zigzag path along diatomaceous earth, which would tend to greatly hasten their deaths.

### 6. Protection of Windows, Curtains, and Drapes

FIG. 16 shows a moat system for protecting windows, curtains, and drapes. The window, window frame, and window sill are 1685, 1695, and 1665, respectively. The curtain rod is 1670. Target pests that try to exit the area of the windows, curtains, and drapes, crawl along climbing sticks 1660 and 1680 because barrier 1650 and 1690 prevents them from walking directly to wall 1675. Barrier 1650 and 1690 thus acts as a guide. It would, therefore, be advantageous if the climbing sticks 1660 and 1680 are easy for the target pests to climb and hold the killing material well to their surfaces. Target pests that try to exit the windows, curtains, and drapes would thus walk long distances along killing material held by the surfaces of climbing sticks 1660 and 1680. The target pests, which try to exit the area, are guided downward into the moat bounded by the wall 1675 and the moat wall 1620. Barrier 1600 and 1610, which is shown affixed to the inner surface of moat wall 1620, but which could instead be affixed to the outer surface of moat wall 1620, makes escape from the moat difficult. Persistent target pests that try to exit would thus be compelled to walk a long zigzag path along any killing material held by the surface of the moat wall 1620, which would thus advantageously be easy for the target pests to climb and hold the killing material well to its surface. The moat could optionally hold a climbing stick 1655 at its bottom, which holds killing material on its surface. If barrier 1600 and 1610 faces inward, as shown in FIG. 16, target pests would have a much more difficult time exiting the protected area than entering it. The opposite would be true if the barrier were facing in the opposite direction. With the barrier 1600 and 1610 facing inward, target pests that try to enter the protected area would climb up the outer surface of moat wall 1620 and then down the inner side of the moat wall 1620 until they encounter barrier 1600 or 1610. If persistent, they would walk a zigzag path along any killing material held by the surface of moat wall 1620 above barrier 1600 or 1610.

If the barrier 1600 and 1610 instead faces outward, target pests that try to exit the protected area would walk a long zigzag path along the portion of moat wall 1620 that lies above barrier 1600 or 1610, and those that try to enter the protected area would walk a long zigzag path along the portion of moat wall 1620 that lies below the barrier 1600 or 1610. In any of these cases, it would be advantageous if all materials, except barriers 1650, 1690, 1600, and 1610, were easy for the target pests to climb and capable of holding the killing material well to their surfaces. Thus, any target pests that try to enter or exit the protected region, i.e., the windows, curtains, and drapes, would walk a long zigzag path along any killing material that is held by these surfaces.

If the target pests are, e.g., bed bugs, the bathers 1650, 1690, 1600, and 1610 could be smooth material, such as smooth tape. In this case, it would usually be best to maintain all the barriers above the slanted portion of the wall 1630, so that they lie in the vertical plane, which would make them more difficult for bed bugs to climb. 1640 represents a portion of the bottom of the wall, which lies in the vertical plane.

FIGS. 17 and 18 show a top view of two embodiments of the moat shown in FIG. 16. For FIG. 17 and FIG. 18, we have, respectively: the wall is 1700 and 1800; the optional climbing stick is 1740 and 1840; the horizontal running bather is 1750 plus 1760 and 1850 plus 1860 plus 1870; the furrow is 1730 and 1830; the vertical barrier is 1710 and 1810; and the moat wall is 1720 and 1820. For FIG. 17, the barrier affixed to moat wall 1720 faces outward, away from the moat, but for FIG. 18, it faces in the opposite direction. For both figures, the barrier is continuous, so that no target pest could enter or exit the protected area without crossing the bather, which is designed so that the target pests have great difficulty crossing it. For some arrangements, e.g., if the bather is smooth material, such as smooth tape, it would be advantageous to arrange all barriers so that they lie in the vertical plane, or are oriented so that climbing them would be very difficult for the target pests.

For both figures, any target pests that try to enter or exit the protected area are guided by the vertical barrier 1710 and 1810 (or, for FIG. 18, horizontal bather 1870) into the moat. In FIG. 17, target pests that try to enter the protected region would walk a long zigzag path along the portion of moat wall 1720, which lies below barrier 1750 and 1760. In FIG. 18, these pests would instead walk a long zigzag path along the portion of moat wall 1820, which lies above bather 1850 and 1860. For FIG. 18, some of these target pests are likely to drop into either the furrow 1830 or the climbing stick 1840. With all surfaces, except the barriers, easy for the target pests to climb and holding plenty of the killing material, and with the furrows 1730 and 1830 also holding killing material, persistent target pests that try to enter the protected region would thus get ample exposure to the killing material.

In FIG. 17, target pests that try to exit the protected region would walk a long zigzag path along the portion of moat wall 1720, which lies above bather 1750 and 1760. In FIG. 18, these pests would instead walk a long zigzag path along the portion of moat wall 1820, which lies below barrier 1850 and 1860. With all surfaces, except the bathers, easy for the target pests to climb, and with all these surfaces, except the bathers, holding plenty of the killing material, persistent target pests that try to exit the protected region would thus get ample exposure to the killing material.

For some situations and for some pests, it might be advantageous to spread some killing material over barrier 1750 and 1760 or bather 1850 and 1860 (assuming this bather holds the killing material well to its surface); this could be advantageous for, e.g., cockroaches and ants that have adhesive pads because, for such target pests, fine particulate matter could be coated in combination with killing material onto the bather 1750 and 1760 or bather 1850 and 1860, as explained previously in this disclosure.

An advantage of the arrangement of FIG. 18 is that, regardless of whether a target pest is trying to exit or enter the protected region, it might drop into either the furrow 1830 or the climbing stick 1840; for many arrangements, this can be particularly lethal for any targets pests. FIG. 17 could be advantageous, however, if it is particularly important to keep the target pests out of the protected region; with the arrangement in FIG. 18, a pregnant target pest might cross to enter the protected region and then survive long enough to give birth to more target pests.

### 6.1 Simple Prototype Designs for FIGS. 16-18 Applied to Bed Bugs

For protecting windows, curtains, and drapes from bed bugs, the bather material shown in FIGS. 16-18 could be smooth tape, such as ultrahigh molecular weight polyethylene tape. The tape should form a continuous demarcation between the target pest (i.e., bed bugs) region and the bait (i.e., human blood meal) region. The tape should at all points be oriented so that bed bugs have great difficulty climbing it. The walls and climbing sticks of the moat system could be constructed of balsa wood, which is a material that bed bugs find easy to climb and that holds diatomaceous earth well to its surface. All these moat walls could be glued together. All the moat walls and climbing sticks could advantageously be coated with diatomaceous earth. The climbing sticks could advantageously be scored with a tape dispenser before they are coated with diatomaceous earth. Any furrows that are formed should also hold some diatomaceous earth.

The smooth tape should be adhered to the wall, so that it runs vertically, along the sides of the windows, drapes, and curtains, and horizontally over the top of the latter. The smooth tape should also be adhered to the moat walls, as shown in FIGS. 17 and 18. With this arrangement, regardless of whether bed bugs are coming or going, they would tend to walk a long zigzag path along diatomaceous earth. As with most of the other moats discussed in this disclosure, bed bugs that struggle hard enough and long enough against the smooth tape oftentimes tend to fall, usually on their backsides, into the furrow of diatomaceous earth below.

### 7. Protection of Areas of Walls

The moat systems shown in FIGS. 14-18 could be used for protecting many other items besides windows, curtains, and drapes. For example, some areas of a wall might be known to have no openings through which target pests can crawl, while other areas might provide potential openings for target pests. Instead of protecting a window, curtains, and drapes, a moat similar to those shown in FIGS. 14-18 could protect a wall that is known to be free of openings for target pests. Items, such as hanging clothes, might accidentally touch the area of a wall circumscribed by a barrier. Target pests that try to enter these clothes, cannot access them from the wall because they cannot reach the circumscribed area of the wall. And if they try to gain access to the circumscribed area of the wall, they will eventually be guided into a moat waiting below the circumscribed area. The moat could comprise a furrow, or it could be nothing more than a climbing stick, which holds plenty of the killing material to its surface. The protected area of the wall could, instead, be some area through which target pests might crawl to gain access to the attached wall; an example might be a light switch, a crack, or an electric wall outlet. Target pests that try to gain access to the surrounding wall would be guided into the moat waiting below.

### 8. Moat System with an Orientation Dependent Function

FIGS. 19A and 19B show two views of a versatile embodiment of a moat system. In FIGS. 19A and 19B, basswood (or any durable material) stick 1970 has pieces of basswood (or any durable material) 1910 and 1960 affixed, so that they will serve as supports for a platform, which can hold most any types of protected items. For example, four of these moat systems could be constructed, and four holes could be drilled or otherwise cut into a platform, such as one made of plywood, and the portion 1920 or 1950 of the moat system could be inserted into the holes in the platform. 1910 or 1960 would then support the platform. For both figures, 1900 is material that covers the outside of a jar whose inner surface, 1980, in FIG. 19A, is a barrier, which the target pests find difficult to climb The outer edge of the moat is 1990. FIG. 19B is a view of the moat system shown in FIG. 19A, with the barrier of the moat system 1980, in FIG. 19A, facing downward, instead of upward. The moat system is also rotated 90 degrees about the vertical axis. 1930 is the side of the jar opposite the barrier 1980. 1930 would advantageously be comprised of material that the target pests find easy to climb and that holds the killing material well to its surface. 1940 is the interface between stick 1970 and the material 1930. It would be advantageous if all surfaces of the moat system shown in FIGS. 19A and 19B, except the barrier 1980, are easy for the target pests to climb and if all these surfaces, except barrier 1980, hold the killing material well.

Suppose, for example, that the target pests are bed bugs. Using the orientation shown in FIG. 19A, if the protected items are dirty clothes that will be washed and dried at high heat before the clothes are reused, bed bugs that manage, somehow, whether by climbing the moat system or by hitching a ride on clothes that are stored in the protected item, such as a hamper, will have an extremely difficult time exiting the protected item. They would thus likely die from either dehydration, because of exposure to the diatomaceous earth contained in and on the moat system shown in FIG. 19A, or being washed and dried at high heat. Using the orientation shown in FIG. 19B, the protected items might be clean clothes or dirty exercise equipment, such as ankle weights, which will not be cleaned and dried at high heat before reuse. With the orientation shown in FIG. 19B, it would be extremely difficult for bed bugs to enter the protected items. If persistent, they would, instead, walk a long zigzag path along diatomaceous earth held by all the surfaces of the moat system, except the barrier 1980. If diatomaceous earth is also contained in the furrow formed by the barrier 1980, then bed bugs that try to exit the protected item, when the orientation is as shown in FIG. 19A, would also walk a long zigzag path along diatomaceous earth contained in this furrow.

### 8.1 Simple Prototype Designs for FIGS. 19A and 19B Applied to Bed Bugs

To design a prototype of the moat system shown in FIGS. 19A and 19B, a ¼″ by ¼″ basswood stick can be cut into pieces of the appropriate dimensions, as shown in the figures. The basswood sticks could then, advantageously, be scored using a tape dispenser; although this step is unnecessary, it helps the basswood sticks hold more diatomaceous earth to their surfaces. A hole can be cut into a plastic medicine bottle, which is made of smooth plastic, after the medicine bottle has been cut in half. A ¼″ by ¼″ basswood stick can then be inserted through the hole, so that an airtight seal is formed between the stick and the medicine bottle. The pieces of basswood could be glued together, as shown in the figures. Cork sheet could be glued to the periphery of the medicine bottle and diatomaceous earth could be rubbed into the cork sheet. Diatomaceous earth should also be rubbed into all the basswood. The idea is to make the entire moat system, shown in FIGS. 19A and 19B, except the inside of the medicine jar, easy for bed bugs to climb and capable of holding diatomaceous earth well to the surface. With the moat system positioned as shown in FIG. 19A, bed bugs would be able to enter the protected item by dropping into the medicine jar, but they would have a hard time escaping because the medicine jar is made of smooth plastic. With the moat system positioned as shown in FIG. 19B, bed bugs would find it nearly impossible to enter the moat system. Thus, when the moat system is oriented as shown in FIG. 19A, it could be used for protecting dirty clothes that will be cleaned and dried at high heat before reuse, and when the moat system is oriented as shown in FIG. 19B, it could be used for protecting clean clothes, dirty clothes that cannot be dried at high heat, and dirty items, such as shoes and ankle weights, which will be reused without being first cleaned and dried at high heat. Of course, either orientation could actually be applied to either of these uses, but the specific uses for these two orientations, which were just mentioned, provide certain advantages.

### 9. Removable Moats for Protection of Supports with Polygonal Cross Section

In FIG. 20, we see a particularly simple moat system, which protects a support 2050 of square or rectangular cross section. Barrier 2010 surrounds the support 2050, so that any target pests that try to enter or exit the protected bait, which is supported by support 2050, would eventually encounter barrier 2010. Several climbing sticks 2000 are arranged around the periphery of support 2050. There exist myriad ways to affix climbing sticks 2000 to each other and the support 2050. For example, pieces of magnetic tape 2020 could be used, as shown in the figure. As much of the support as possible could advantageously be constructed of, or covered with, material that is easy for the target pests to climb and that holds the killing material well to its surface. It would be particularly helpful for this type of material to be located both above (2030) and below (2040) barrier 2010. With plenty of killing material held by all the surfaces, except the barrier 2010, exactly as with the other embodiments already discussed, regardless of whether the target pests are coming or going, they would walk a long zigzag path parallel to barrier 2010 and, thus, along killing material held by this moat system. For some situations and for some pests, it might be advantageous to spread some killing material over bather 2010 (assuming barrier 2010 holds the killing material well to its surface); this could be advantageous for, e.g., cockroaches and ants that have adhesive pads because, for such target pests, fine particulate matter could be coated in combination with killing material onto the barrier 2010, as explained previously in this disclosure.

In FIG. 21, we see a particularly simple moat system, which protects a bed frame 2150 of square or rectangular cross section. Barrier 2110 surrounds the bed frame 2150, so that any target pests that try to climb up or down the outer surface of bed frame 2150 would eventually encounter barrier 2110. Several climbing sticks 2100 are arranged around the periphery of bed frame 2150. There exist myriad ways to affix climbing sticks 2100 to each other and the bed frame 2150. For example, pieces of magnetic tape 2120 could be used, as shown in the figure. As much of the bed frame as possible could advantageously be constructed of, or covered with, material that is easy for the target pests to climb and that holds the killing material well to its surface. It would be particularly helpful for this type of material to be located both above (2130) and below (2140) barrier 2110. With plenty of killing material held by all the surfaces, except the bather 2110, exactly as with the other embodiments already discussed, regardless of whether the target pests are coming or going, they would walk a long zigzag path parallel to barrier 2110 and, thus, along killing material held by this moat system. For some situations and for some pests, it might be advantageous to spread some killing material over bather 2110 (assuming barrier 2110 holds the killing material well to its surface); this could be advantageous for, e.g., cockroaches and ants that have adhesive pads because, for such target pests, fine particulate matter could be coated in combination with killing material onto the bather 2110, as explained previously in this disclosure.

### 9.1 Simple Prototype Designs for FIGS. 20-21 Applied to Bed Bugs

If the target pests are bed bugs, a simple prototype for the moats shown in FIGS. 20-21 could be designed as follows. Here we assume that the supports (which could be, e.g., bedframes or supports for exercise equipment) for the furniture are metallic of a type that attracts magnets. ¼″ by ¼″ balsa wood sticks are scored using a tape dispenser. Pieces of magnetic tape are then glued to the scored balsa wood sticks. Diatomaceous earth is then rubbed into the scored balsa wood sticks. ¼″ wide smooth tape, such as ultrahigh molecular weight polyethylene tape, is then adhered to the periphery of the support. Optionally, pieces of cork or balsa wood are glued to the support, and diatomaceous earth is rubbed into them. The scored, powdered balsa wood sticks are then secured to the support, assuming it is made of a magnetic form of iron, using the magnetic tape that is glued to them.

The cross sectional shape of the support does not need to be square or rectangular, e.g., it can be polygonal, because any number of balsa wood sticks can be secured around the periphery of the support. The balsa wood sticks can be staggered, so that each balsa wood stick can protrude beyond the edges of the polygonal support.

If the support, bedframe, etc. is not metallic, metal tape (e.g., made of iron or steel), which attracts magnets could be adhered to the surface of the support prior to affixing the balsa wood sticks. This arrangement could be used for many other pests as well as bed bugs. For example, metallic tape could be adhered all along the bottom of a bathroom, including the bathtub, walls, etc., and scored balsa wood sticks, into which boric acid has been rubbed, can be affixed, using the magnetic tape, to the metallic tape. Immediately before a person takes a shower, the person can temporarily remove the sticks from the side of the bathtub; the person can replace them when finished taking the shower. Alternatively, a combination of boric acid and diatomaceous earth can be rubbed into the scored balsa wood sticks, so that both bed bugs and cockroaches would die when they make adequate contact with the balsa wood sticks.

Metallic tape can tend to have sharp edges, so it might be a good idea to adhere cellophane tape to the top of the metallic tape. Smooth tape, such as ultrahigh molecular weight polyethylene tape, could be adhered along the edges of the metallic tape. With the latter arrangement, if both diatomaceous earth and boric acid are rubbed into the balsa wood sticks, both bed bugs and cockroaches would be efficiently killed when they walk along the scored and powdered balsa wood sticks.

### 10. Cylindrical, Bottomless, Donut-Shaped Moats

In what follows, a description of a moat system, designed in accordance with FIGS. 22A-C, is provided. This moat system has myriad potential applications. A specific application is assumed for simplicity and clarity, but, as with all the other applications discussed in this disclosure, description of this application is in no manner intended to limit the enormous scope of potential applications of this invention.

10.1 Description of the Moat System of FIG. 22 Applied to Protection of a Broccoli Plant against Slugs

FIGS. 22A-C show a moat system that is cylindrical, similar to some of the others described previously, but it is also bottomless and has a furrow with roof, which is donut-shaped. (Depending on the application, this moat could, of course, have a bottom.) In all three figures, 2200 is the opening of the moat system, which protects whatever is inside the opening, such as a plant. 2210 is the inner surface of the moat system, and 2260 is the outer surface of the moat system. The separation between these two surfaces could be arbitrarily small, e.g., 2210 and 2260 could indicate two sides of a thin sheet of plastic, which is in the form of a cylinder, or they could indicate two sides of a thicker piece of wood. 2220 is the roof of the moat system, which can be comprised of most any durable material. 2230 is an optional slant, which could be a flexible flap, which attaches to the roof; 2230 helps increase the tendency of water, such as that from rain, to run off the roof of the moat system and to avoid falling into furrow 2280.

To demonstrate the operation of this moat system, let us assume that the protected item, which is located at 2200, is a young broccoli plant and that the target pests are slugs. The moat system is inserted into the ground, just deep enough that relatively few slugs would tend to tunnel to the broccoli plant through the soil beneath the moat system. The soil line is at 2270 on the moat system's surface. A slug climbs outer moat surface 2260; climbs the outer lip 2250 of furrow 2280; enters through opening 2240; and crawls through furrow 2280. Furrow 2280 has killing material, such as metaldehyde (without bait) and/or salt and/or synergists, etc., spread along its surface. The slug crawls along this killing material until it reaches barrier 2290. For slugs, the barrier material of which barrier 2290 is comprised could be copper tape or any substance that slugs find difficult to traverse, such as crushed egg shells, blends of chewing tobacco and coffee grounds (tobacco should not be used to protect crops in the nightshade family, such as tomatoes, peppers, potatoes, etc., because such crops are susceptible to tobacco mosaic virus), etc. Upon being repulsed by the barrier 2290, the slug would try again, slithering along the killing material held in the furrow 2280. If the surface of 2215 and/or 2295, which lies above and/or below the barrier 2290, respectively, holds killing material well to its surface, then some killing material could advantageously be rubbed into this surface. The slug, if persistent, would wind up walking a long, generally zigzag, path along the killing material. A slug that manages, somehow, to enter the broccoli plant, e.g. by tunneling beneath the soil, would, if it tries to escape by climbing through the moat system rather than burrowing back through the soil, climb inner moat wall surface 2210; crawl along roof 2220 and 2230; crawl along the inner moat wall surface 2215, which lies above barrier 2290; encounter barrier 2290; and continue trying to get past barrier 2290, walking a long generally zigzag path along any killing material that has been rubbed into 2215. Because iron phosphate is relatively nontoxic to plants, iron phosphate, rather than, e.g., metaldehyde or salt, could advantageously be rubbed into the surface of 2215; this would help minimize the probability that any of these slugs that eventually choose to return to the plant and/or to burrow beneath the soil near the roots of the plant would carry phytotoxic substances or substances that are toxic to other animals to locations that might harm plants or other animals. This same objective might be served by applying metaldehyde to 2215 above barrier 2290 because, upon contact with metaldehyde, slugs tend to have difficulty traveling to other locations because such contact tends to cause them to lose a lot of their slimy mucus.

It is important that the moat system not interfere with the roots of the plant. It would thus be helpful if the portion of the moat that is sunk beneath the soil is separated adequately from the roots, to minimize this interference. The portion of the moat system that lies beneath the soil could advantageously be constructed of a screen so that it minimally interferes with the roots of the plant it protects.

### 11. Psychological Barriers for Control of Target Pests

As has been discussed elsewhere in this disclosure, for some bathers, target pests can sometimes physically cross the barrier, yet are inhibited from doing so. For example, a bed bug would have great difficulty crossing a smooth barrier by climbing or crawling along the smooth barrier, regardless of whether the bed bug is trying to cross from below to above the barrier, or in the opposite direction. Yet a bed bug could literally cross a smooth bather in one direction by dropping off the side of the barrier. But it has great difficulty dropping off the side in the sense that it would prefer to try to bypass the barrier; this preference would, in accordance with the present invention, induce the bed bug to walk a long, typically zigzag, path along killing material located above the barrier. Although a bed bug could scarcely be said to possess a mind, it behaves as if it were intimidated by the smooth barrier, i.e., the smooth barrier, in some situations, seems to have a psychological effect on the bed bugs. In this section, a brief discussion is offered concerning possible methods and apparatuses that can be used to implement the present invention using psychological barriers to control general target pests.

11.1 Lenticular Prints as Barriers that Synergize Traps for Rodents

As discussed elsewhere in this disclosure, systems that kill rodents tend to be hazardous to humans and pets. Poisons that harm rodents tend to be harmful to humans and pets as well. The same objection applies to traps that kill rodents. Furthermore, some rodents have developed resistance to several poisons, and some rodents simply avoid traps. Fortunately, the similarity of rodents, as mammals, to humans and most pets, which explains the hazards to humans and pets of systems that kill rodents, can be exploited to effectively trap rodents, which can later be killed if so desired. This section presents a system that causes a rodent to suddenly panic and, as a result of the rodent's inability to think clearly while panic stricken, to flee directly into a trap.

A lenticular print is a sequence of photographs, which are multiplexed, i.e., sliced and interleaved, and then covered with a series of very thin lenses, arranged side by side above the multiplexed photographs. A lenticular print presents an image that appears in three dimensions (3-D) and/or to move when the viewer of the lenticular print moves. Whether a lenticular print emphasizes the illusion of 3-D or the illusion of movement, depends on the dimensions of the lenses.

Rodents, as mammals, have similar nervous systems to those of humans. Like humans, they perceive movement, and when they are frightened, panic could set in, which could cause them to make rash, sometimes self-defeating, decisions. Obviously, rodents and humans also have their differences. Rodents tend to have poor eyesight. For example a rat typically has vision with about 20/600 acuity. In contrast to humans, rodents, as with most prey, have eyes that are set mostly at the sides of their heads. They therefore have much more limited binocular vision than humans do. We can exploit these similarities and differences as follows.

A lenticular print, which shows an image of a vicious cat, which moves when a rodent approaches the lenticular print, can be adhered to, e.g., a trash can for rats and mice or the periphery of a garden for squirrels. The dimensions of the lenses of which the lenticular print is constructed should be such that the illusion of movement is emphasized over the illusion of 3-D. When a rodent approaches the trash or garden to which such a lenticular print has been adhered, it perceives a moving, vicious cat. In its ensuing panic, the rodent scurries for cover. A trap, which does not create a significant hazard to humans or pets, can be arranged near the trash can or garden. If the trap is concealed under the cover of some innocent looking hideout, the rodent might, in its panic, forsake caution and find itself snared by the trap. Although it is probably oftentimes unnecessary to arrange a trap near the lenticular print, there should be such a trap in a location to which a hungry rodent is likely to wander because rodents probably have a learning curve, so if the rodents are not removed, they might eventually catch on to the trick. If a rodent does eventually catch on, or if it becomes desperate enough, it might eventually become less cautious and, thus, more apt to fall prey to a real cat. But, in case this does not happen, a trap should be located somewhere to ensure that the rodents are removed. One or several traps strategically placed near the lenticular print would exploit the sudden panic likely to be experienced by a rodent upon encountering a moving image of one of its much feared enemies.

FIGS. 23A and 23B show sketches of this simple embodiment of the invention. In both figures, 2300 is a side view of a trash can, 2340 is a lenticular print, and 2380 is the image presented by the lenticular print, which appears to move when the viewer moves. FIG. 23B shows a view of the lenticular image from a slightly different angle from that of FIG. 23A. These figures are intended to illustrate the manner in which the image changes when the viewing angle changes, thus presenting the illusion of movement. A rodent approaches the trash can, perceives an image of a moving, vicious predator, and runs for cover. At least one trap should ideally be located nearby and should be made to appear safe to the rodent.

The lenticular prints which present images of natural enemies of the rodents have the property that, as long as they are oriented in such a manner that approaching rodents see images of natural enemies moving, rodents find them substantially difficult to traverse by climbing or crawling on them. And the more persistent a rodent is, i.e., the more times it tries again to approach the bait region, e.g., a trash can, the more likely it is to be incapacitated, e.g., by being trapped or killed.

11.2 Lenticular Prints as Barriers that Synergize Traps for Birds

Among the most destructive bird pests are house sparrows, European starlings, and pigeons. House sparrows and European starlings are normative to North America, having been imported in the 1800's from Europe. Because they are normative, they have few, if any, natural enemies. As we have learned from experience, simply importing birds, which are natural enemies of these pest birds, from elsewhere in an effort to combat these problem birds could result in a new problem posed by the imported birds. Another possible solution would be to position lenticular prints, which display images of moving natural enemies of these pests. If these pests are intimidated by such images, then these images might help to control them.

Two natural bird predators of many birds and rodents are owls and hawks. Unfortunately, real owls and hawks would likely feed on other creatures, such as beautiful and harmless birds. But a lenticular print, which presents a 3-D image of an owl or hawk, if properly placed, might intimidate bird pests without in any manner harming any of the desirable birds. Another possibility would be to wrap a lenticular print, which shows a 3-D image of a moving cat, around a portion of a tree trunk or other typical hangout for bird pests. Pest birds that encounter such a 3-D image of a moving cat might prefer to hang out elsewhere. Thus, any number of traps could be set up, a short distance from the lenticular print rigged tree. Birds that flee the tree would be relatively likely to get caught by the nearby trap.

### 12. Clarification of Claim Language

In this section, an attempt is made to clarify some of the terminology used in the claims. This section is not actually intended to narrow the scope of the claims, but is instead intended to minimize any possible vagueness in the claim terminology. Language is, of course, limited in its ability to accurately and reliably convey concepts from one person to another. For this accuracy and reliability to be ensured, people who use various symbols, such as letters, words, phrases, expressions, characters, etc., should agree to associate similar concepts with these symbols. Sometimes, perhaps because terminology is either new or can be used with drastically different meanings, explicit definitions are helpful. Typically, a symbol, which is used for communication, can be defined in a manner analogous to a set in mathematical set theory. Oftentimes, one can provide a definition by either spelling out a rule, listing instances, or listing properties. Other modes of definition, which are useful in many cases, can be provided by either listing causes, listing effects, or listing ways in which one uses a given symbol. At some point, to avoid infinite regress, one must stop providing definitions and assume, for the sake of communication, that, as a result of common aspects of experience, the parties to the attempted communication associate, with the various symbols, concepts that are similar enough to accomplish the goal of the attempted communication; such symbols can be referred to as “primitive” symbols. In this section, with no intention to narrow the scope of the claims, basic—and necessarily incomplete—definitions of some of the claim terminology are provided.

In several claims words, such as “substantial” and “substantially”, are used, and a reasonable question could be raised concerning the intended metes and bounds of this claim language. In many cases, to answer questions concerning meaning, it would be helpful to analyze at least the following three concepts: “one of ordinary skill in the art,” “intent,” and “choice.” This section is intended to clarify the interpretation of words that appear in the claims. In the first few subsections, intended meanings for words commonly appearing in claims, such as “substantial”, “substantially,” and several others, are discussed. In a subsequent subsection, some terminology that is used in the specification, as well as that commonly employed expression, “one of ordinary skill in the art,” are briefly discussed. The last subsection of this section, which is the longest, concerns clarification of words, phrases, expressions, etc., which are, for the most part, peculiar to the claims for the present invention.

(Note that in this section, it is stated in some places that the primary goal of this invention is to kill rather than to trap target pests. Although this is true for most of the embodiments, an uncommon exception concerns the use of lenticular prints to serve as psychological barriers for pests, such as rodents and birds. These target pests could either be killed or trapped; the option of trapping for these particular target pests can sometimes be much safer.)

### 12.1 Barrier Material

Some claims specify that the impeding surface of the barrier material is “substantially difficult for said target pests to traverse by climbing or crawling” along this impeding surface when this impeding surface is positioned “within a specific range of orientations.” It is also specified, in some claims, that the “greater the effort” by target pests to surmount the barrier, the greater their exposure to the killing material. The primary purpose of this invention is not to trap or repel target pests, but is instead simply to kill them. Some target pests might happen to become trapped because of not being able to scale the barrier, but it is crucial that the moat system design not be such that it repels a significant fraction of the target pests before they have had ample exposure to the killing material used by the moat system. One of ordinary skill in the art would deliberately (“intent”) choose (“choice”) barrier material so that it reduces the probability of a target pest scaling the barrier to below some “low”, tolerable threshold, while it also causes the target pests to become so thoroughly exposed to the killing material, because of their long, deflected, zigzag paths along the killing material, that diminishing returns sets in (i.e., so that any increment in exposure would result in a negligible increase in probability of death).

For example, consider the use of smooth tape as a barrier for bed bugs. Assume we have about 4″ to play with, i.e., that we will construct a moat system using up to 4″ of space beginning at the floor. One might use a 4″ wide fairly smooth barrier to keep bed bugs out of the protected item. Another option would be to use a smaller amount of smoother tape and add some clinging material into which killing material has been rubbed. One could thus use, e.g., a smoother 1″ wide piece of tape and arrange the moat system so that it has 1″ of clinging material above the smooth tape and 2″ of clinging material below the smooth tape. In this example, the probability of a bed bug scaling the barrier is greater than if the bather had used the full 4″ width of smoother tape, but using a smaller piece of the smoother tape permits bed bugs to be killed by allowing the use of clinging material that holds killing material. As the quantity of clinging material increases, diminishing returns sets in, so that bed bugs are not killed significantly more effectively beyond a certain amount of clinging material. On the other hand, as the quantity of clinging material increases, the frequency with which the killing material must be reapplied decreases.

For bed bugs, one of ordinary skill in the art would choose the smoothest material available and would use just enough of this smooth material that this skilled artisan would decide it is unlikely that a bed bug would scale the bather and that this skilled artisan would have space available for adding clinging material and/or furrows, which would hold killing material. If possible, one of ordinary skill in the art would further enhance the effectiveness of the barrier by orienting it so that bed bugs would have a particularly difficult time scaling it. A good benchmark for comparison, which could be used for any target pest, would be a ¼″ wide by 0.01″ thick piece of ultrahigh molecular weight polyethylene tape, the surface of which lies in the vertical plane, for bed bugs. One of ordinary skill in the art would apply similar reasoning, for general target pests, to decide whether a bather is “substantially difficult” for target pests to traverse. One of ordinary skill in the art would apply similar reasoning for any target pest with which this skilled artisan is familiar.

One might also wonder what is intended by “specific range of orientations.” A typical barrier is not useful for preventing target pests from traveling between the target pest region and the bait region unless it is oriented within a specific range of orientations. For example, smooth tape that lies in the horizontal plane is easy for bed bugs to traverse by crawling or climbing along the surface. The inventor has observed that bed bugs can traverse smooth tape when the smooth surface is oriented upward, so that the normal to the surface is directed at a 45 degree angle with the vertical. Thus, by “within a specific range of orientations,” it is intended that one of ordinary skill in the art would design a moat system so that the barrier, of whatever type, is oriented in such a manner that it achieves its objective as described above and elsewhere in this section and throughout this patent, for the target pest of interest to this skilled artisan.

Finally, in deciding whether “effort” by target pests to traverse or bypass a barrier is “great,” one of ordinary skill in the art would likely use intuition to visualize two target pests trying to reach the protected bait region. If one such target pest behaves in such a manner that its probability of scaling a general barrier, constructed of any material of any width, would be judged to exceed that of the other target pest, then one of ordinary skill in the art would likely conclude that the former target pest is expending “greater effort” than that expended by the latter target pest. In general, such “effort” might be intuitively estimated based on energy expended, duration of effort, number of times its claws grope at the barrier, etc.

### 12.2 Killing Material

Some claims specify that the killing material is “substantially lethal to said target pests” when “substantial” contact is made with a specific part of the anatomy of the target pests. Pest extermination professionals typically have a wide arsenal of substances for killing target pests. The most basic issue concerns which substances one of ordinary skill in the art would immediately recognize as being useful for killing the target pests, as evidenced, e.g., by this skilled artisan's willingness to purchase the substances for personal use against the target pests. Diatomaceous earth would immediately be recognized as being useful against bed bugs, and boric acid would similarly be recognized as being useful against cockroaches. But many substances are far more potent against these creatures, and people have different tolerances for the use of poisons. Furthermore, some poisons, when spread on a surface, tend to repel target pests, which is inconsistent with the goal of this invention to kill target pests by luring them and then compelling them to walk a long distance along killing material. Thus, a substance is “substantially lethal” if one of ordinary skill in the art would choose the substance in such a manner that it does not exceed this skilled artisan's tolerance for poison, it does not tend to repel target pests when applied to a surface, and it is a substance that is well recognized as being useful for the killing of the target pests of interest to this skilled artisan.

Some claims specify that it must be “substantially easy” for the target pests to reach and then traverse a “border portion of said killing material” so that they make “substantial contact with” this “border portion of said killing material.” The primary aim of this invention is to kill rather than to trap or to repel target pests. The “border portion of said killing material” is killing material that target pests can access without having to traverse some gauntlet of barriers (e.g., by crawling or climbing along surfaces of barriers, or by dropping from a side of a barrier), to ensure that even the most skittish of target pests can acquire ample killing material on their bodies without any particular effort. By “ample,” we mean that the target pests can make “substantial contact with” the killing material in the sense that the contact can be adequate for diminishing returns to set in, as discussed above with regard to barriers, without a requirement that the target pests actually make contact with the barriers. It does not matter how this killing material is contained; it could, e.g., be rubbed into clinging material or sprinkled into a furrow.

### 12.3 Clinging Material

Some claims specify properties the clinging material must possess. Some claims specify that the clinging material must be “capable of holding a clinging portion of said killing material substantially securely to its surface at any orientation in space”; that “the quantity of said clinging portion of said killing material per surface area of said clinging material is substantial”; and that the clinging material must be “easy” for the target pests to traverse by crawling or climbing along its surface. One of ordinary skill in the art would want to choose clinging material so that it can lie in about the vertical plane and still hold the killing material well enough to its surface that the killing material would seldom have to be reapplied, e.g., a quantity great enough to kill target pests adequately for the purpose of this skilled artisan could remain on the surface for a long enough time that the skilled artisan is likely to declare the choice of clinging material “convenient.” Although a typical timeframe might be one or two months, the inventor has found, for example, that ¼″ by ¼″ balsa wood sticks, which have been scored using a tape dispenser, hold diatomaceous earth to their surface for several months at a time (about half a year), as evidenced by gently applying a finger to the surface. If the item that is protected by the moat is subject to considerable vibrations, such as those experienced by exercise equipment, then the timeframe would be much shorter. The critical question is, “What material would one of ordinary skill in the art carefully select for the purpose of holding the killing material to its surface while welcoming target pests to climb its surface with an adequate density of killing material held to the surface of the clinging material so that the barrier material (discussed above) can do its job of compelling persistent target pests to walk a long enough, general zigzag path along killing material that they have a high probability of dying as a result of the exposure?” Ultimately, the question is a relative one: “Among the available options, which material holds the chosen killing material longer to its surface, holds it in a larger quantity per surface area of the material, does not repel the target pests, and is easy for them to traverse by climbing or crawling along its surface when it holds the killing material?” A skilled artisan would typically find this question easy to answer.

### 12.4 Furrows

Some claims specify that:
“said zigzag furrow is substantially easy for said target pests to traverse by climbing or crawling within said zigzag furrow between the adjacent pair of moat walls that form said zigzag furrow when said zigzag furrow holds said zigzag furrow portion of said killing material;”

One might wonder what is meant here by “substantially easy.” One of ordinary skill in the art would recognize that a choice of killing material which is hard for the target pests to traverse, e.g., because it repels them or is otherwise hard for them to crawl over, would defeat the purpose of the invention because the intention of the invention is that the moat systems be designed so that target pests get maximal exposure to the killing material. This claim language also intends, by “between,” that the path over which the target pests must find it easy to crawl does not necessarily include any portion of the moat walls. One of ordinary skill in the art would thus recognize that this claim language is simply intended to require that the zigzag furrow be designed so that target pests can travel over the killing material contained in the furrow with sufficient ease that, because of their journey, which results from their struggle to surmount a barrier, they get abundant exposure to the killing material.

### 12.5 Some Language Used in the Specification

At several points in this disclosure, it is specified that clinging material holds the killing material well to its surface. A reasonable question is, “How well is ‘well’?” At least three concepts are relevant in determining the intended meaning of this characteristic of the clinging material. These concepts are “one of ordinary skill in the art,” “intent,” and “choice.” This disclosure goes to great lengths to enable virtually anyone to gain experience in making and using the moat systems described in this disclosure. Thus, one of ordinary skill in the art would be virtually anyone who has acquired significant experience in making and using these moat systems. The relevant question is thus, “If given a choice, what materials would one with experience with designing the moat systems described in this disclosure intentionally, i.e., with careful thought, choose?” One goal in making this decision would be that the moat system function as intended without a need to reapply killing material any more frequently than once every few months or so. For bed bugs, for example, one would certainly not choose easily climbable material typically used for devices that trap bed bugs, such as paper backed tape, because a negligible quantity of diatomaceous earth clings to its surface; it would thus be questionable whether bed bugs that crawl on this paper backed tape would die, and any diatomaceous earth that is rubbed onto the surface would likely soon drop off and have to be reapplied. (Of course, if the paper of which this paper backed tape is comprised is adequately rough to hold enough killing material to tend to kill bed bugs and to tend to hold the killing material to its surface for an adequately long time, then such paper backed tape could serve as “clinging material.”) But balsa wood and cork sheet, among myriad other possible choices, would be obvious choices because they are easy for bed bugs to climb, and they hold plenty of diatomaceous earth well to their surfaces for a very long time, i.e., for several months.

Also, at several points in this disclosure, it is mentioned that, as a result of target pests struggling to traverse or bypass barrier material, they walk a “zigzag path” along killing material located adjacent to barrier material. The path target pests actually walk is not necessarily zigzag. The word “zigzag” is simply used to characterize the process whereby target pests encounter the barrier and then try to traverse it or bypass it, to their detriment.

12.6 Relationship between Claim Language and the Specification

To interpret the claims, one must decide upon a “bait region” and a “target pest region.” Consider, for example, bed bugs. The moat in FIG. 6 is an example of a moat, which can protect either ankle weights or a box of dirty laundry. Bed bugs are oftentimes attracted to these protected items, which can thus be thought of as “bait.” But, suppose a bed bug wishes to exit one of these protected items to feed on someone who is sleeping in bed. Shall we now declare that the “bait region” has changed? Ultimately, the answer to this question is open ended. One starts with a consideration of one's goal, one then designs a moat system in accordance with the claims in such a manner as to achieve the goal, and then one notes that the “bait region” typically possesses certain properties. Because the moat system is static, the target pests would usually (but not always) have a harder time entering the “bait region” than exiting it, so two properties of the “bait region” tend to be that target pests are attracted to an object located within this region, and one wants, if possible, to keep target pests out of this object. But consider dirty laundry, which will be washed and dried at high heat before reuse. Bed bugs would be attracted to this dirty laundry, but it would be wonderful if, once they get inside the dirty laundry, which would do one no harm, they had a difficult time exiting the dirty laundry. The moat systems shown in FIGS. 8 and 19A are examples of moat systems that would probably be better than that shown in FIG. 6 for achieving this objective. One would probably intuitively consider the “bait region” to include the dirty clothes. So it seems that properties associated with a “bait region” more generally include attraction of target pests to an object located within the “bait region”; the tendency of the paths of target pests to converge onto the “bait region”; and a desire to control and exploit these converging (and thus predictable) paths. Therefore, when a target pest exits a moat, which protects ankle weights, in order to feed on a person sleeping in a bed, it would probably usually be more fruitful, rather than consider the “bait region” to be changing, to consider that the moats positioned beneath the bed legs (hopefully) are protecting another “bait region”, i.e., the bed.

Examples of “barrier material” are shown in the following figures, with the following reference numbers:
FIGS. 1A-1C-150; FIG. 2-250, 286; FIG. 3-340; FIG. 4-410, 445; FIG. 5-515; FIG. 6-660; FIG. 7-780; FIG. 8-880; FIG. 9-980; FIG. 10-1070, 1080

For bed bugs, these reference numbers point to smooth material, such as smooth tape. An example of such smooth tape would be ¼″ wide ultrahigh molecular weight polyethylene tape. The smooth surface of this smooth tape is the “impeding surface.” When this smooth tape has this “impeding surface” oriented so that the width of the smooth tape runs approximately vertically, i.e., so that the surface of the smooth tape lies approximately in the vertical plane from the perspective of an approaching bed bug, the bed bug finds this “impeding surface” of the smooth tape very difficult to climb. Note that barrier 515 of FIG. 5 is oriented at an angle that a target pest, such as a bed bug, would find particularly hard to traverse because the “impeding surface,” which for bed bugs is the smooth surface, is oriented at a somewhat downward angle. A portion of the “impeding surface” of the smooth tape forms a “demarcation” between a “bait region,” which is the region protected by the moat system, and another region, referred to as the “target pest region.”

When contemplating the intended meaning of “demarcation”, one should interpret the “demarcation” to define the boundary between the “target pest region” and the “bait region” when the moat is fully assembled and positioned as desired. For example, consider the moat system depicted in FIGS. 1A-1C. If the barrier material 150 were to serve as the “demarcation” when the moat is not assembled and in place, barrier material 150 would have to extend all the way to the floor to serve as a “demarcation” between these two regions. The intention in the claims, however, is that this barrier material 150 serves as a demarcation with the moat system in FIG. 1 fully assembled and in its final position. Thus, the barrier material 150 can be very small, e.g., it could be a ¼″ wide piece of ultrahigh molecular weight polyethylene tape for bed bugs.

Examples of “bait region[s]” are indicated in the figures as follows:
FIGS. 1A-1B-120; FIG. 3-300; FIG. 5-500; FIG. 6-600; FIG. 7-790; and FIG. 8-890

In each case, the region on the side of the barrier opposite the above listed reference number location is the “target pest region.” Because the “impeding surface of said barrier material,” as shown in each of the above figures, is oriented so that target pests find it hard to climb, and because the entire demarcation is a portion of the impeding surface of the barrier material, the limitation in some of the claims, which states that the impeding surface is so oriented, implies that the entire demarcation is so oriented. Thus, when referring to “said demarcation,” it is given that “said demarcation” is very difficult for the target pests to climb.

For bed bugs, if the “killing material” is diatomaceous earth, the “at least one specific part of the anatomy of the target pest” is the exoskeleton. The greater the contact, which could be measured intuitively in terms of time or energy spent by a bed bug, made by the bed bug with the diatomaceous earth, the greater the probability that the bed bug will die of dehydration because of this contact. Although diminishing returns would be expected to set in after a bed bug has had a certain level of contact with the diatomaceous earth, when a large number of bed bugs are considered, the greater the average contact made by the population of bed bugs, the greater is the probability of death as a result of such contact. Adding to this effect is the fact that the harder a bed bug tries to scale the smooth barrier, the more water and energy it loses, so the sooner it would tend to die. For cockroaches and ants, the “killing material” might be boric acid, and the “at least one specific part of the anatomy of the target pest” would be the adhesive pads and foregut. In general, different “killing material” and different parts of the anatomy would apply for different target pests.

Examples of the “at least one moat wall” are shown in the following figures, with the following reference numbers:
FIGS. 1A-1C-135, 175; FIG. 2-235, 275, 290; FIG. 3-305, 380; FIG. 4-405, 480; FIG. 5-505, 580; FIG. 6-620, 650, 670; FIG. 7-710, 740; FIG. 8-810, 830; FIG. 9-910, 930, 965

It is unnecessary that a moat comprise more than one moat wall, so it is unnecessary that a moat comprise any furrows. In each of the above figures, therefore, “at least one moat wall” refers to at least the one moat wall, to which the barrier is attached.

Each of the moat walls, pointed to by one of the corresponding reference numbers, which are listed above, can in some embodiments comprise “clinging material”, which target pests, e.g., bed bugs, find easy to climb. This clinging material also holds the killing material, e.g., diatomaceous earth for bed bugs, well to its surface, regardless of the orientation of the surface. The clinging material must be capable of holding a substantial quantity of the killing material per surface area of the clinging material to its surface. This “clinging material” must be easy to climb over a wide range of angles, including angles at which it is inclined as part of a moat system—even with plenty of killing material held by the surface of the clinging material. By “easy to climb” and “plenty of killing material,” we mean simply that the clinging material and killing material must be selected so that the moat system under design is effective at killing target pests by luring them into walking long, meandering paths along killing material held to the surface of the clinging material. For bed bugs, good examples of clinging material would be balsa wood, which can be curved if so desired using ammonia, and cork sheet. Balsa wood and cork hold a large quantity of diatomaceous earth, boric acid, etc., to their surfaces, so these materials serve as a good basis for comparison.

Assuming the moat walls, to which the barriers are attached, shown in the above figures are comprised of clinging material, the “clinging portion of said demarcation” is the entire barrier shown in each of the above listed figures. This portion of the demarcation interacts with the portion of the clinging material that is adjacent to the barrier and that holds a portion of the killing material, which for bed bugs is diatomaceous earth. This portion of the killing material is referred to as “a zigzag portion of said clinging portion of said killing material” because bed bugs that persistently try to scale the barrier wind up walking a long distance along the killing material that is held to this surface of the clinging material; and the path traveled by such a bed bug tends to take a zigzag pattern.

Of course, all the above interpretations apply equally well to applications of the present invention to other target pests. Some, but not all, of the dependent claims specify application to target pests that travel from the target pest region to the bait region, while some, but not all, other dependent claims specify travel in the opposite direction. Also, bed bugs (as well as any target pests) could struggle to pass a barrier either from beneath the barrier or from above the barrier. When attempting to pass from beneath a barrier, a bed bug would walk a long distance along diatomaceous earth rubbed into the clinging material beneath the barrier. Bed bugs that try to pass the barrier from above the barrier would tend to hesitate to drop off the side of the barrier, so they would, in their effort to find an opening in the barrier, walk a long distance along diatomaceous earth rubbed into the clinging material above the bather. A furrow, which is not specified in all the claims, would be helpful at least because bed bugs that struggle against the bather oftentimes drop off the side and usually on their backsides; it would thus be advantageous to include a furrow beneath the barrier; this is specified in some of the claims. It should also be noted that clinging material is not necessary because furrows can be used instead. Also, clinging material can be located on either one or both sides of a barrier. Again, it should be emphasized that the moat system disclosed herein can be applied to many target pests other than bed bugs.

Some other limitations that appear in the claims are listed below:
“ingress portion of said clinging portion of said demarcation”:
   FIGS. 1A-1C-150; FIG. 3-340; FIG. 5-515; FIG. 6-660; and FIG. 7-780
“ingress portion of said clinging material”:
   FIG. 3-350; FIG. 5-515; FIG. 6-670; and FIG. 7-760

The “ingress portion of said clinging material” is the portion of the above described clinging material that lies below the “ingress portion of said clinging portion of said demarcation”, which is shown in the figures, as indicated above. The “ingress portion of said clinging portion of said demarcation” is the entire barrier shown in the above listed figures. This portion of the demarcation interacts with the portion of the clinging material that is below this portion of the demarcation and that holds a portion of the killing material, which for bed bugs is diatomaceous earth. This portion of the killing material is referred to as “an ingress portion of said zigzag portion of said clinging portion of said killing material” because bed bugs that persistently try to scale the barrier to enter the bait region wind up walking a long distance along the killing material that is held to this surface of the clinging material; and the path traveled by such a bed bug tends to take a zigzag pattern.

Note that, although the interpretation in the previous paragraph is probably the most obvious one, the “ingress portion of said clinging portion of said demarcation” could instead face inward, toward the bait region, and the “an ingress portion of said zigzag portion of said clinging portion of said killing material” could be located above the latter portion of the demarcation. For simplicity, the details are omitted here, because they are fairly obvious, and similar considerations are discussed elsewhere in this patent.

Consider the example of bed bugs. As described in detail in the specification, bed bugs that try to enter the bait region climb the “ingress portion of said clinging material” and encounter the smooth material, which is the “ingress portion of said clinging portion of said demarcation”, which induces them, if they are persistent, to walk a long, generally zigzag path along the “ingress portion of said clinging material.” With killing material, e.g., diatomaceous earth, held by the “ingress portion of said clinging material,” these persistent bed bugs would walk a long path along the killing material, and this path would generally tend to involve many changes in direction.

Some other limitations that appear in the claims are listed below:
“egress portion of said clinging portion of said demarcation”:
   FIG. 2-286; FIG. 4-445; FIG. 8-880; FIG. 10-1080
“egress portion of said clinging material”:
   FIG. 8-860; and FIG. 10-1085

The “egress portion of said clinging material” is the portion of the above described clinging material that lies below the “egress portion of said clinging portion of said demarcation”, which is shown in the figures, as indicated above. The “egress portion of said clinging portion of said demarcation” is the entire barrier shown in FIG. 8 and is the outermost barrier shown in FIGS. 4 and 10. This portion of the demarcation interacts with the portion of the clinging material that is below this portion of the demarcation and that holds a portion of the killing material, which for bed bugs is diatomaceous earth. This portion of the killing material is referred to as “an egress portion of said zigzag portion of said clinging portion of said killing material” because bed bugs that persistently try to scale the barrier to exit the bait region wind up walking a long distance along the killing material that is held to this surface of the clinging material; and the path traveled by such a bed bug tends to take a zigzag pattern.

Note that, although the interpretation in the previous paragraph is probably the most obvious one, the “egress portion of said clinging portion of said demarcation” could instead face outward, toward the target pest region, and the “an egress portion of said zigzag portion of said clinging portion of said killing material” could be located above the latter portion of the demarcation. For simplicity, the details are omitted here, because they are fairly obvious, and similar considerations are discussed elsewhere in this patent.

Consider the example of bed bugs. As described in detail in the specification, bed bugs that try to exit the bait region climb the “egress portion of said clinging material” and encounter the smooth material, which is the “egress portion of said clinging portion of said demarcation”, which induces them, if they are persistent, to walk a long, generally zigzag path along the “egress portion of said clinging material.” With killing material, e.g., diatomaceous earth, held by the “egress portion of said clinging material,” these persistent bed bugs would walk a long path along the killing material, and this path would generally tend to involve many changes in direction. A furrow, which is not specified in all the claims, would be helpful at least because bed bugs that struggle against the barrier oftentimes drop off the side and usually on their backsides; it would thus be advantageous to include a furrow beneath the barrier; this is specified in some of the claims. It should also be noted that clinging material is not necessary because furrows can be used instead. In most cases, however, it would be preferable if the moat system would use both furrows and clinging material.

Examples of the “at least two moat walls” are shown in the following figures, with the following reference numbers:
FIGS. 1A-1C-135, 175; FIG. 3-305, 380; FIG. 5-505, 580; FIG. 6-620, 650, 670; FIG. 7-710, 740; and FIG. 8-810, 830

In each of the above figures, some of the claims refer to at least the one furrow above which a barrier is positioned (e.g., “zigzag furrow” or “zigzag clinging furrow”). If a moat has multiple furrows, it is unnecessary for a barrier to be positioned above every furrow. The possibility of multiple barriers for one or more furrows is permitted in at least some of the claims. Some of the claims also specify clinging material in addition to furrows and one or more barriers (e.g., “zigzag clinging furrow”).

Each of the moats, pointed to by one of the corresponding references, which are listed above, comprises a furrow, which target pests, e.g., bed bugs, encounter as they cross a moat. Examples of furrows, and their reference numbers, are shown in the following figures:
FIGS. 1A-1C-160; FIG. 3-390; FIG. 5-525, 535; FIG. 6-640; FIG. 7-750; and FIG. 8-850

This furrow also holds the killing material, e.g., diatomaceous earth for bed bugs. This is the “furrow portion of said killing material.” As explained next, if a barrier lies above this “furrow portion of said killing material,” then this killing material is also a “zigzag furrow portion of said killing material.” For bed bugs, good examples of materials, which could be used for moat walls, are a tin can and a plastic cap (for moat walls that do not comprise clinging material) or balsa wood (which may be curved using ammonia, if so desired) and/or cork sheet (for moat walls that do comprise clinging material).

Each of the above listed furrows is a “zigzag furrow” because it has a barrier directly above it. If a moat has at least one furrow, then, in accordance with some of the claims, at least one is a zigzag furrow (or, e.g., a “zigzag clinging furrow”, which is discussed shortly below). Note that, in accordance with some of the claims, even if a moat happens to have a furrow, the furrow does not have to be a “zigzag furrow.” A “zigzag furrow” is one along which persistent target pests, such as bed bugs, wind up walking a long distance, which tends to (but does not necessarily) comprise a zigzag path, along killing material (e.g., “zigzag furrow portion of said killing material”), which could be diatomaceous earth for bed bugs. A zigzag furrow accomplishes this feat by holding killing material below a barrier (“furrow portion of said demarcation”), which could be smooth material for bed bugs. Note that, as already mentioned above, because the entire impeding surface is oriented so that target pests, e.g., bed bugs, have a hard time climbing it, this “furrow portion of said demarcation” is also hard for the target pests to climb. Persistent bed bugs that try to cross a barrier (“furrow portion of said demarcation”), which is located close above a zigzag furrow, from below the barrier, would tend to walk a long, generally zigzag, path along killing material (“zigzag furrow portion of said killing material”), e.g., diatomaceous earth, held in the zigzag furrow below the bather.

Examples of the “furrow portion of said demarcation” are:
FIG. 1-150; FIG. 2-250; FIG. 3-340; FIG. 4-10; FIG. 5-515; FIG. 6-660; FIG. 7-780; FIG. 9-980; FIG. 10-1070; and FIG. 11-1120

In what follows, it is assumed that, in each of the above listed figures, the portion of the moat wall to which the “furrow portion of said demarcation” is attached has clinging material, to which killing material is held, directly beneath the “furrow portion of said demarcation.” Thus, in each of the above listed figures, the listed barrier is above a “zigzag clinging furrow”, and target pests that try to enter the bait region are compelled, by this bather, to walk a long zigzag path along killing material held in the “zigzag clinging furrow” shown in the figure and held on the “ingress zigzag portion of said clinging material,” directly beneath the “furrow portion of said demarcation.”

In at least one claim, the “furrow portion of said demarcation” does “double duty.” It not only induces persistent target pests to walk a long zigzag path along killing material, but it also induces them to walk a long zigzag path along killing material that is held by clinging material that is held in a zigzag furrow. It could be that the “furrow portion of said demarcation” only induces target pests that are trying to travel from the bait region to the target pest region to walk a long zigzag path along killing material in the zigzag furrow below. But, for at least one claim, the “furrow portion of said demarcation” causes target pests that travel from the target pest region to the bait region to walk a zigzag path along killing material contained in the zigzag furrow below and held by clinging material.

Of course, it would still be consistent with the claims if the “furrow portion of said demarcation” causes target pests to walk the long zigzag path along killing material regardless of the direction in which they are heading. For example, suppose the target pests are bed bugs. Smooth tape can be adhered to both walls of a zigzag clinging furrow. In this situation, the “furrow portion of said demarcation” would, indeed, induce bed bugs to walk a zigzag path along diatomaceous earth contained in the zigzag furrow below. If clinging material, with diatomaceous earth rubbed into it, is positioned below the smooth tape, then the bed bugs would also walk a long zigzag path along the diatomaceous earth rubbed into the clinging material. Thus, these two pieces of smooth tape would, together, satisfy at least some of the claims. Of course, one piece of smooth tape adhered to one moat wall in such a manner as to make bed bugs that try to enter the bait region from the target pest region walk the long zigzag path along diatomaceous earth contained in both the furrow and on the clinging material would also satisfy some of the claims.

Furthermore, in accordance with some of the claims, the “ingress zigzag clinging portion of said killing material” could be positioned so that target pests that try to travel from the target pest region to the bait region would walk a long zigzag path along killing material rubbed into clinging material directly above a barrier. For example, consider, again, bed bugs. Although positioning the smooth tape so that it faces away from the bait region would obviously make entrance to the bait region difficult for the bed bugs, the smooth tape could, instead, be adhered to a moat wall so that the smooth surface of the smooth tape faces toward the bait region. Beg bugs would still have difficulty entering the bait region because they would much prefer not to drop over the edge of the smooth tape. They would thus walk a long zigzag path along diatomaceous earth rubbed into the clinging material located above the smooth tape. For this particular moat design, however, bed bugs that try to travel from the target pest region to the bait region would not be induced, by this specific piece of smooth tape to walk a long zigzag path along diatomaceous earth contained in the furrow below, unless they drop into the furrow and then try to travel back in the opposite direction.

For one of the claims, to understand the claim limitation, “wherein said target pests cannot traverse said adjacent pair of moat walls which form said zigzag furrow without either traversing a portion of said impeding surface of said barrier material by climbing or crawling along said portion of said impeding surface of said bather material or bypassing said portion of said impeding surface of said barrier material by dropping into said zigzag furrow,” it would be helpful to examine FIGS. 14 and 15. One might inquire into the possibility of specifying “a portion of said furrow portion of said demarcation” instead of “a portion of said impeding surface of said barrier material.” But consider bather material 1400 and 1500 in relation to climbing sticks 1560 and 1590, which can be advantageously comprised of clinging material, and “furrow portion of said demarcation” 1580. Each of the climbing sticks 1560 and 1590 is a moat wall, and together they form a furrow 1550, which holds killing material. Assume the barrier material is smooth tape, the target pests are bed bugs, and the killing material is diatomaceous earth. The portions of the bather 1400 and 1500 that lie above or alongside of climbing sticks 1560 and 1590, and that are adhered to a wall of the abode, are not necessarily portions of the “furrow portion of said demarcation” 1580 because they do not necessarily tend to compel bed bugs that struggle against them to walk a long distance along diatomaceous earth contained in furrow 1550. Yet if these portions of the “impeding surface of said bather material” were excluded, then bed bugs could climb from one moat wall 1560 or 1590 to the other moat wall without crossing any bather material at all, i.e., by simply climbing along the wall of the abode. Thus, all that is needed to prevent them from safely crossing from one moat wall to the other is a portion of the “impeding surface of said bather material” and not necessarily a portion of “said furrow portion of said demarcation.”

As discussed above, some claims combine at least one furrow with clinging material. Each “zigzag furrow” is a furrow through which a target pest tends to be compelled, by a portion of barrier material, to walk a long, generally zigzag, path along killing material contained in the zigzag furrow. In some claims, we go one step further and specify that one of these zigzag furrows is also a “zigzag clinging furrow”, through which target pests are also compelled, by their repeated encounters with barrier material, to walk a long, generally zigzag, path along killing material held by some clinging material of which a moat wall of the “zigzag clinging furrow” is comprised.

Examples of locations among the figures where the following limitations can be found are the following:
“zigzag furrow” is a “zigzag clinging furrow”:
   FIGS. 1A-1C-160; FIG. 3-390; FIG. 6-610; FIG. 7-750; and FIG. 8-850
“a clinging portion of said furrow portion of said demarcation”:
   FIGS. 1A-1C-150; FIG. 3-340; FIG. 5-515; FIG. 6-660; FIG. 7-780; and FIG. 8-880

Assuming that the moat walls to which the barriers are attached are comprised of clinging material, i.e., material that the target pests find easy to climb and that holds the killing material well to its surface, the “clinging portion of said furrow portion of said demarcation” is the entire barrier shown in each of the above listed figures. This portion of the demarcation interacts with the portion of the clinging material that is adjacent to the barrier and that holds killing material to its surface. The latter portion of the clinging material holds a portion of the killing material, which for bed bugs is diatomaceous earth. This portion of the killing material is referred to as “a clinging portion of said killing material” because target pests that persistently try to scale the barrier wind up walking a long distance along the killing material that is held to this surface of the clinging material; the path traveled by such a target pest tends to take a zigzag pattern.

In accordance with some of the claims, “the clinging portion of said furrow portion of said demarcation” induces target pests to walk long zigzag paths along both the killing material contained in the zigzag clinging furrow and the killing material held by the clinging material above the zigzag clinging furrow.

Examples of locations among the figures where some further limitations can be found are the following:
“ingress zigzag portion of said clinging material”:
   FIG. 3-350; FIG. 4-450, 470; FIG. 5-545; FIG. 6-670; FIG. 7-760; FIG. 8-870; FIG. 9-960; and FIG. 10-1030, 1095
“ingress clinging portion of said demarcation”:
   FIGS. 1A-1C-150; FIG. 3-340; FIG. 4-110, 445; FIG. 5-515; FIG. 6-660; FIG. 7-780; FIG. 8-880; FIG. 9-980; and FIG. 10-1070, 1080

For the above listed reference numbers, 350, 450, 545, 670, 760, 960, and 1030, the “ingress zigzag portion of said clinging material” is the portion of the above described clinging material that lies below the “ingress clinging portion of said demarcation”, which is shown in the figures, as indicated above. For the above listed reference numbers, 470, 870, and 1095, the “ingress zigzag portion of said clinging material” is the portion of the above described clinging material that lies above the “ingress clinging portion of said demarcation”, which is shown in the figures, as indicated above. For each of these cases, the “ingress clinging portion of said demarcation” is the entire barrier adjacent to the clinging material shown as one of the above reference numbers. This portion of the demarcation interacts with the adjacent portion of the clinging material, which holds a portion of the killing material, which for bed bugs is diatomaceous earth. This portion of the killing material is referred to as “an ingress zigzag clinging portion of said killing material” because target pests that persistently try to scale the barrier to enter the bait region wind up walking a long distance along the killing material that is held to this surface of the clinging material; and the path traveled by such a target pest tends to take a zigzag pattern.

(Note that it is not necessary that any of the moats depicted in the above figures comprise clinging material. Here we are simply explaining where clinging material, in accordance with the claims, can be located and the relationships of such clinging material to other features specified in the claims.)

Consider the example of bed bugs. As described in detail in the specification, bed bugs that try to enter the bait region climb the “ingress zigzag portion of said clinging material” and encounter the smooth material, which is the “ingress clinging portion of said demarcation”, which induces them, if they are persistent, to walk a long, generally zigzag path along the “ingress zigzag portion of said clinging material” and/or the “zigzag clinging furrow” below. With killing material, e.g., diatomaceous earth, held by the “ingress zigzag portion of said clinging material” and the “zigzag clinging furrow” below, these persistent bed bugs would walk a long path along the killing material, and this path would generally tend to involve many changes in direction.

Note that some of the claims are particularly broad in scope at least because they do not specify the moat wall surface or surfaces to which the “ingress clinging portion of said demarcation” and the “ingress zigzag portion of said clinging material” are attached. Consider the drawing shown in FIG. 12. The drawing shows a cross section of a typical moat system. The system can have any number of moat walls, and any combination of the moat wall surfaces can comprise clinging material. Suppose the bait region is to the right of the moat walls 1200 in the figure. Suppose the “furrow portion of said demarcation”, which is specified in some of the claims, is the barrier 1210 to the right, directly above the “zigzag furrow” 1220. Among other possibilities, we have the following combinations:
1. The “ingress clinging portion of said demarcation” could be the “furrow portion of said demarcation” itself. The only barrier in FIG. 12 would then be that on the right. The “ingress zigzag portion of said clinging material” would then lie directly beneath this “ingress clinging portion of said demarcation.” Target pests that try to reach the bait region would walk a long zigzag path along the killing material, which is contained in the zigzag furrow and held by the clinging material beneath the barrier.
2. The “ingress clinging portion of said demarcation” could be on the same moat wall as the “furrow portion of said demarcation”, but on the opposite side of the wall. The barrier on the left side in FIG. 12 would thus, instead, be located on the right hand side of the same moat wall to which the barrier on the right in FIG. 12 is attached. The “ingress zigzag portion of said clinging material” would then lie directly above this “ingress clinging portion of said demarcation.” Target pests that try to reach the bait region would walk a long zigzag path along the killing material, which is contained in the zigzag furrow beneath the “furrow portion of said demarcation.” If they somehow get onto the moat wall above the “furrow portion of said demarcation”, and if they try to reach the bait region, they would walk a long zigzag path along the killing material held by the “ingress zigzag portion of said clinging material” above the “ingress clinging portion of said demarcation.”
3. The “ingress clinging portion of said demarcation” could be above the “zigzag furrow,” but on the opposite side of the zigzag furrow from the “furrow portion of said demarcation.” The barrier on the left in FIG. 12 would thus be the “ingress clinging portion of said demarcation.” The “ingress zigzag portion of said clinging material” would then lie directly above this “ingress clinging portion of said demarcation.” Target pests that try to reach the bait region would walk a long zigzag path along the killing material, which is held by the “ingress zigzag portion of said clinging material” above the “ingress clinging portion of said demarcation.”
4. The “ingress clinging portion of said demarcation” could be on the moat wall opposite the moat wall to which the “furrow portion of said demarcation” is attached and not above the “zigzag furrow.” The bather on the left in FIG. 12 would thus be located, instead, on the left hand side of the left moat wall. The “ingress zigzag portion of said clinging material” would then lie directly beneath this “ingress clinging portion of said demarcation.” Target pests that try to reach the bait region would walk a long zigzag path along the killing material, which is held by the “ingress zigzag portion of said clinging material” beneath the “ingress clinging portion of said demarcation.”

The “furrow portion of said demarcation” could instead be to the left, directly above the “zigzag furrow” 1220. In this case, a similar set of possibilities for the “ingress clinging portion of said demarcation” and the “ingress zigzag portion of said clinging material” exists.

Alternatively, the barrier could be oriented in the opposite direction from those listed above, yet still impede ingress of target pests. For bed bugs, for example, the killing material (e.g., diatomaceous earth) could be rubbed into the clinging material located above each of the below listed barriers. Examples of such an alternative orientation of the “ingress clinging portions[s] of said demarcation” are the following:
FIG. 2-286; FIG. 115; FIG. 10-1080

Using the example of bed bugs again, bed bugs would hesitate to drop off the side of the barrier, so they would walk a long zigzag path along killing material that is rubbed into the clinging material above the barrier.

Examples of locations among the figures where the following limitations can be found are the following:
“zigzag furrow” is a “zigzag clinging furrow”:
   FIG. 2-260; FIG. 4-490; FIG. 10-1050
“egress zigzag portion of said clinging material”:
   FIG. 3-330; FIG. 4-430; FIG. 5-510; FIG. 6-650; FIG. 7-770; FIG. 8-860; FIG. 9-970; and FIG. 10-1000, 1085
“egress clinging portion of said demarcation”:
   FIG. 2-286; FIG. 3-340; FIG. 4-440, 445; FIG. 5-515; FIG. 6-660; FIG. 7-780; FIG. 8-880; FIG. 9-980; and FIG. 10-1070, 1080

For reference numbers, 860 and 1085, the “egress zigzag portion of said clinging material” is the portion of the above described clinging material that lies below the “egress clinging portion of said demarcation”, which is shown in the figures, as indicated above. For reference numbers, 330, 430, 510, 650, 770, 970, and 1000, the “egress zigzag portion of said clinging material” is the portion of the above described clinging material that lies above the “egress clinging portion of said demarcation”, which is shown in the figures, as indicated above. For each of these cases, the “egress clinging portion of said demarcation” is the entire barrier adjacent to the clinging material indicated by one of the reference numbers. This portion of the demarcation interacts with the adjacent portion of the clinging material, which holds a portion of the killing material, which for bed bugs is diatomaceous earth. This portion of the killing material is referred to as “an egress zigzag clinging portion of said killing material” because bed bugs that persistently try to scale the barrier to exit the bait region (hence, “egress”) wind up walking a long distance along the killing material that is held to this surface of the clinging material; and the path traveled by such a bed bug tends to take a zigzag pattern.

(Note that it is not necessary that any of the moats depicted in the above figures comprise clinging material. Here we are simply explaining where clinging material, in accordance with the claims, can be located and the relationships of such clinging material to other features specified in the claims.)

Consider the example of bed bugs. As described in detail in the specification, bed bugs that try to exit the bait region climb the “egress zigzag portion of said clinging material” and encounter the smooth material, which is the “egress clinging portion of said demarcation”, which induces them, if they are persistent, to walk a long, generally zigzag path along the “egress zigzag portion of said clinging material” and/or the “zigzag clinging furrow” below. With killing material, e.g., diatomaceous earth, held by the “egress zigzag portion of said clinging material” and the “zigzag clinging furrow” below, these persistent bed bugs would walk a long path along the killing material, and this path would generally tend to involve many changes in direction.

Note that some of the claims are particularly broad in scope at least because they do not specify the moat wall surface or surfaces to which the “egress clinging portion of said demarcation” and the “egress zigzag portion of said clinging material” are attached. Consider the drawing shown in FIG. 12. The drawing shows a cross section of a typical moat system. The system can have any number of moat walls, and any combination of the moat wall surfaces can comprise clinging material. Suppose the bait region is to the right of the moat walls 1200 in the figure. Suppose the “furrow portion of said demarcation” is the barrier 1210 to the right, directly above the “zigzag furrow” 1220. Details of the various possible combinations are omitted because they are similar to those for the “ingress clinging portion of said demarcation,” which are discussed above.

Other examples, for the purpose of some of the claims, of the “furrow portion of said demarcation” are:
FIG. 2-286; FIG. 4-4.45; FIG. 8-880; FIG. 10-1080; and FIG. 11-1180

It is assumed that, in each of the above listed figures, the portion of the moat wall to which the “furrow portion of said demarcation” is attached has clinging material, to which killing material is held, directly beneath the “furrow portion of said demarcation. Thus, in each of the above listed figures, the listed barrier is above a zigzag clinging furrow, and target pests that try to exit the bait region are compelled, by this barrier, to walk a long zigzag path along killing material held in the zigzag clinging furrow shown in the figure and held on the “egress zigzag portion of said clinging material,” directly beneath the “furrow portion of said demarcation.”

In accordance with some of the claims, the “egress zigzag clinging portion of said killing material”, which is held by the “egress zigzag portion of said clinging material,” could be positioned so that target pests that try to travel from the bait region to the target pest region would walk a long zigzag path along killing material rubbed into clinging material directly above a barrier. For example, consider, again, bed bugs. Although positioning the smooth tape so that it faces toward the bait region would obviously make exit from the bait region difficult for the bed bugs, the smooth tape could, instead, be adhered to a moat wall so that the smooth surface of the smooth tape faces away from the bait region. Beg bugs would still have difficulty exiting the bait region because they would much prefer not to drop over the edge of the smooth tape. They would thus walk a long zigzag path along diatomaceous earth rubbed into the clinging material located above the smooth tape. For this particular moat design, however, bed bugs that try to travel from the bait region to the target pest region would not be induced, by this specific piece of smooth tape to walk a long zigzag path along diatomaceous earth contained in the furrow below, unless they drop into the furrow and then try to travel back in the opposite direction.

At least one claim adds to the “egress zigzag portion of said clinging material,” “egress zigzag clinging portion of said killing material,” and “egress clinging portion of said demarcation,” specified in claims from which they depend, the “ingress zigzag portion of said clinging material,” “ingress zigzag clinging portion of said killing material,” and “ingress clinging portion of said demarcation.” In accordance with such claims, the moat system uses clinging material to kill target pests regardless of the direction in which they are headed.

Examples of the “guiding portion[s] of said impeding surface of said barrier material” are shown in the following figures, using the following reference numbers, when no killing material is arranged alongside the “guiding portion[s] of said impeding surface of said barrier material”:
FIG. 14-1430, 1495; FIG. 15-1530, 1593, 1595; FIG. 16-1650, 1690; FIG. 17-1710; and FIG. 18-1810, 1870

Optionally, portions or all of climbing sticks 1410, 1440, 1510, 1540, 1585, 1660, and 1680 could be omitted. In this case, the above listed barriers can be considered “guiding portion[s] of said impeding surface of said barrier material” because they tend to lead persistent target pests, e.g., bed bugs, to follow them into some “killing material” with its adjacent barrier. This guiding material is an easy and sure way to lead persistent target pests, such as bed bugs, into moats, regardless of their direction of travel.

The “guiding portion of said impeding surface of said bather material” is intended to guide persistent target pests toward those portions of the demarcation that tend to cause target pests to walk a long zigzag path along killing material. The killing material is positioned relative to a portion of the demarcation by the clinging material and/or by a furrow. Note that a “guiding portion of said impeding surface of said bather material” that does not have any killing material adjacent to it is neither a “portion of said clinging portion of said demarcation” nor a “portion of said furrow portion of said demarcation” because the former merely directs persistent target pests toward either the “zigzag portion of said clinging portion of said killing material” and the “clinging portion of said demarcation” or the “zigzag furrow portion of said killing material” and the “furrow portion of said demarcation.”

Because it is not necessarily a portion of “said demarcation,” the “guiding portion of said impeding surface of said bather material” does not necessarily impede travel between the target pest region and the bait region. To understand this point, it would be helpful to refer to FIG. 15. Climbing sticks 1585 and the portions 1593 of barrier material 1500, which are adjacent to climbing sticks 1585, do not significantly impede the travel of the target pests between the target pest region and the bait region. But they do tend to guide target pests that encounter them and are headed in the general direction from inside the abode, represented by 1505, toward the door, represented by 1520. In accordance with some of the claims, the climbing sticks 1585 may be omitted or may not have killing material rubbed into them. Target pests that head from the living area 1505 to the door 1520 could be guided by climbing sticks 1585 (if present) and adjacent portions 1593 of barrier material 1500 until they eventually drop over the side and land into the moat below. In accordance with some of the claims, wherein the climbing sticks 1585 are omitted or do not hold killing material, the portion 1593 of barrier 1500 shown above climbing sticks 1585 is an example of a “guiding portion of said impeding surface of said barrier.”

For some of the claims, the “guiding portion of said impeding surface of said barrier material” has killing material arranged adjacent to it. Because, as specified in these claims, it is not a portion of “said demarcation,” the “guiding portion of said impeding surface of said barrier material” does not necessarily impede travel between the target pest region and the bait region. To understand this point, it would be helpful to refer to FIG. 15. Climbing sticks 1585 and the portions 1593 of barrier material 1500, which are adjacent to climbing sticks 1585, do not significantly impede the travel of the target pests between the target pest region and the bait region. Thus, they are not part of the demarcation. But they do tend to guide target pests that encounter them and are headed in the general direction from inside the abode, represented by 1505, toward the door, represented by 1520. In accordance with some of these claims, the climbing sticks 1585 have killing material rubbed into them and/or furrows (in lieu of or in addition to climbing sticks 1585) contain killing material. Target pests that head from the living area 1505 to the door 1520 could be guided by climbing sticks 1585 (or furrows used in place of climbing sticks 1585) and portions 1593 of barrier material 1500 until they eventually drop over the side and land into the moat below. In accordance with these claims, the portions 1593 of barrier material 1500, which are adjacent to climbing sticks 1585, are, therefore, examples of “guiding portion[s] of said impeding surface of said barrier.”

The claims that have “means plus function” language should be interpreted to incorporate all the embodiments disclosed in the specification. For the vast majority of the embodiments disclosed in the specification, the target pests are “incapacitated” by being killed. An exception is the use of lenticular prints for a psychological barrier for certain target pests, such as rodents and birds; for this case, target pests could be “incapacitated” by being either killed or trapped. For all the figures, except FIG. 23, the “impeding means” is the physical barrier, which impedes the travel of the target pests between the target pest region and the bait region. In most of these figures, the barrier is indicated by the boldfaced double lines; where the barrier is not normally visible, this double line is in the form of dashes. Exceptions are figures for which clarity requires that the barrier be depicted by single, bold lines. For beds bugs, for example, the “impeding means” could be smooth material. The controlling means could either kill or trap the target pests. For example, for bed bugs, the “controlling means” could be diatomaceous earth. Diatomaceous earth “incapacitates” bed bugs by killing them through dehydration. For most of the embodiments discussed at length throughout the specification, the “synergizing means” would be the “clinging material” that is near a barrier (“impeding means”) and/or a furrow that is near a barrier (“impeding means”). For example, for a bed bug, the “synergizing means” could be balsa wood and/or cork sheet arranged near a smooth barrier (“impeding means”); for bed bugs, the “synergizing means” could also be a furrow arranged near a smooth barrier (“impeding means”). For the bed bug, diatomaceous earth (“controlling means”) is rubbed into “clinging material” (e.g., balsa wood or cork) arranged near a smooth barrier (“impeding means”) and/or diatomaceous earth (“controlling means”) is contained in a furrow arranged near a smooth barrier (“impeding means”). In each case, and for each example provided in the specification for which killing material is used (which is the vast majority of the embodiments), the “synergizing means” positions the “controlling means” and the “impeding means” so that the “impeding means” greatly enhances the killing power (“incapacitating” power) of the killing material (“controlling means”). Note that, for the bed bug example, the balsa wood or cork sheet is not, per se, the “synergizing means.” Instead, the “synergizing means” is an arrangement of the balsa wood or cork such that the killing effect of the killing material is greatly enhanced by the impeding means.

For FIG. 23, however, we have an example in which the “impeding means” presents a psychological barrier to the target pests, which impedes the travel of the target pests between the target pest region and the bait region. For example, a lenticular print, which presents an image of a moving and/or three-dimensional natural enemy of the target pest, serves as an “impeding means” because the target pests, such as rodents and birds, have a hard time getting past the lenticular print because the image tends to intimidate them. The “controlling means” could “incapacitate” the target pests either by killing them or by trapping them. For a trash can, the “synergizing means” could be the combination of the surface of the trash can and the ground in the vicinity of the trash can. The combination of the trash can and the area of the ground near the trash can permit the lenticular print and the killing material and/or the trap to be positioned in such a manner that an approaching target pest panics upon seeing the lenticular image, and, as a result of this panic, runs to hide in a nearby “shelter,” which “incapacitates” it by either killing it or trapping it.

One claim also specifies, a “guiding means.” Optionally, portions or all of climbing sticks 1410, 1440, 1510, 1540, 1660, and 1680 could be omitted. In this case, both sides of the above listed barriers can be considered “guiding means” because they tend to lead persistent target pests, e.g., bed bugs, to follow them into some killing material (“controlling means”) with its adjacent barrier. This “guiding means” is an easy and sure way to lead target pests, such as bed bugs, into moats, regardless of their direction of travel. The “synergizing means” is the combination of structures, in the figures, that position the killing material (“controlling means”) near the demarcation (“impeding means”) in such a manner that the demarcation (“impeding means”) enhances the killing power of the killing material (“controlling means”).

The “guiding means” is intended to guide persistent target pests toward those portions of the “impeding means” (demarcation) that tend to cause target pests to walk a long zigzag path along the “controlling means” (killing material). The “controlling means” (killing material) is positioned relative to a portion of the “impeding means” (demarcation) by the “synergist means” (clinging material and/or a furrow), as described in some of the claims. Note that a “guiding means” is not necessarily a part of the “impeding means,” and the “impeding means” is not necessarily a part of the “guiding means” because the “guiding means” does not necessarily impede travel of the target pests between the target pest region and the bait region. The “guiding means” merely directs persistent target pests toward a portion of the “controlling means” and a portion of the “impeding means.”

Because it is not necessarily a portion of the “impeding means,” the “guiding means” does not necessarily impede travel between the target pest region and the bait region. To understand this point, it would be helpful to refer to FIGS. 9, 15, and 16, to name just a few examples. Several figures that provide examples of guiding means have already been provided. Additional examples of “guiding means” are shown in the following figures, using the following reference numbers, regardless of whether killing material is arranged alongside the “guiding means”:
FIG. 9-955, 965, 985; FIG. 15-1500, 1585; FIG. 16-1620

Climbing sticks 1585 and the portions 1593 of barrier material 1500, which are adjacent to climbing sticks 1585, do not significantly impede the travel of the target pests between the target pest region and the bait region. Thus, they are not part of the “impeding means” (demarcation). But they do tend to guide target pests that encounter them and are headed in the general direction from inside the abode, represented by 1505, toward the door, represented by 1520. In accordance with some of the claims, the climbing sticks 1585 (“synergizing means”) may or may not be omitted or may or may not have “controlling means” (killing material) rubbed into them. Also, furrows can be used in lieu of climbing sticks 1585. Target pests that head from the living area 1505 to the door 1520 could be guided by climbing sticks 1585 (if present) and/or furrows (if present) and portions 1593 of bather material 1500 until they eventually drop over the side and land into the moat below. In accordance with some of the claims, the portion 1593 of barrier 1500 shown above climbing sticks 1585 is, therefore, an example of a “guiding means.”

The outer moat wall, indicated by 955, 965, and 985, in FIG. 9, does not significantly impede the travel of the target pests if they find it easy to climb, e.g., if it is made of clinging material. But target pests that want to travel from the target pest region to the bait region, would be guided by this moat wall to reach bather 980. The outer moat wall, indicated by 955, 965, and 985, in FIG. 9, is, therefore, another example of a “guiding means.”

Similarly, the outer moat wall, indicated by 1620, in FIG. 16, does not significantly impede the travel of the target pests if they find it easy to climb, e.g., if it is made of clinging material. But target pests that want to travel from the target pest region to the bait region, assuming the bait region to be the window, would be guided by this moat wall to reach bather 1600 or 1610. The outer moat wall, indicated by 1620, in FIG. 16, is, therefore, yet another example of a “guiding means.”

This disclosure has cited several patents, which this disclosure hereby incorporates by reference. This disclosure has also relied on the following non-patent literature, which this disclosure also hereby incorporates by reference:
CHANGLU WANG, MICHAEL E. SCHARF, AND GARY W. BENNETT. Insecticide Resistance and Resistance Management: Behavioral and Physiological Resistance of the German Cockroach to Gel Baits (Blattodea: Blattellidae). J. Econ. Entomol. 97(6): 2067D2072 (2004).
DANGSHEG LIANG. Performance of Cockroach Gel Baits against Susceptible and Bait Averse Strains of German Cockroach, Blattella Germanica (Dictyoptera: Blattellidae)—Role of Bait Base and Active Ingredient. Proceedings of the Fifth International Conference on Urban Pests, Chow-Yang Lee and William H. Robinson (editors), 2005.
R. E. HUMPHRIES, R. M. SIBLY, AND A. P. MEEHAN. Cereal aversion in behaviorally resistant house mice in Birmingham, UK. Applied Animal Behaviour Science 66 (2000), 323-333.
MATTHEW J. ANYON, MICHAEL J. ORCHARD, DAVID M. A. BUZZAL, STUART HUMPHRIES, AND MIKA M. KOHONEN. Effect of particulate contamination on adhesive ability and repellence in two species of ant (Hymenoptera; Formicidae). The Journal of Experimental Biology 215, 605-616.
JIAN CHEN AND XIKUI WEI. Coated Containers with Reduced Concentrations of Fluon to Prevent Ant Escape. J. Entomol. Sd. 42(1): 119-121 (January 2007).
JOHN H. KLOTZ, CHRIS AMRHEIN, STEVEN MCDANIEL, MICHAEL K. RUST, AND DONALD A. REIERSON. Assimilation and Toxicity of Boron in the Argentine Ant (Hymenoptera: Formicidae). J. Entomol. Sci. 37(2): 193-199 (2002).
SYMONDSON, WILLIAM O. C. (Professor). Slug Control. Cardiff School of Biosciences, UK. October 1996. http://www.cf.ac.uk/biosi/staffinfo/wocs2.html
EIS, MATTHEW DOUGLAS. An Evaluation of Bed Bug (Cimex lectularius L.) Host Location and Aggregation Behavior. Thesis submitted to the faculty of the Virginia Polytechnic Institute and State University in partial fulfillment of the requirements for the degree of Master of Science In Life Sciences In Entomology (2010).
BENOIT, JOSHUA, DEL GROSSO, NICHOLAS A., YODER, JAY A., and DENLINGER, DAVID L. Resistance to Dehydration Between Bouts of Blood Feeding in the Bed Bug, Cimex Lectularius, is Enhanced by Water Conservation, Aggregation, and Quiescence. Am. J. Trop. Med. Hyg. May 2007, Vol 76., No. 5, 987-993.
TARSHIS, BARRY, Assistant Professor of (Entomology UCLA), California Agriculture. Laboratory and Field Trials with Sorptive Dusts and Dibrom for Control of Animal and Household Pests (May 1961).
STEPHEN L. DOGGETT, A Code of Practice For the Control of Bed Bug Infestations in Australia 3rd Edition, Australian Environmental Pest Managers Association, LTD (May 2010).
BENOIT, J. B, PHILLIPS, S. A., CROXALL, T. J., CHRISTENSEN, B. S., YODER, J. A., and DENLINGER D. L. Addition of alarm pheromone components improves the effectiveness of desiccant dusts against Cimex lectularius. J. Med Entomol. 2009 May; 46(3): 572-9.
GARY W. BENNETT, JOHN M. OWENS, LEE C. TRUMAN, AND ROBERT M. CORRIGAN. Truman's Scientific Guide to Pest Management Operations, 6th ed. Purdue University Press (2003).

What I claim is the following:

1. A moat system for killing target pests that are attracted to a bait, wherein said moat system comprises:
a. barrier material, which is substantially difficult for said target pests to traverse by climbing or crawling along an impeding surface of said barrier material when said impeding surface of said barrier material is positioned within a specific range of orientations;
i. wherein a demarcating portion of said impeding surface of said barrier material forms a demarcation between two regions;
ii. wherein one of said two regions comprises a target pest region and the other of said two regions comprises a bait region;
iii. wherein said bait is located within said bait region;
iv. wherein said target pests cannot travel from one of said two regions to the other of said two regions without either traversing said demarcation by climbing or crawling along a portion of said demarcation or bypassing said demarcation by dropping over the side of said demarcation;
and
v. wherein said impeding surface of said barrier material is positioned within said specific range of orientations;
b. at least one moat wall;
i. wherein at least one surface of at least one of said at least one moat wall comprises clinging material;
A. wherein said clinging material is easy for said target pests to traverse by climbing or crawling along the surface of said clinging material;
and
c. killing material, which is substantially lethal to said target pests when at least one specific part of the anatomy of said target pests makes contact with said killing material;
i. wherein said clinging material is capable of holding a clinging portion of said killing material substantially securely to its surface at any orientation in space;
ii. wherein said clinging material holds said clinging portion of said killing material to its surface;
iii. wherein the quantity of said clinging portion of said killing material per surface area of said clinging material is substantial;
iv. wherein said clinging material is easy for said target pests to traverse by climbing or crawling along the surface of said clinging material when said clinging material holds said clinging portion of said killing material to its surface;
v. wherein said killing material possesses the property that the greater the contact with said killing material made by said at least one specific part of the anatomy of said target pests the higher the probability that said target pests will die as a result of said contact;
vi. wherein said barrier material is so arranged relative to said killing material that said target pests can substantially easily reach, from at least one of said target pest region and said bait region, a border portion of said killing material and can substantially easily traverse said border portion of said killing material in such a manner that said at least one specific part of the anatomy of said target pests makes substantial contact with said border portion of said killing material without said target pests making contact with any of said barrier material;
vii. wherein at least one surface of at least one of said at least one moat wall comprises a clinging portion of said demarcation;
and
viii. wherein said clinging portion of said demarcation is so arranged relative to a zigzag portion of said clinging portion of said killing material that the greater the effort expended by said target pests to traverse or bypass said clinging portion of said demarcation in an attempt to exit the portion of the clinging material that holds said zigzag portion of said clinging portion of said killing material the greater the contact made by said at least one specific part of the anatomy of said target pests with said zigzag portion of said clinging portion of said killing material.

2. The moat system of claim 1,
a. wherein at least one surface of at least one of said at least one moat wall comprises an ingress portion of said clinging portion of said demarcation and an ingress portion of said clinging material;
b. wherein said ingress portion of said clinging material holds an ingress portion of said zigzag portion of said clinging portion of said killing material;
and
c. wherein said ingress portion of said clinging portion of said demarcation is so arranged relative to said ingress portion of said zigzag portion of said clinging portion of said killing material that the greater the effort expended by said target pests to traverse or bypass said ingress portion of said clinging portion of said demarcation to reach said bait region from said target pest region the greater the contact made by said at least one specific part of the anatomy of said target pests with said ingress portion of said zigzag portion of said clinging portion of said killing material.

3. The moat system of claim 1,
a. wherein at least one surface of at least one of said at least one moat wall comprises an egress portion of said clinging portion of said demarcation and an egress portion of said clinging material;
b. wherein said egress portion of said clinging material holds an egress portion of said zigzag portion of said clinging portion of said killing material;
and
c. wherein said egress portion of said clinging portion of said demarcation is so arranged relative to said egress portion of said zigzag portion of said clinging portion of said killing material that the greater the effort expended by said target pests to traverse or bypass said egress portion of said clinging portion of said demarcation to reach said target pest region from said bait region the greater the contact made by said at least one specific part of the anatomy of said target pests with said egress portion of said zigzag portion of said clinging portion of said killing material.

4. The moat system of claim 1,
a. wherein a guiding portion of said impeding surface of said bather material directs said target pests, which persist in attempting to traverse or bypass said guiding portion of said impeding surface of said bather material, toward a portion of said clinging portion of said demarcation and a portion of said zigzag portion of said clinging portion of said killing material;
b. wherein said portion of said clinging portion of said demarcation is so arranged relative to said portion of said zigzag portion of said clinging portion of said killing material that the greater the effort expended by said target pests to traverse or bypass said portion of said clinging portion of said demarcation in an attempt to exit said portion of said zigzag portion of said clinging portion of said killing material the greater the contact made by said at least one specific part of the anatomy of said target pests with said portion of said zigzag portion of said clinging portion of said killing material;
and
c. wherein said guiding portion of said impeding surface of said barrier material is not adjacent to any of said killing material.

5. The moat system of claim 1, further comprising at least two moat walls;
a. wherein each adjacent pair of said at least two moat walls forms a furrow;
b. wherein said furrow contains a furrow portion of said killing material;
c. wherein the minimum separation between said each adjacent pair of said at least two moat walls is adequate to prevent said target pests from traveling from one moat wall of said each adjacent pair of said at least two moat walls to the other moat wall of said each adjacent pair of said at least two moat walls without traversing said furrow portion of said killing material.

6. The moat system of claim 3,
a. wherein at least one surface of at least one of said at least one moat wall comprises an ingress portion of said clinging portion of said demarcation and an ingress portion of said clinging material;
i. wherein said ingress portion of said clinging material holds an ingress portion of said zigzag portion of said clinging portion of said killing material;
and
ii. wherein said ingress portion of said clinging portion of said demarcation is so arranged relative to said ingress portion of said zigzag portion of said clinging portion of said killing material that the greater the effort expended by said target pests to traverse or bypass said ingress portion of said clinging portion of said demarcation to reach said bait region from said target pest region the greater the contact made by said at least one specific part of the anatomy of said target pests with said ingress portion of said zigzag portion of said clinging portion of said killing material.

7. The moat system of claim 1,
a. wherein a guiding portion of said impeding surface of said barrier material directs said target pests, which persist in attempting to traverse or bypass said guiding portion of said impeding surface of said barrier material, toward a portion of said clinging portion of said demarcation and a portion of said zigzag portion of said clinging portion of said killing material;
b. wherein said portion of said clinging portion of said demarcation is so arranged relative to said portion of said zigzag portion of said clinging portion of said killing material that the greater the effort expended by said target pests to traverse or bypass said portion of said clinging portion of said demarcation in an attempt to exit said portion of said zigzag portion of said clinging portion of said killing material the greater the contact made by said at least one specific part of the anatomy of said target pests with said portion of said zigzag portion of said clinging portion of said killing material;
c. wherein said demarcation does not comprise said guiding portion of said impeding surface of said barrier material;
and
d. wherein said guiding portion of said impeding surface of said barrier material is so arranged relative to a killing guiding portion of said killing material that, until a guided portion of said target pests reach said clinging portion of said demarcation and said zigzag portion of said clinging portion of said killing material, the greater the effort expended by said guided portion of said target pests to traverse or bypass said guiding portion of said impeding surface of said barrier material in an attempt to exit said killing guiding portion of said killing material the greater the contact made by said at least one specific part of the anatomy of said guided portion of said target pests with said killing guiding portion of said killing material.

8. A moat system for killing target pests that are attracted to a bait, wherein said moat system comprises:
a. barrier material, which is substantially difficult for said target pests to traverse by climbing or crawling along an impeding surface of said barrier material when said impeding surface of said bather material is positioned within a specific range of orientations;
i. wherein a demarcating portion of said impeding surface of said barrier material forms a demarcation between two regions;
ii. wherein one of said two regions comprises a target pest region and the other of said two regions comprises a bait region;
iii. wherein said bait is located within said bait region;
iv. wherein said target pests cannot travel from one of said two regions to the other of said two regions without either traversing said demarcation by climbing or crawling along a portion of said demarcation or bypassing said demarcation by dropping over the side of said demarcation;
and
v. wherein said impeding surface of said barrier material is positioned within said specific range of orientations;
b. killing material, which is substantially lethal to said target pests when at least one specific part of the anatomy of said target pests makes contact with said killing material;
i. wherein said killing material possesses the property that the greater the contact with said killing material made by said at least one specific part of the anatomy of said target pests the higher the probability that said target pests will die as a result of said contact;
ii. wherein said barrier material is so arranged relative to said killing material that said target pests can substantially easily reach, from at least one of said target pest region and said bait region, a border portion of said killing material and can substantially easily traverse said border portion of said killing material in such a manner that said at least one specific part of the anatomy of said target pests makes substantial contact with said border portion of said killing material without said target pests making contact with any of said bather material;
and
c. at least two moat walls;
i. wherein each adjacent pair of said at least two moat walls forms a furrow;
ii. wherein at least one furrow is a zigzag furrow;
A. wherein said zigzag furrow contains a zigzag furrow portion of said killing material;
B. wherein said zigzag furrow is substantially easy for said target pests to traverse by climbing or crawling within said zigzag furrow between the adjacent pair of moat walls that form said zigzag furrow when said zigzag furrow holds said zigzag furrow portion of said killing material;
C. wherein at least one moat wall of the adjacent pair of moat walls that form said zigzag furrow comprises a furrow portion of said demarcation;
D. wherein the minimum separation between said adjacent pair of moat walls that form said zigzag furrow is adequate to prevent said target pests from traveling from one moat wall of said adjacent pair of moat walls that form said zigzag furrow to the other moat wall of said adjacent pair of moat walls that form said zigzag furrow without traversing said zigzag furrow portion of said killing material;
E. wherein said target pests cannot traverse said adjacent pair of moat walls which form said zigzag furrow without either traversing a portion of said impeding surface of said barrier material by climbing or crawling along said portion of said impeding surface of said barrier material or bypassing said portion of said impeding surface of said barrier material by dropping into said zigzag furrow;
and
F. wherein said furrow portion of said demarcation is so arranged relative to said zigzag furrow portion of said killing material that the greater the effort expended by said target pests to traverse or bypass said furrow portion of said demarcation in an attempt to exit said zigzag furrow the greater the contact made by said at least one specific part of the anatomy of said target pests with said zigzag furrow portion of said killing material;
iii. wherein said target pests can reach, from at least one of said target pest region and said bait region, said zigzag furrow portion of said killing material by climbing, crawling, or dropping, without climbing or crawling along any portion of said impeding surface of said barrier material;
d. wherein said target pests can reach, from said bait region, the zigzag furrow portion of said killing material that is contained in at least one zigzag furrow, by climbing, crawling, or dropping, without climbing or crawling along any portion of said impeding surface of said barrier material.

9. The moat system of claim 8, wherein at least one zigzag furrow is a pitfall furrow;
a. wherein said pitfall furrow contains a pitfall furrow portion of said killing material;
b. wherein at least one moat wall of the adjacent pair of moat walls that form said pitfall furrow comprises:
i. a pitfall furrow portion of said demarcation;
A. wherein said pitfall furrow portion of said demarcation is so arranged relative to said at least one moat wall of the adjacent pair of moat walls that form said pitfall furrow that any of said target pests that touch said pitfall furrow portion of said demarcation from above are subject to a force of gravity that pulls them downward, directly toward said pitfall furrow portion of said killing material;
B. wherein when any of said target pests that touch said pitfall furrow portion of said demarcation from above release their grip on said at least one moat wall of the adjacent pair of moat walls that form said pitfall furrow, said any of said target pests that touch said pitfall portion of said demarcation from above drop and land into said pitfall furrow portion of said killing material.

10. The moat system of claim 8, wherein at least one zigzag furrow is a zigzag clinging furrow;
a. wherein at least one moat wall of the adjacent pair of moat walls which form said zigzag clinging furrow comprises:
i. a clinging portion of said furrow portion of said demarcation;
ii. clinging material;
A. wherein said clinging material is easy for said target pests to traverse by climbing or crawling along the surface of said clinging material;
B. wherein said clinging material is capable of holding a clinging portion of said killing material substantially securely to its surface at any orientation in space;
C. wherein said clinging material holds said clinging portion of said killing material to its surface;
D. wherein the quantity of said clinging portion of said killing material per surface area of said clinging material is substantial;
E. wherein said clinging material is easy for said target pests to traverse by climbing or crawling along the surface of said clinging material when said clinging material holds said clinging portion of said killing material to its surface;
and
F. wherein said clinging portion of said furrow portion of said demarcation is so arranged relative to a zigzag portion of said clinging portion of said killing material that the greater the effort expended by said target pests to traverse or bypass said clinging portion of said furrow portion of said demarcation in an attempt to exit the portion of the clinging material that holds said zigzag portion of said clinging portion of said killing material the greater the contact made by said at least one specific part of the anatomy of said target pests with said zigzag portion of said clinging portion of said killing material.

11. The moat system of claim 8, wherein at least one zigzag furrow is a zigzag clinging furrow;
a. wherein at least one moat wall of the adjacent pair of moat walls which form said zigzag clinging furrow comprises:
i. clinging material;
A. wherein said clinging material is easy for said target pests to traverse by climbing or crawling along the surface of said clinging material;
B. wherein said clinging material is capable of holding a clinging portion of said killing material substantially securely to its surface at any orientation in space;
C. wherein said clinging material holds said clinging portion of said killing material to its surface;
D. wherein the quantity of said clinging portion of said killing material per surface area of said clinging material is substantial;
and
E. wherein said clinging material is easy for said target pests to traverse by climbing or crawling along the surface of said clinging material when said clinging material holds said clinging portion of said killing material to its surface;
ii. an ingress zigzag portion of said clinging material;
A. wherein said ingress zigzag portion of said clinging material holds an ingress zigzag clinging portion of said killing material to its surface;
and
iii. an ingress clinging portion of said demarcation;
A. wherein said ingress clinging portion of said demarcation is so arranged relative to said ingress zigzag clinging portion of said killing material that the greater the effort expended by said target pests to traverse or bypass said ingress clinging portion of said demarcation to reach said bait region from said target pest region the greater the contact made by said at least one specific part of the anatomy of said target pests with said ingress zigzag clinging portion of said killing material.

12. The moat system of claim 11, wherein said furrow portion of said demarcation is so arranged relative to said ingress zigzag clinging portion of said killing material that the greater the effort expended by said target pests to traverse or bypass said furrow portion of said demarcation to reach said bait region from said target pest region the greater the contact made by said at least one specific part of the anatomy of said target pests with said ingress zigzag clinging portion of said killing material.

13. The moat system of claim 8, wherein at least one zigzag furrow is a zigzag clinging furrow;
a. wherein at least one moat wall of the adjacent pair of moat walls which form said zigzag clinging furrow comprises:
i. clinging material;
A. wherein said clinging material is easy for said target pests to traverse by climbing or crawling along the surface of said clinging material;
B. wherein said clinging material is capable of holding a clinging portion of said killing material substantially securely to its surface at any orientation in space;
C. wherein said clinging material holds said clinging portion of said killing material to its surface;
D. wherein the quantity of said clinging portion of said killing material per surface area of said clinging material is substantial;
and
E. wherein said clinging material is easy for said target pests to traverse by climbing or crawling along the surface of said clinging material when said clinging material holds said clinging portion of said killing material to its surface;
ii. an egress zigzag portion of said clinging material;
A. wherein said egress zigzag portion of said clinging material holds an egress zigzag clinging portion of said killing material to its surface;
and
iii. an egress clinging portion of said demarcation;
A. wherein said egress clinging portion of said demarcation is so arranged relative to said egress zigzag clinging portion of said killing material that the greater the effort expended by said target pests to traverse or bypass said egress clinging portion of said demarcation to reach said target pest region from said bait region the greater the contact made by said at least one specific part of the anatomy of said target pests with said egress zigzag clinging portion of said killing material.

14. The moat system of claim 13, wherein said furrow portion of said demarcation is so arranged relative to said egress zigzag clinging portion of said killing material that the greater the effort expended by said target pests to traverse or bypass said furrow portion of said demarcation to reach said target pest region from said bait region the greater the contact made by said at least one specific part of the anatomy of said target pests with said egress zigzag clinging portion of said killing material.

15. The moat system of claim 13, wherein at least one moat wall of the adjacent pair of moat walls which form said zigzag clinging furrow comprises:
i. an ingress zigzag portion of said clinging material;
A. wherein said ingress zigzag portion of said clinging material holds an ingress zigzag clinging portion of said killing material to its surface;
and
an ingress clinging portion of said demarcation;
A. wherein said ingress clinging portion of said demarcation is so arranged relative to said ingress zigzag clinging portion of said killing material that the greater the effort expended by said target pests to traverse or bypass said ingress clinging portion of said demarcation to reach said bait region from said target pest region the greater the contact made by said at least one specific part of the anatomy of said target pests with said ingress zigzag clinging portion of said killing material.

16. The moat system of claim 8,
a. wherein a guiding portion of said impeding surface of said barrier material directs said target pests, which persist in attempting to traverse or bypass said guiding portion of said impeding surface of said barrier material, toward a portion of said furrow portion of said demarcation and a portion of said zigzag furrow portion of said killing material;
b. wherein said portion of said furrow portion of said demarcation is so arranged relative to said portion of said zigzag furrow portion of said killing material that the greater the effort expended by said target pests to traverse or bypass said portion of said furrow portion of said demarcation in an attempt to exit said portion of said zigzag furrow portion of said killing material the greater the contact made by said at least one specific part of the anatomy of said target pests with said portion of said zigzag furrow portion of said killing material;
and
c. wherein said guiding portion of said impeding surface of said barrier material is not adjacent to any of said killing material.

17. The moat system of claim 8,
a. wherein a guiding portion of said impeding surface of said barrier material directs said target pests, which persist in attempting to traverse or bypass said guiding portion of said impeding surface of said barrier material, toward a portion of said furrow portion of said demarcation and a portion of said zigzag furrow portion of said killing material;
b. wherein said portion of said furrow portion of said demarcation is so arranged relative to said portion of said zigzag furrow portion of said killing material that the greater the effort expended by said target pests to traverse or bypass said portion of said furrow portion of said demarcation in an attempt to exit said portion of said zigzag furrow portion of said killing material the greater the contact made by said at least one specific part of the anatomy of said target pests with said portion of said zigzag furrow portion of said killing material;
c. wherein said demarcation does not comprise said guiding portion of said impeding surface of said bather material;
and
d. wherein said guiding portion of said impeding surface of said barrier material is so arranged relative to a killing guiding portion of said killing material that, until a guided portion of said target pests reach said furrow portion of said demarcation and said zigzag furrow portion of said killing material, the greater the effort expended by said guided portion of said target pests to traverse or bypass said guiding portion of said impeding surface of said barrier material in an attempt to exit said killing guiding portion of said killing material the greater the contact made by said at least one specific part of the anatomy of said guided portion of said target pests with said killing guiding portion of said killing material.

18. The moat system of claim 10, wherein said clinging portion of said furrow portion of said demarcation is so arranged relative to said zigzag clinging furrow that target pests that drop while attempting to traverse or bypass said clinging portion of said furrow portion of said demarcation tend to land into said zigzag clinging furrow below.

19. A moat system for controlling target pests that are attracted to a bait, wherein said moat system comprises:
a. impeding means for impeding travel of said target pests between a target pest region and a bait region;
i. wherein said bait is located in said bait region;
b. controlling means for incapacitating said target pests;
and
c. synergizing means for combining said impeding means and said controlling means in such a manner that said impeding means enhances the incapacitating effect of said controlling means.

20. The moat system of claim 19, further comprising guiding means for directing the paths of said target pests, as they attempt to travel between said target pest region and said bait region, toward said impeding means, said controlling means, and said synergizing means.
